(19) United States
(12) Patent Application Publication
(10) Pub. No.: US 2024/0292079 A1
(43) Pub. Date: Aug. 29, 2024

(54) BULLET CASING ILLUMINATION MODULE AND FORENSIC ANALYSIS SYSTEM USING THE SAME

(71) Applicant: Ballistix, Inc., Woodinville, WA (US)

(72) Inventors: David Olsen, Palo Alto, CA (US); David Brebner, Palo Alto, CA (US); Robert H. Poole, Annapolis, MD (US); Gary Lauder, Palo Alto, CA (US); Tracy McSheery, Palo Alto, CA (US); Michael Fertik, Palo Alto, CA (US); Dirk Schwenk, Palo Alto, CA (US)

(21) Appl. No.: 18/035,025

(22) PCT Filed: Nov. 2, 2021
(86) PCT No.: PCT/US2021/057748

§ 371 Date: May 2, 2023

Related U.S. Application Data
(60) Provisional application No. 63/109,331, filed on Nov. 3, 2020.
(60) Provisional application No. 63/109,318, filed on Nov. 3, 2020.

(51) Int. Cl. H04N 23/56; F42B 35/00; G03B 17/14; H04N 13/254; H04N 23/51

(52) U.S. Cl. CPC H04N 23/56; F42B 35/00; G03B 17/14; H04N 13/254; H04N 23/51

(57) ABSTRACT

Methods, systems, and apparatus, including computer programs encoded on a computer storage medium, for a forensic imaging apparatus for documentation, forensic analysis, and reporting of bullet casings. In one aspect, an assembly includes an adaptor for attaching the assembly to a user device, a housing defining a barrel extending along an axis and attached to the adaptor and having an opening that is sufficiently large to receive a firearm cartridge casing, and a holder for holding the firearm cartridge casing at an illumination plane within the barrel. Light sources are arranged within the housing and to direct light to illuminate the illumination plane, the light sources including a first light source arranged to illuminate the illumination plane at a first range of glancing incident angles.

### CROSS-REFERENCE TO RELATED APPLICATIONS

This application claims the benefit of U.S. Provisional Application Ser. No. 63/109,331, filed on Nov. 3, 2020 and U.S. Provisional Application Ser. No. 63/109,318, filed on Nov. 3, 2020, which are incorporated herein by reference.

### BACKGROUND

Current systems for collecting and analyzing forensic evidence associated with gun-related crimes and injuries include sending collected forensic evidence, e.g., bullets and bullet shell casings, to an off-site central processing location. Forensic scientists at the central processing location generate a forensics report from ballistic imaging of the evidence and comparisons to a database including manufacturer's markings on components of guns that serve as identifying features. Generated reports by off-site central processing locations can cause delays in active investigations due to transit time of the forensic evidence to the central processing location, limited imaging and personnel resources, and a backlog of cases from nationwide sources.

Current shell imaging technology and 3D scanning methodology, in general—including extremely expensive and precise confocal microscopes, structured light laser scanners, and other commercially available forensic inspection systems-cannot easily image the metallic surfaces of bullet shells. Such systems often rely on some intervening process to render the shells' surfaces Lambertian (that is, a matte, diffusely reflecting and that obey Lambert's cosine law) through an aerosol coating or elastic gel membrane that conforms to the surface and acts as an intermediary layer between the light source and the camera sensor. This extra layer typically perturbs the surface, thereby limiting the maximum resolution of the instrument.

Even digital processing techniques engineered for imaging non-Lambertian surfaces (e.g., smooth and/or glossy surfaces) can fail when imaging metal surfaces because such surfaces often have non-linear anisotropic BRDF (bidirectional reflectance distribution functions), with multiple facets, which cause ambiguous normal reflections, including “self-illumination” that is not easily correlated with incident light direction. This renders 3D scanning techniques like photometric stereo limited for reproducing raw metallic surfaces, such as those found in shell casings.

### SUMMARY

The imaging techniques described herein employ an illumination scheme that includes low glancing angle light to allow for edge direction of a metallic or other structured, specularly reflecting surface. That is, the disclosed techniques can be suitable for surfaces with non-Lambertian reflectance where slope and illumination are not linked. For shell casings, the surfaces being measured are often brushed metal where the surface slope and illumination are not correlated at all and can vary significantly over the surface to be imaged. This can even vary based on the light direction, the type of surface faceting, and based on corrosion. By hacking the geometry of the material the imaging techniques described can detect the presence of directional edges, rather than measuring the angle of slopes based on illumination intensity.

The devices described herein work in tandem with image acquisition and analysis software designed to easily handle specularly reflective and faceted surfaces, yielding 3D surface reconstructions of metallic and other reflective surfaces. High resolution images can be obtained without intermediary aerosol coatings or the like and can be easily deployed in the field as a mobile scanning unit.

Among other uses, the disclosed techniques and devices can be used to aid law enforcement in matching recovered shells from multiple crime scenes to dramatically improve the lead-generation process available today and ultimately facilitate successful prosecution of criminals. Other applications of the disclosed techniques and devices can include, for example, valuation and counterfeit detection of specimens including specularly reflective and faceted surfaces, e.g., rare coins, jewelry, and the like.

Implementations of the present disclosure are generally directed to a forensic imaging apparatus, for in-field, real-time documentation, forensic analysis, and reporting of spent bullet casings.

More particularly, the forensic imaging apparatus can be affixed to a smart phone, tablet, or other user device including an internal camera. The forensic imaging apparatus can include an illumination module with a set of light sources, e.g., LEDs, a set of diffusers, or the like, arranged with respect to a sample holder within the forensic imaging apparatus to generate photometric conditions for imaging a sample casing in a fixed or mobile environment. The forensic imaging apparatus can, in some embodiments, couple the light directly from the smart phone or tablet's flash to illuminate the sample casing instead of relying on separate light sources, e.g., LEDs. The forensic imaging apparatus further includes a sample holder with a mounting mechanism to retain the sample casing while minimizing contact/contamination of the casing (e.g., contamination of DNA evidence located on the casing) and which positions the sample casing at an imaging position. The forensic imaging apparatus further can include a macro lens for generating high resolution imaging conditions, e.g., 12 megapixel resolution (3-5 micron resolution) images.

In some embodiments, the forensic imaging apparatus can be a stand-alone portable device including illumination and imaging capabilities described herein. The stand-alone portable device may communicate with a user device, e.g., via wireless communication, to upload captured images to the user device. The stand-alone portable device (also referred to herein as a portable assembly) can be a handheld portable device, having dimensions and weight that can be held by a user of the stand-alone portable device.

The forensic imaging apparatus in combination with image processing software can be utilized to capture and process imaging data of a forensic sample, e.g., a spent bullet casing, where one or more surfaces of the bullet casing can be imaged under multiple imaging conditions, e.g., illumination at various angles and using different illumination sources. The captured imaging data can be processed to identify and catalogue tool marks, e.g., striation patterns including breech face marking, firing pin markings, ejection marking and/or additional tool marks that may not be routinely utilized for identification. The processed imaging data can be utilized to generate metadata for the forensic sample which can be combined with additional metadata, e.g., GPS coordinates, crime scene details, etc. A database of catalogued forensic samples can be generated including the metadata for each forensic sample of multiple forensic samples. In some embodiments, metadata for each forensic sample can include information identifying an evidence collecting agent or officer, date and time of evidence recovery, location of evidence recovery (e.g., longitude/latitude), physical location of recovered evidence relative to a crime scene, and/or an indication on an electronic map interface (e.g., map “pin”) of a location of the recovered evidence. Additionally, photographs of the crime scene including photographs capturing location of the evidence can be included in the captured metadata for the forensic sample.

In general, one innovative aspect of the subject matter described in this specification can be embodied in an assembly including an adaptor for attaching the assembly to a user device, and a housing defining a barrel extending along an axis, the housing being attached to the adaptor at a first end of the barrel and having an opening at a second end of the barrel opposite the first end, the opening being sufficiently large to receive a firearm cartridge casing. The assembly includes a holder for holding the firearm cartridge casing within the barrel to position a head of the firearm cartridge casing at an illumination plane within the barrel. Light sources are arranged within the housing and arranged to direct light to illuminate the illumination plane within the barrel, the light sources being arranged between the between the first end and the illumination plane, where the light sources include a first light source arranged to illuminate the illumination plane at a first range of glancing incident angles.

Other embodiments of this aspect include corresponding systems, apparatus, and computer programs, configured to perform the actions of the methods, encoded on computer storage devices.

These and other embodiments can each optionally include one or more of the following features. In some embodiments, the light sources include a second light source arranged to illuminate the illumination plane at a second range of incident angles different from the first range of incident angles. The first light source can be at a first position along the axis and the second light source can be at a second position along the axis different from the first light source. Light sources can include a first set of light sources including the first light source, each of the first set of light sources being arranged at the first position along the axis, each arranged to illuminate the illumination plane at the first range of incident angles. Light sources can include a second set of light sources including the second light source, each of the second set of light sources being arranged at the second position along the axis, each arranged to illuminate the illumination plane at a second range of incident angles. The first range of incidence angles and/or the second range of incidence angles can be sufficient to generate photometric stereo conditions.

In some embodiments, light sources can include at least one structured light source. In some embodiments, light sources are arranged at different azimuthal angles with respect to the axis, for example, the second set of light sources are arranged at different azimuthal angles with respect to the axis.

In some embodiments, the light sources include a third light source at a third position along the axis arranged to illuminate the illumination plane at a third range of incident angles, different from the first and second ranges of incident angles.

In some embodiments, light sources can include at least one spatially extended light source. The at least one spatially extended light source can include a diffusing light guide arranged to emit light across an extended area. The at least one spatially extended light source can be arranged at a location along the axis to illuminate the illumination plane across a range of incident angles sufficient to generate photometric stereo conditions. The second light source can be a spatially extended light source.

In some embodiments, the first light source and/or the second light source can be point light sources.

In some embodiments, the assembly further includes a lens assembly mounted within the barrel, the lens assembly defining a focal plane at the illumination plane. The lens assembly can include a magnifying lens assembly.

In some embodiments, the assembly further includes a source of electrical power for the light sources, and/or can include an electrical controller in communication with the light sources and programmed to control a sequence of illumination of the illumination plane by the light sources.

In general, another aspect of the subject matter described in this specification can be embodied in an assembly including an adaptor for attaching the assembly to a user device, a housing defining a barrel extending along an axis, the housing being attached to the adaptor at a first end of the barrel and having an opening at a second end of the barrel opposite the first end, the opening being sufficiently large to receive a firearm cartridge casing, a holder for holding the firearm cartridge casing within the barrel to position a head of the firearm cartridge casing at an illumination plane within the barrel, and multiple light sources arranged within the housing and arranged to direct light to illuminate the illumination plane within the barrel, the multiple light sources being arranged between the between the first end and the illumination plane, and where the multiple light sources comprise at least one point light source and at least one spatially extended light source.

Other embodiments of this aspect include corresponding systems, apparatus, and computer programs, configured to perform the actions of the methods, encoded on computer storage devices.

In general, another aspect of the subject matter described in this specification can be embodied in an assembly including an adaptor for attaching the assembly to a user device, a housing defining a barrel extending along an axis, the housing being attached to the adaptor at a first end of the barrel and having an opening at a second end of the barrel opposite the first end, the opening being sufficiently large to receive a firearm cartridge casing, a holder for holding the firearm cartridge casing within the barrel to position a head of the firearm cartridge casing at an illumination plane within the barrel, and multiple light sources arranged within the housing and arranged to direct light to illuminate the illumination plane within the barrel, the multiple light sources being arranged between the between the first end and the illumination plane, and where the multiple light sources include a first light source at a first position along the axis and the multiple light sources include a second light source at a second position along the axis different from the first position.

Other embodiments of this aspect include corresponding systems, apparatus, and computer programs, configured to perform the actions of the methods, encoded on computer storage devices.

In general, another aspect of the subject matter described in this specification can be embodied in a device including a user device including a camera and an electronic processing module, and an assembly attached to the user device, where the assembly includes a holder for holding a firearm cartridge casing to position a head of the firearm cartridge casing at an illumination plane within a barrel for imaging by the camera of the user device, and multiple light sources arranged to direct light to illuminate the illumination plane, where the electronic processing module is programmed to control the multiple light sources and the camera to sequentially illuminate the head of the firearm cartridge casing with light from the multiple light sources at a range of different incident angles, and acquire, with the camera, a sequence of images of the head of the firearm cartridge casing while the head of the firearm cartridge is illuminated by a corresponding one of the multiple light sources.

Other embodiments of this aspect include corresponding systems, apparatus, and computer programs, configured to perform the actions of the methods, encoded on computer storage devices.

In general, another aspect of the subject matter described in this specification can be embodied in a method including arranging a head of a firearm cartridge casing relative to a camera of a user device for the camera to acquire images of the head of the firearm cartridge casing, sequentially illuminating the head of the firearm cartridge with light from multiple light sources each arranged to illuminate the head of the firearm cartridge casing at a different range of incident angles, acquiring, with the camera, a sequence of images of the head of the firearm cartridge casing while the head of the firearm cartridge casing is illuminated by a corresponding one of the multiple light sources, and constructing a three-dimensional image of the head of the firearm cartridge casing based on the sequence of images and information about the range of incident angles for the illumination from each of the multiple light sources.

Other embodiments of this aspect include corresponding systems, apparatus, and computer programs, configured to perform the actions of the methods, encoded on computer storage devices.

In general, another aspect of the subject matter described in this specification can be embodied in an assembly including an adaptor for attaching the assembly to a user device relative to a camera and a flash of the user device, a housing defining a barrel extending along an axis, the housing being attached to the adaptor at a first end of the barrel aligning the barrel with the camera of the user device and having an opening at a second end of the barrel opposite the first end, the opening being sufficiently large to receive a firearm cartridge casing, a holder for holding a firearm cartridge casing within the barrel to position a head of the firearm cartridge casing at an illumination plane within the barrel, and a light directing assembly positioned relative to the flash of the user device when the assembly is attached to the user device, the light directing assembly being configured to direct light from the flash of the user device to the illumination plane within the barrel.

Other embodiments of this aspect include corresponding systems, apparatus, and computer programs, configured to perform the actions of the methods, encoded on computer storage devices.

These and other embodiments can each optionally include one or more of the following features. In some embodiments, the light directing assembly is configured to illuminate the illumination plane with light from the flash of the user device at a first range of glancing incident angles.

In some embodiments, the holder is configured to rotate the firearm cartridge casing about the axis.

In some embodiments, the light directing assembly is a light guide. The light directing assembly can include a positive lens between a light guide and the camera flash. The light directing assembly can include free space optical elements (e.g., mirrors, lenses, diffractive optical elements spaced apart along a light path from the camera flash to the illumination plane).

In some embodiments, the light directing assembly is configured to illuminate the illumination plane with light at more than one range of incident angles.

In general, another aspect of the subject matter described in this specification can be embodied in methods including arranging a head of a firearm cartridge casing relative to a camera of a user device for the camera to acquire images of the head of the firearm cartridge casing, illuminating the head of the firearm cartridge with light from a flash of the camera by directing light from the camera flash to the head of the firearm cartridge, and while illuminating the head of the firearm cartridge, varying a relative orientation of the head and the light from the camera flash. The methods further include acquiring, with the camera, a sequence of images of the head of the firearm cartridge casing while illuminating the head of the firearm cartridge, each of the images being acquired with a different relative orientation of the head and the light, and constructing a three-dimensional image of the head of the firearm cartridge casing based on the sequence of images.

Other embodiments of this aspect include corresponding systems, apparatus, and computer programs, configured to perform the actions of the methods, encoded on computer storage devices.

These and other embodiments can each optionally include one or more of the following features. In some embodiments, the relative orientation is varied by rotating the firearm cartridge casing relative to the light, by rotating the light relative to the firearm cartridge casing, or a combination thereof.

In some embodiments, directing the light from the camera flash to the head of the firearm cartridge includes guiding light from the flash using a light guide. Directing the light can include shaping the light to correspond to a point light source. Directing the light can include shaping the light to correspond to a structured light source.

In some embodiments, the head of the firearm cartridge is illuminated at a glancing angle of incidence.

In general, another aspect of the subject matter described in this specification can be embodied in an assembly including an adaptor for attaching the assembly to a user device, a housing defining a barrel extending along an axis, the housing being attached to the adaptor at a first end of the barrel and having an opening at a second end of the barrel opposite the first end, the opening being sufficiently large to receive a firearm cartridge casing, a holder for holding the firearm cartridge casing within the barrel to position a head of the firearm cartridge casing at an illumination plane within the barrel, and multiple light sources arranged within the housing and arranged to direct light to illuminate the illumination plane within the barrel, the multiple light sources being arranged between the between the first end and the illumination plane, and where the multiple light sources include at least one structured light source arranged to illuminate the illumination plane with an intensity pattern including intensity peaks that extend along a line.

Other embodiments of this aspect include corresponding systems, apparatus, and computer programs, configured to perform the actions of the methods, encoded on computer storage devices.

These and other embodiments can each optionally include one or more of the following features. In some embodiments, the multiple light sources include multiple structured light sources each arranged to illuminate the illumination plane with a corresponding intensity pattern comprising intensity peaks that extend along a corresponding different line. The structured light source(s) can include a coherent light source and a diffraction grating. The structured light source(s) can include a laser diode.

In some embodiments, the different lines are non-parallel to each other.

In general, another innovative aspect of the subject matter described in this specification can be embodied in methods including analyzing, using a computer system, multiple images of a bullet casing head each image acquired by a mobile device camera with the bullet casing head in a fixed position with respect to the mobile device camera, each image of the bullet casing head acquired with a different illumination profile, where the analyzing includes identifying an edge of at least one facet on the bullet casing head based on at least two of the images acquired with respective different illumination profiles including glancing angle illumination from a point light source, and the analyzing further includes determining information about the facet based on at least one of the multiple images acquired with respective illumination profile comprising structured illumination and/or at least one of the images acquired with illumination profile comprising illumination from a spatially-extended light source.

These and other embodiments can each optionally include one or more of the following features. In some embodiments the information about the facet includes a slope of the facet. The information about the facet can include a dimension (e.g., depth or length) of the facet, a height map of a surface of the bullet casing head, or a combination thereof. The height map can be determined based on one or more of the images acquired with respective illumination profile comprising structured illumination.

In some embodiments, the methods further include generating a three-dimensional image of the bullet casing head based on the analysis. The methods can further include identifying one or more marks on the bullet casing head associated with a specific firearm based on the three-dimensional image.

Other embodiments of this aspect include corresponding systems, apparatus, and computer programs, configured to perform the actions of the methods, encoded on computer storage devices.

Particular embodiments of the subject matter described in this specification can be implemented so as to realize one or more of the following advantages. By providing a means to capture imaging data on-site and perform real-time analysis at a crime scene, criminal investigators can reduce the need to wait extended periods of time for delivery of the actual evidence to a forensic laboratory for analysis. A database repository of imaging data of stored microscopic features on fired casings for manufactured guns can be built, where imaging data collected by the forensic imaging apparatus can be compared to the stored imaging data to generate a search report that can identify criminal leads which criminal investigators may use in shooting investigations. Once the investigators know that a particular firearm fired bullets at certain locations, they can start tying multiple crimes to specific people. Significant cost savings are possible to society when gun crimes are solved more quickly. In the United States in 2019 alone, there were over 15,000 shooting fatalities. The hospitalization costs related to gun violence totaled approximately $1B U.S.D. per year. Additionally, each gun-related incident may cost between hundreds of thousands of dollars to over a million dollars to investigate. Having a system in place, where leads can be generated while there is active case momentum, can promote faster resolution and greatly lowered cost to society in terms of dollars and tears.

Moreover, utilizing a forensic imaging apparatus that can leverage a user's smart phone or tablet device can result in a relatively accessible, significantly lower-cost solution than the current system reliance on lab-based microscopy, thus allowing a much larger number of agencies and departments to utilize the system. Increased accessibility can significantly increase a number of shell casings that can be compared, resulting in an increase of resolved firearms crimes.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 depicts an example operating environment of a forensic imaging apparatus.

FIGS. 2A-2C depict schematic views of an example forensic imaging apparatus.

FIGS. 2D-2H depict schematic views of another example forensic imaging apparatus.

FIGS. 2I-2J depict schematic views of example aspects of forensic imaging apparatuses

FIGS. 2K-2O depict schematic views of example forensic imaging apparatuses.

FIGS. 3A-3E depict schematic views of example forensic imaging apparatuses.

FIG. 3F depicts a schematic cross-sectional view of an example forensic imaging apparatus parallel to an illumination plane of the forensic imaging apparatus.

FIGS. 3G-3K depict schematic views of example forensic imaging apparatuses.

FIG. 3L depicts schematic views of example components of forensic imaging apparatuses.

FIGS. 3M-3O depict schematic views of example aspects of forensic imaging apparatuses.

FIGS. 4A-4E depict illumination profiles of different light sources at the illumination plane of a forensic imaging apparatus.

FIGS. 5A-5C depict schematics of partial views of forensic imaging apparatuses.

FIGS. 5D-5E depict schematics of partial views of forensic imaging apparatuses.

FIG. 6A is a flow diagram of an example process of a forensic imaging apparatus.

FIG. 6B illustrates reflection of light incident at an angle of approximately 45 degrees from a diffuse, glossy, and mirror (specular) surface, respectively.

FIG. 6C shows reflection of light incidence at a high angle of incidence measured relative to the surface normal (referred to as low-illumination light direction) on a flat surface and a faceted surface.

FIG. 6D shows images photographed under various illumination directions by respective incoming light vectors specified by varying azimuthal (or compass angles).

FIG. 6E shows corresponding direction maps for respective images depicted in FIG. 6D.

FIG. 6F shows corresponding normal maps for respective images depicted in FIG. 6D.

FIG. 6G depicts a synthetic normal map constructed from the composite images depicted in FIGS. 6D-6F.

FIGS. 6H-6J illustrate reflections from various faceted spheres having different surface qualities and under various lighting conditions.

FIGS. 6K-6L depict an example for utilizing a structured light source for illuminating a surface.

FIGS. 6M-6N depict another example for utilizing a structured light source for illuminating a surface.

FIG. 6O is a flow diagram of an example process of the forensic imaging apparatus.

FIG. 6P is a flow diagram of another example process of the forensic imaging apparatus.

FIG. 6Q-6W depict example screens of a user interface for the forensic imaging application environment.

FIG. 7 depicts an example forensic imaging apparatus.

FIGS. 8A-8B depict example forensic manipulation tool.

FIGS. 9A-9B depict example forensic manipulation tools.

FIG. 10 depicts an example forensic manipulation tools.

FIGS. 11A-11B depict example forensic manipulation tools.

FIGS. 12A-12B depict an example forensic manipulation tool in two positions.

FIG. 12C depicts an example forensic manipulation tool.

FIGS. 13A-13D depict views of another example forensic manipulation tool.

FIGS. 14A-14F depict views of another example forensic manipulation tool.

FIG. 15A is a cross-sectional cutaway view of a handgun identifying the breech block and firing pin.

FIGS. 15B-15D show views of a firearm cartridge identifying different parts thereof.

FIG. 16 is a photograph showing a head of a firearm cartridge.

FIGS. 17A and 17B are perspective and side views, respectively, of an assembly with a cone mirror for imaging the extractor flange of a shell casing.

FIGS. 18A-18C are additional views of the assembly shown in FIGS. 17A-B.

FIG. 19 depict an example focusing reticle for the forensic microscope assembly.

FIG. 20 depicts another example operating environment of a forensic imaging apparatus according to some embodiments.

### DETAILED DESCRIPTION

### Overview

Implementations of the present disclosure are generally directed to a forensic imaging apparatus, e.g., a forensic imaging apparatus, for in-field, real-time documentation, forensic analysis, and reporting of spent bullet casings using a mobile device with a camera, such as a smart phone. The forensic imaging apparatus can be used in combination with a software application installed on the mobile device and/or a networked server application to analyze the spent bullet casings and generate forensic reports including, for example, “chain of custody” verification regarding evidence recovery, e.g., suitable for admission as evidence in legal proceedings.

More particularly, in use, the forensic imaging apparatus is affixed to a smart phone, tablet, or other user device including an internal camera. The forensic imaging apparatus includes an illumination (or lighting) module that can include a set of light sources, e.g., LEDs, a set of diffusers, or the like, arranged with respect to a sample holder within the forensic imaging apparatus to generate a illumination conditions suitable for imaging a sample casing using the internal camera or can include aperture(s) which allow light to be coupled into the housing from a user device illumination source (e.g. flash) to illuminate the sample casing at different angles by manipulating the casing in place in the holder assembly. The forensic imaging apparatus further can include a sample holder with a mounting mechanism to retain a sample casing, including a wide range of firearm ammunition caliber casings, while minimizing contact/contamination of the casing and which positions the sample casing at an imaging position. The forensic imaging apparatus can also include a macro lens for generating high resolution imaging conditions using the internal camera. For example, images having a resolution over an object field sufficiently large to encompass the surface of the sample casing being imaged, e.g., of 8 megapixel resolution or more, of 12 megapixel resolution or more, etc. In some cases, this field size is 1 cm² or larger (e.g., 2 cm² or larger, 3 cm² or larger, such as 5 cm² or less). In some embodiments, the resolution is sufficiently high to resolve details on the sample casing having a dimension of 20 microns or less (e.g., 15 microns or less, 10 microns or less, 5 microns or less, e.g., 3-5 microns).

The lighting module is useful for illuminating a forensic sample under conditions suitable for photometric analysis. In some embodiments, the lighting module can direct light from each of multiple light sources to an illumination plane at a different angle of incidence. Imaging data is collected of a forensic sample that is retained by the sample holder and positioned in the illumination plane, where imaging data includes images capturing reflections and/or shadows cast by features on the forensic sample illuminated sequentially by a variety of different illumination conditions. For example, an image of the forensic sample can be captured when illuminated by each light source individually and/or by different combinations of the multiple light sources.

In some embodiments, light from a light source on a user device, e.g., camera flash, can be directed into an imaging barrel using a light pipe, for example, to one or more apertures located radially relative to the sample casing, and where the sample can be rotated 360 degrees to approximately synthesize photometric imaging conditions.

In some embodiments, image processing algorithms and/or a pre-trained machine-learned model that have been trained on imaging data including a wide range of calibers of firearm ammunition and firearms can be utilized to generate a composite image from captured imaging data that includes multiple individual images, recognize features on the sample casing in the generated image, and develop understanding about the sample casing, e.g., make/model of the gun, identifying markings, firing conditions, etc. The composite image, e.g., generated from multiple images captured under different illumination conditions, can be can be utilized to generate a three-dimensional rendering which may then be used to recognize/track and compare particular features on the forensic sample.

The mobile device can collect forensic metadata, e.g., geolocation, time/date, or the like, and associate the metadata with the captured images and analysis. A database of forensic analysis reported results can be generated for use in on-going investigations and as a reference in future analysis/investigations. The forensic metadata can be utilized to provide a chain of custody record and can prevent contamination/tampering of evidence during an investigation. Metadata such as geolocation of evidence can be combined with other map-based information in order to extrapolate critical investigative data, e.g., tie a particular crime scene to one or more other related events.

“Glancing angle” illumination (for example, from 5 to 15 degrees) under low light conditions can be incorporated so that the edge features can be detected by the camera's image sensor without saturation or noise due to reflections. Illumination from higher angles (typically greater than 15 degrees) can additionally be utilized, optionally in combination with light diffusers and/or polarizers to reduce possible interference of reflections from the higher angle illumination on image signal integrity. The techniques described herein can be utilized to generate a “2D binary mask” of the shell surface topology from normal maps created by compositing images of the headstamp captured from a single overhead camera illuminated from multiple glancing angles around the shell. A detailed surface edge-map with surfaces with high reflectivity can be constructed, including metal and even completely mirrored finishes. Depth calibration data is captured from either area lights or structured light means and integrated into the overall reconstructed surface map.

### Example Operating Environment

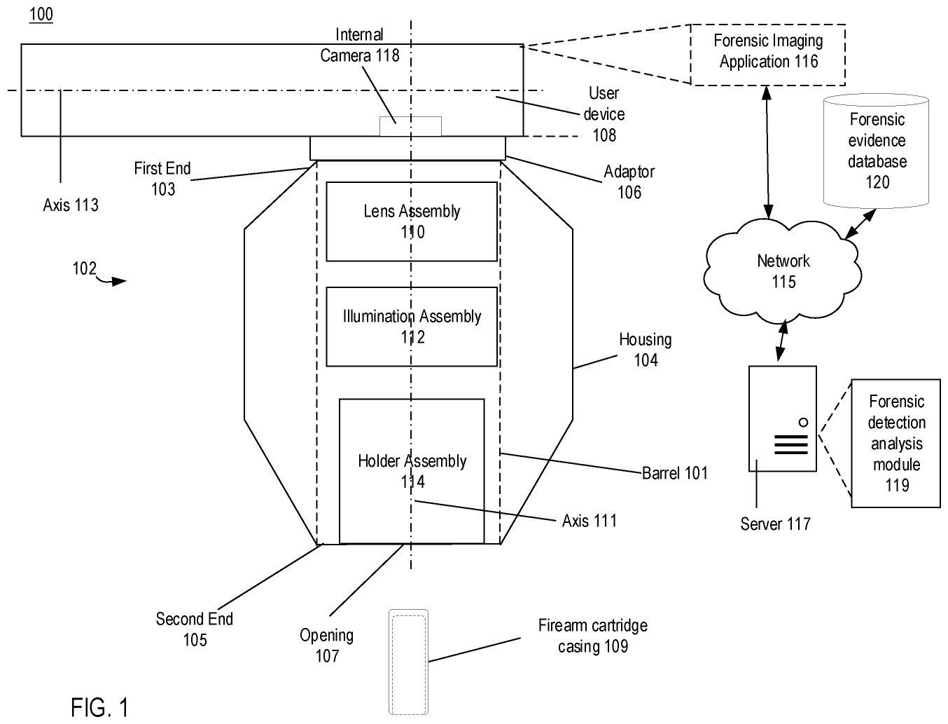

FIG. 1 depicts an example operating environment 100 of a forensic imaging apparatus 102. Forensic imaging apparatus 102 includes a housing 104 and an adaptor 106 affixing the forensic imaging apparatus 102 to user device 108, such as a mobile phone, and enables high resolution imaging of a firearm cartridge casing 109 by an internal camera 118 of user device 108

Adaptor 106 is attached to housing 104 at a first end 103, and configured to affix forensic imaging apparatus 102 to user device 108. At the opposite end 105, housing 104 includes an opening 107 configured to receive firearm cartridge casing 109, where opening 107 is sufficiently large to receive the firearm cartridge casing 109. For example, opening 107 can have a diameter larger than a diameter of various common firearm cartridges. In some embodiments, opening 107 has a diameter of 1 cm or more (e.g., 2 cm or more, such as up to 5 cm). Housing 104 can be formed in various shapes, for example, cylindrical, conical, spherical, planar, triangular, octagonal, or the like. Opening 107 can include an elastic/flexible material, e.g., rubber, configured to deform/stretch in order to accept a range of shell casing diameters.

Generally, housing 104 can be formed from one or more of a variety of suitable structural materials including, for example, plastic, metal, rubber, and the like. For example, housing 104 can be formed from materials that can be readily molded, machined, coated, and/or amenable to other standard manufacturing processes.

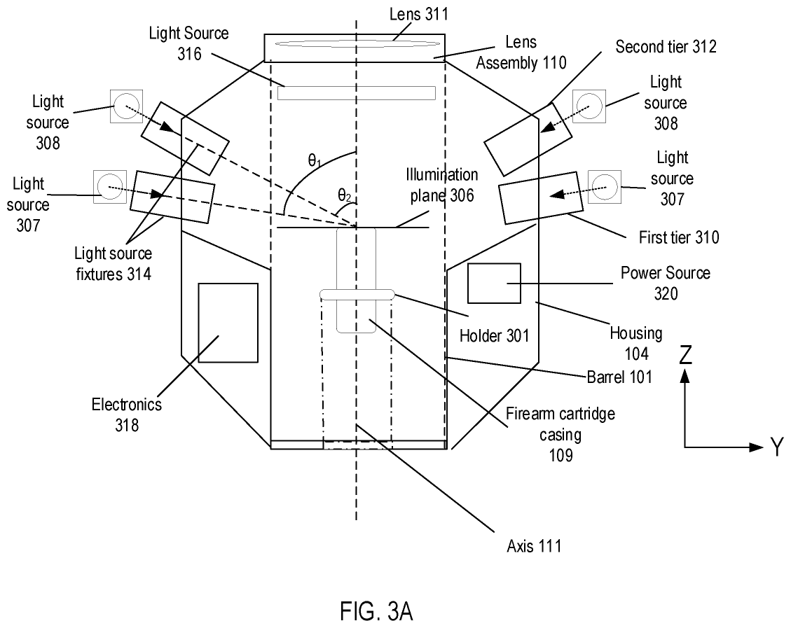

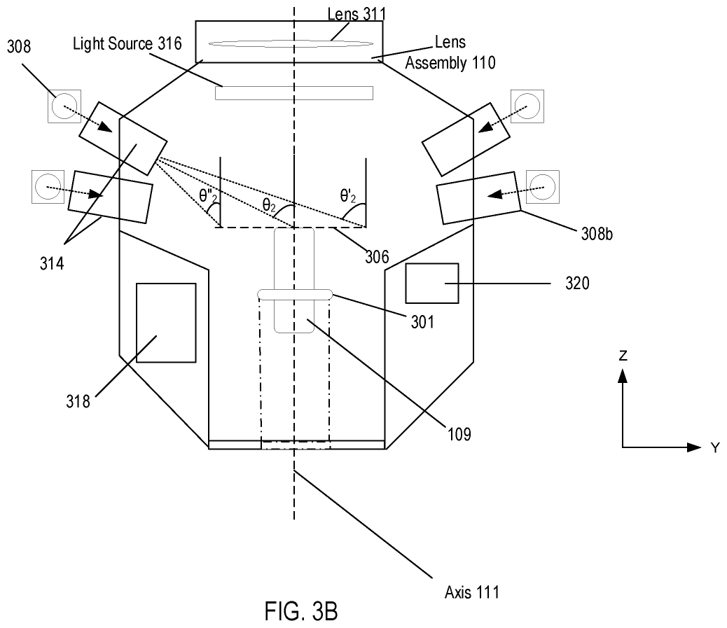

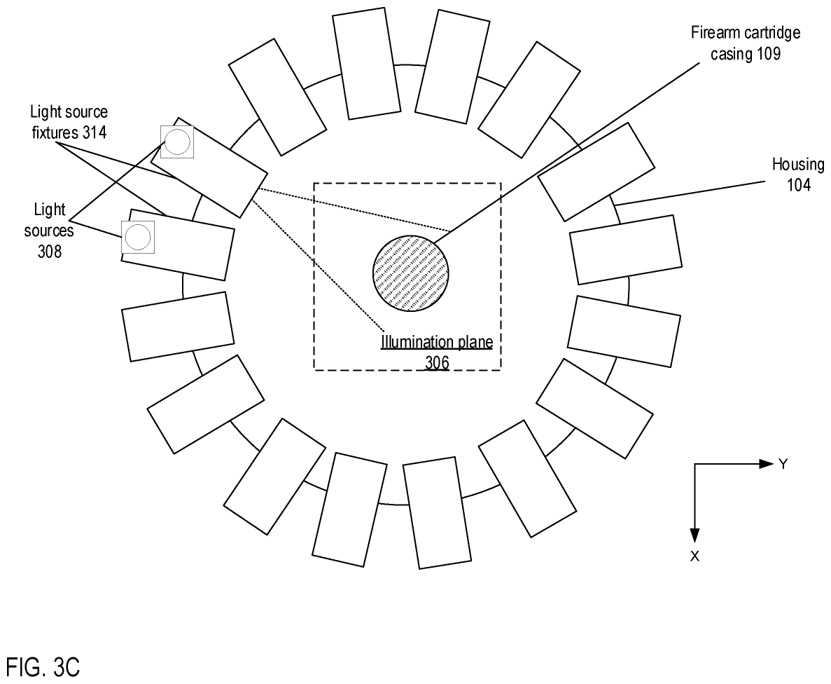

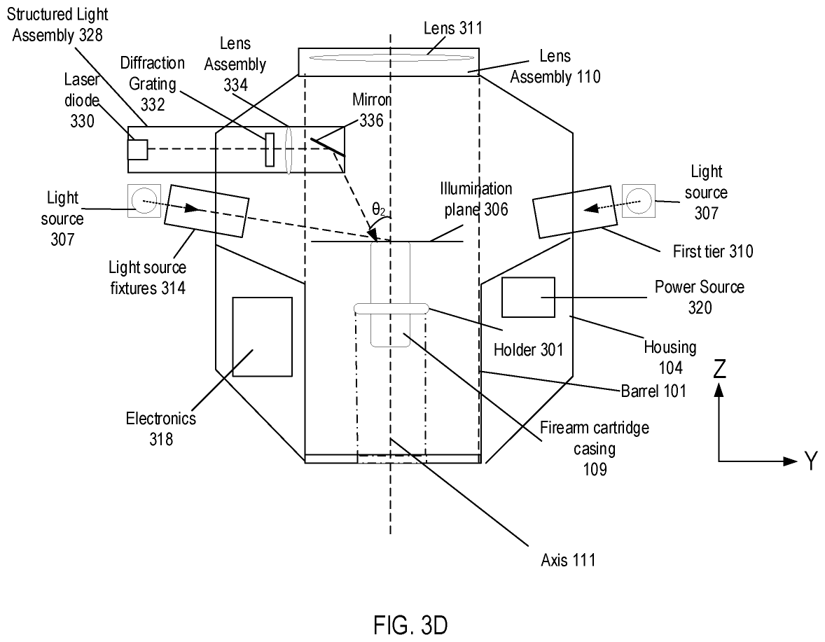

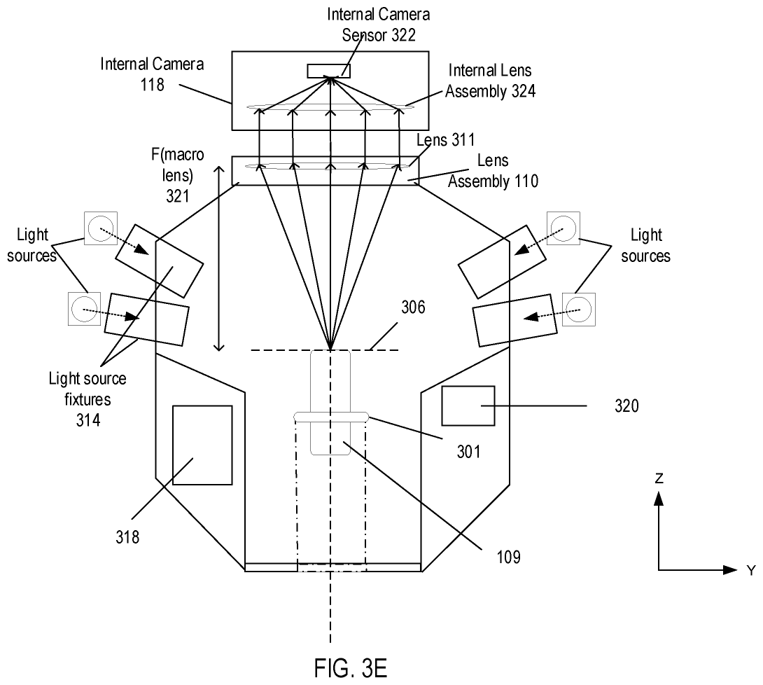

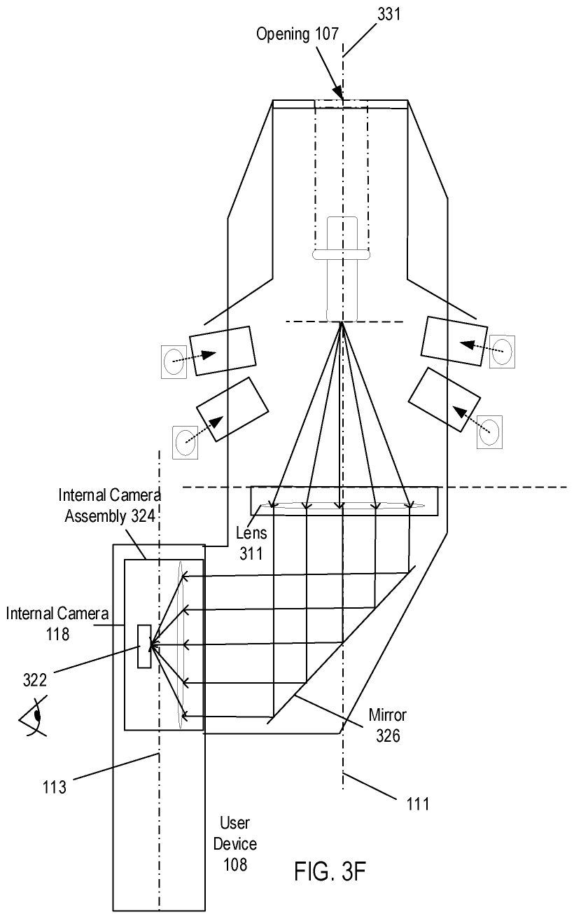

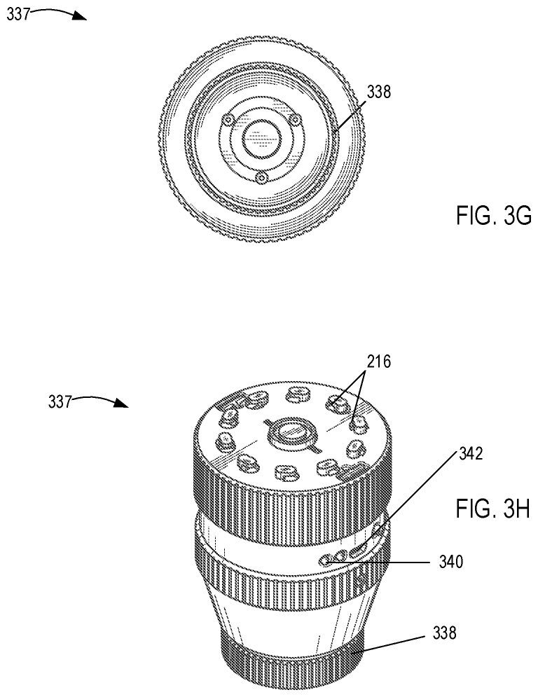

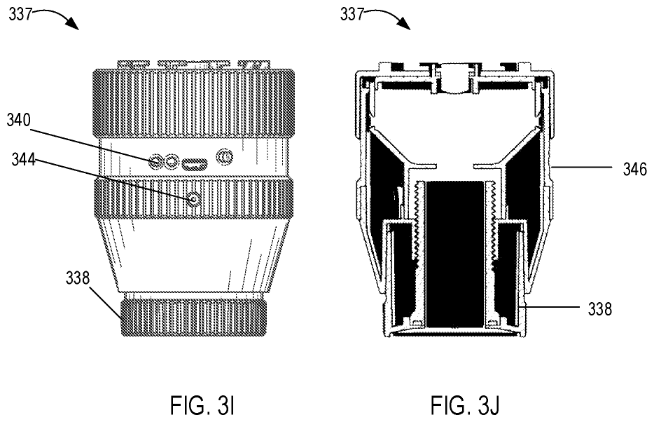

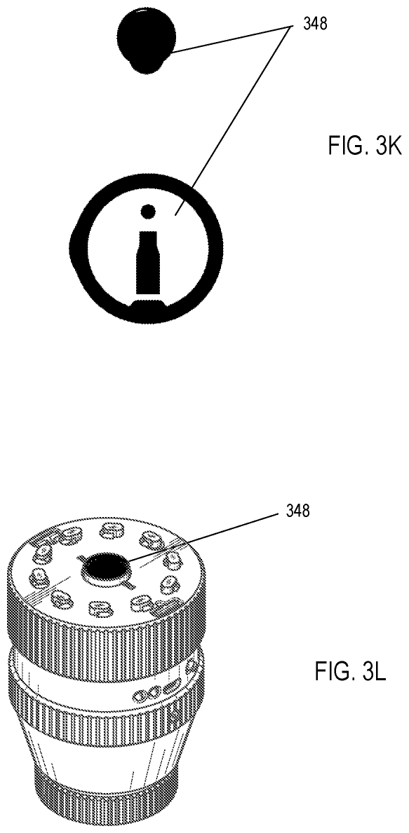

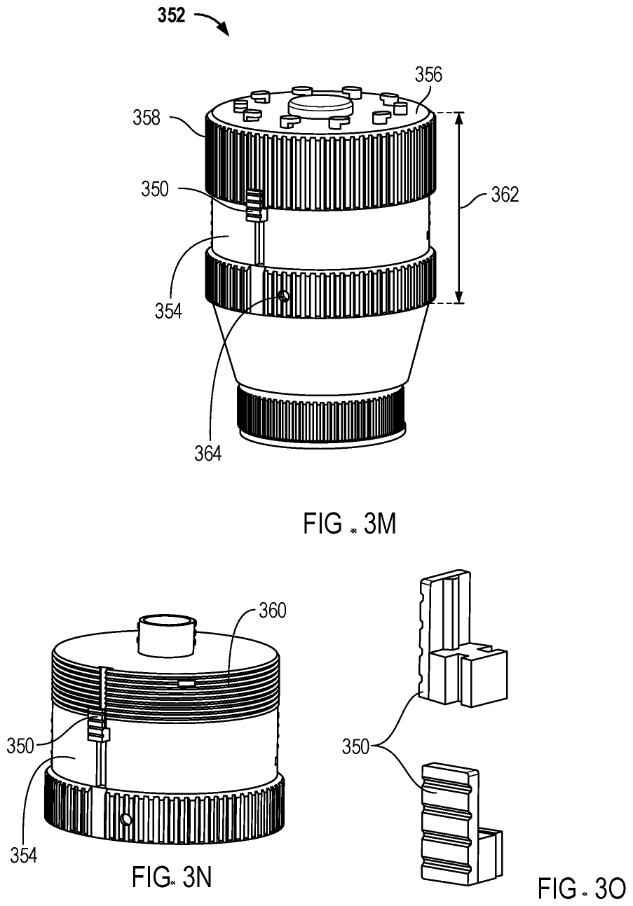

Housing 104 defines a barrel 101 extending along an axis 111 and forensic imaging apparatus 102 includes a lens assembly 110, an illumination assembly 112, and a holder assembly 114 arranged in sequence along axis 111. In some embodiments, one or more of the lens assembly 110, illumination assembly 112, and holder assembly 114 affixed within barrel 101, e.g., retained within the housing 104. Further details of an example lens assembly 110, illumination assembly 112, and holder assembly 114 are described below with reference to FIGS. 3A-3C.

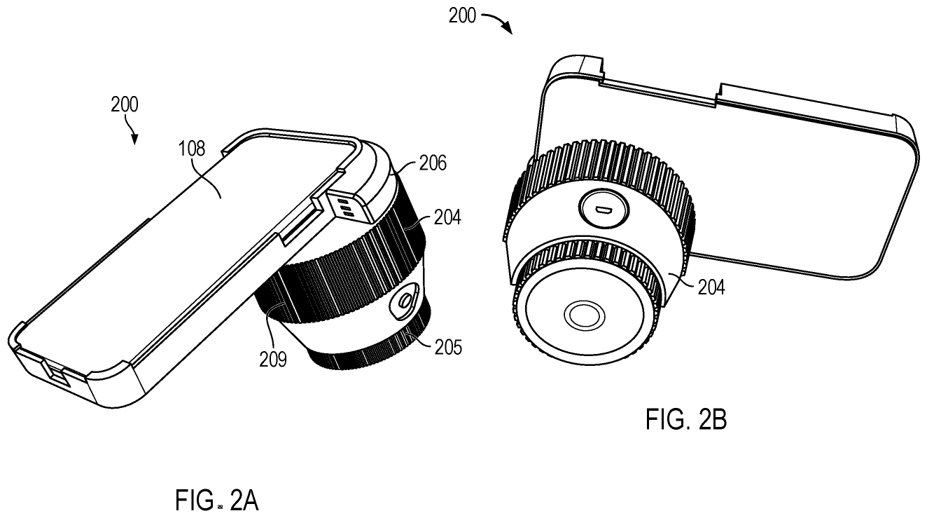

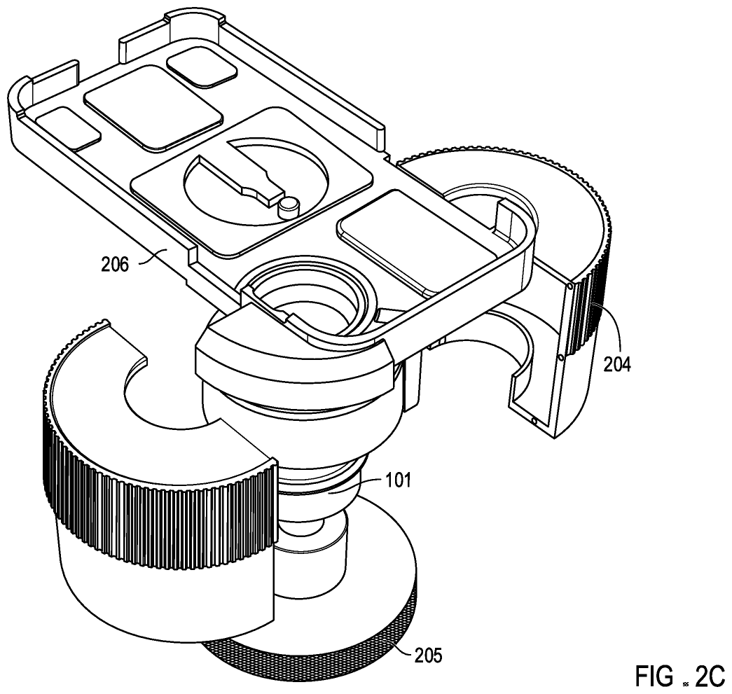

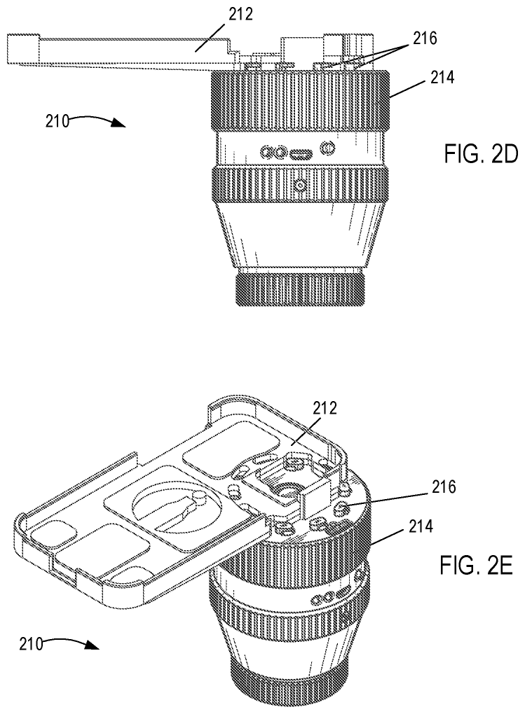

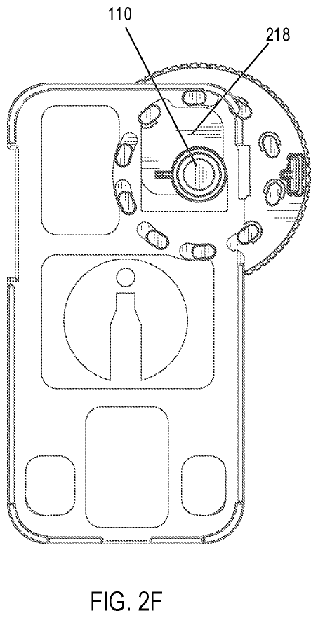

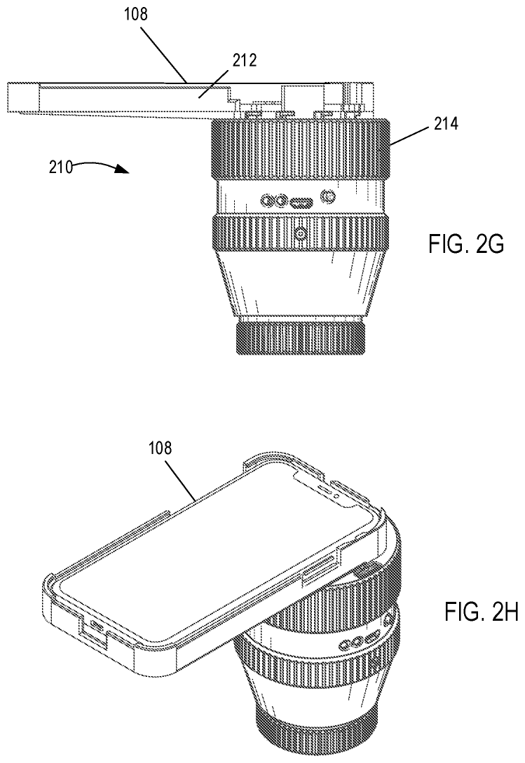

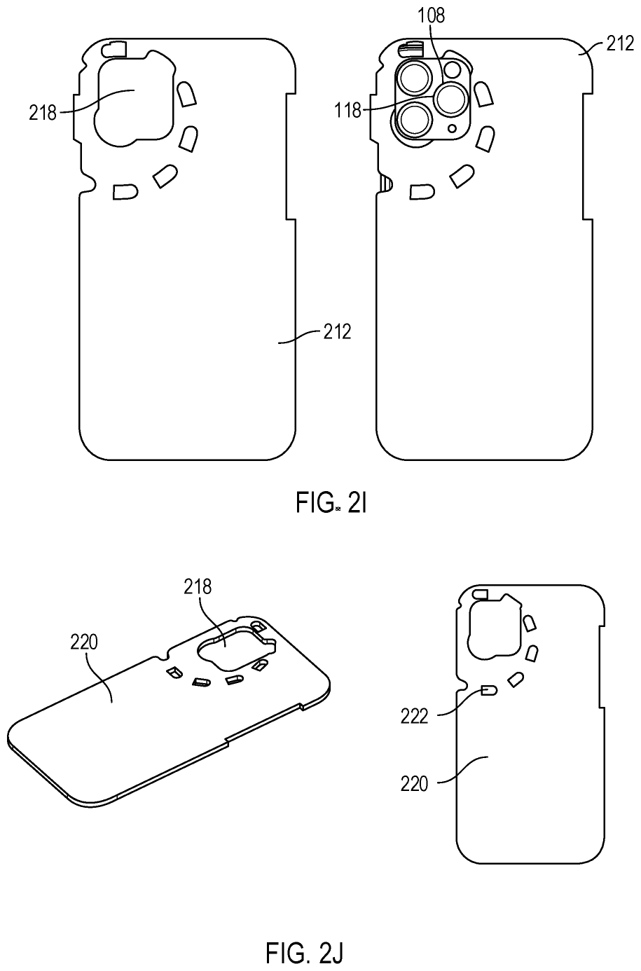

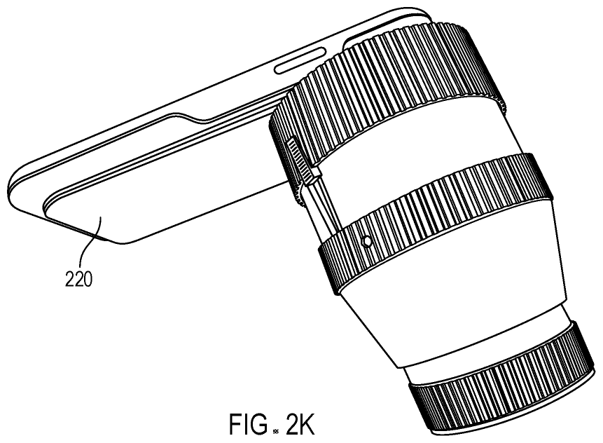

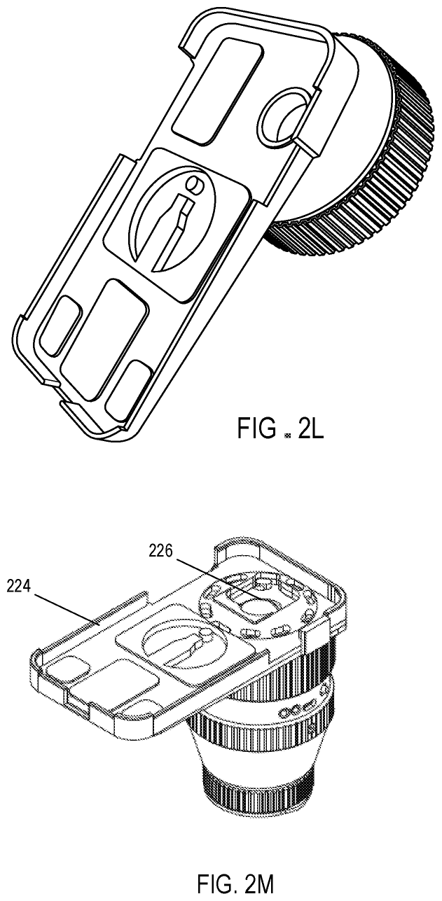

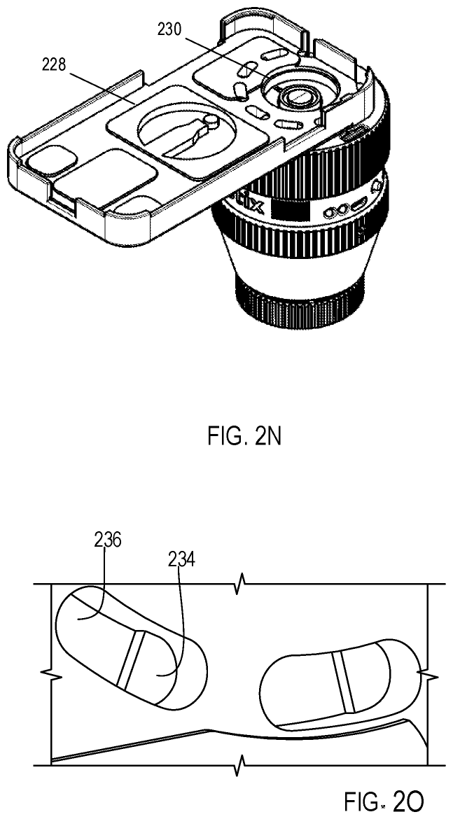

Adaptor 106 can include, for example, a clamp, a cradle, or the like, to attach the apparatus 102 at first end 103 to user device 108. Adaptor 106 can include, for example, a case-style fixture for a user device to retain at least a portion of the user device 108 as well as to hold the housing 104 at a particular orientation with respect to the user device 108, e.g., aligned with respect to an internal camera of the user device 108. Adaptor 106 can orient lens assembly 110 of the forensic imaging apparatus 102 at a particular orientation with respect to the internal camera of the user device 108, e.g., to coaxially align an optical axis of the internal camera with an optical axis of lens assembly 110 and/or to position an illumination plane in the apparatus 102 at a focal plane of the optical imaging system composed of the internal camera of the user device and lens assembly 110. In some embodiments, as depicted in FIG. 1, adaptor 106 is configured to orient housing 104 along axis 111 and perpendicular to a plane (defined by an axis 113 and an axis extending out of the plane of the figure) of the user device 108. In some embodiments, as depicted in FIG. 3F the adaptor 106 orients housing 104 and axis 111 parallel to an axis 113 of the user device 108. Further discussion of the adaptor 106 can be found below with reference to FIGS. 2A-2N and 3A-3F.

In general, lens assembly 110 is a macro lens formed by one or more lens elements, e.g., the macro lens can be a compound macro lens composed of two or more lens elements, or the macro lens can be formed from a single lens element. In some embodiments, the lens assembly can include multiple selectable lenses, e.g., on a rotating carousel, where a particular lens of the multiple selectable lenses (e.g., each having a different magnification) can be selectively rotated into the optical path along axis 111. In some embodiments, lens assembly or another portion of the housing 104 may be adjustable to adjust a distance between lens assembly and the internal camera 118, e.g., to adjust based on a focal length of a selected lens of the multiple selectable lenses.

In some embodiments, the one or more lenses of the lens assembly 110 can be selected to provide magnification of features of the firearm cartridge casing 109, e.g., breech face markings, firing pin markings, ejection markings, and the like. For example, lens assembly 110 can have a magnification of 1.5× or more (e.g., 2× or more, 3× or more, 4× or more, 5× or more, 10× or more). Further discussion of the lens assembly 110 is found below with reference to FIGS. 3A-3D.

Illumination assembly 112 can be affixed within the housing 104 and oriented to provide illumination within the barrel 101 defined by housing 104. Illumination assembly 112 can include multiple light sources arranged between the first end 103 and an illumination plane, where the multiple light sources may be operated alone or in combination to illuminate at least a portion of interior of the housing 104, e.g., an area including an illumination plane for imaging a firearm cartridge casing 109, and which may be operated in a manual, automatic, or semi-automatic manner. Illumination assembly 112 generally provides lighting sufficient for generating photometric conditions appropriate for capturing light reflected by surfaces of a portion of the firearm cartridge casing 109, e.g., a head region with internal camera 118. Internal camera 118 can include a lens assembly and sensor, e.g., CMOS sensor, CCD, or the like. In some embodiments, internal camera 118 includes a resolution of at least 12 megapixels, e.g., 16 megapixels. The amounts of light captured, e.g., shadows and reflections, by an internal camera 118 for a particular light source of multiple light source can be utilized to generate a three-dimensional model of the portion of the firearm cartridge casing. The three-dimensional model can be used to recognize and extract features of a firearm cartridge casing 109 positioned within the housing 104 and retained by the holder assembly 114 and be compared against similarly captured imaging data stored in forensic evidence storage database 120.

In some embodiments, operation of the illumination assembly 112 can be controlled through application 116 on the user device 108. Operations of the illumination assembly can include, for example, particular light sources of the multiple light sources that are in ON versus OFF states, intensities of the light sources, and the like.

Illumination assembly 112 can include light sources of different types, e.g., light emitting diodes (LEDs), diffuser area lights, light propagated from the flash of device 108 through a light pipe, laser-based coherent light sources coupled to a diffraction grating, etc. Each of the light sources of the illumination assembly can be oriented such that at least a portion of light output of each of the light sources is incident on an illumination plane within the housing 104.

Holder assembly 114 can include a holder that is affixed within the barrel 101 defined by housing 104 and configured to retain the firearm cartridge casing 109 within the housing 104 and relative to the illumination assembly 112 and lens assembly 110 such that the firearm cartridge casing 109 is held at an illumination plane during an imaging process. Holder assembly 114 can include a casing stabilizer including fixtures for holding the firearm cartridge casing 109.

In some embodiments, holder assembly 114 can include a holder that includes a mechanical iris for securing and positioning the firearm cartridge casing 109 in a particular orientation relative to the forensic imaging apparatus. The mechanical iris can include multiple moving blades, where each moving blade overlaps another, different moving blade of the multiple moving blades, and where the mechanical iris includes an opening through which a firearm cartridge casing 109 can at least partially pass through. Holder assembly 114 can include an external adjustment point located at least partially on an exterior of the housing 104, where a user can use the external adjustment point to loosen or tighten the holder assembly, e.g., open or close the mechanical iris, by adjusting the external adjustment point. In one example, the external adjustment point can be a knob or rotating fixture that a user can turn in a particular direction to adjust the holder assembly 114, e.g., open/close the mechanical iris.

In some embodiments, the holder assembly can include internal registration detents which mate with bumps on the external adjustment point instead of a mechanical iris to affix the shell casing in place. In some embodiments, the shell casing can be placed into a simple cylindrical chuck and pressed into the opening 107 to position the shell in place.

In some embodiments, as described in further detail with reference to FIG. 3J, a portion of housing 104 can be adjustable such that a length of the housing, e.g., a length between second end 105 and an illumination plane of the illumination assembly 112 can be adjusted. In other words, a portion of the housing 104 can be adjusted to accommodate different length firearm cartridge casings 109 where casings of different lengths can be retained within the housing such that a portion of the different casings, e.g., a headstamp, are each located at the illumination plane of the apparatus 102 by adjusting the portion of the housing 104. For example, a length of the portion of the housing 104 can be adjusted to be longer to accommodate a longer casing and the length of the portion of the housing 104 can be shortened to accommodate a shorter casing within the housing 104.

In general, user device 108 may include devices that host and display applications including an application environment. For example, a user device 108 is a user device that hosts one or more native applications that includes an application interface (e.g., a graphical-user interface (GUI)). The user device 108 may be a cellular phone or a non-cellular locally networked device with a display. The user device 108 may include a cell phone, a smart phone, a tablet PC, a personal digital assistant (“PDA”), a mobile data terminal (“MDT”), or any other portable device configured to communicate over a network 115 and display information. For example, implementations may also include Android-type devices (e.g., as provided by Google), electronic organizers, iOS-type devices (e.g., iPhone devices and others provided by Apple), other communication devices, and handheld or portable electronic devices for gaming, communications, and/or data organization. The user device 108 may perform functions unrelated to a forensic imaging application 116, such as placing personal telephone calls, playing music, playing video, displaying pictures, browsing the Internet, maintaining an electronic calendar, etc.

User device 108 can include a processor coupled to a memory to execute forensic imaging application 116 to perform forensic imaging data collection and analysis. For example, the processor can be utilized interface/control the operations of forensic imaging apparatus 102 and an internal camera 118 of the user device 108 to capture imaging and video data of surface(s) of a firearm cartridge casing 109. Further, processor can analyze the image/video data to detect a variety of striations including, for example, breech face marking, firing pin markings, ejection marking, and the like. The processor may generate forensic sample data including images, video, GPS data, and the like.

In some embodiments, the processor may be operable to perform one or more optical character recognition (OCR) or another text-based recognition image processing on the captured images, for example, to recognize and process text-based data within the captured images. For example, the processor can be operable to perform OCR on the captured images to identify characters located on a bullet shell casing, e.g., “luger,” “9 MM,” etc., and generate forensic sample data including the text-based data.

In some embodiments, the processor may be operable to generate ballistic imaging metadata from the ballistic specimen data, e.g., locally stored data on user device 108 or stored on a cloud-based server 117. For example, the processor may generate a three-dimensional mathematical model of the specimen from the captured image data, detecting one or more dimensions of the tool marks to form an associated set of metadata.

In some embodiments, the processor may be operable to generate and send a hit report of the forensic evidence to a receiving networked device, e.g., a central processing location. In some embodiments, the processor may be operable to perform preliminary analysis on the captured imaging data, where striation markings are detected within the captured imaging data using past ballistic imaging data downloaded from a database, e.g., via a network, and the sample striation image patterns stored within the database. The processor may be operable to mark the detected striations on the captured image data prior to sending the marked image data within the ballistic specimen data to the receiving networked device. Further the processor may be able to identify criminal patterns based upon the hit report at the user device 108 and filter suspect data based upon these identified criminal patterns, along with a set of forensic policies.

User device 108 can include a forensic imaging application 116, through which a user can interact with the forensic imaging apparatus 102. Forensic imaging application 116 refers to a software/firmware program running on the corresponding user device that enables the user interface and features described throughout, and is a system through which the forensic imaging apparatus 102 may communicate with the user and with location tracking services available on user device 108. The user device 108 may load or install the forensic imaging application 116 based on data received over a network 115 or data received from local media. The forensic imaging application 116 runs on user devices platforms, such as iPhone, Google Android, Windows Mobile, etc. The user device 108 may send/receive data related to the forensic imaging apparatus 102 through a network. In one example, the forensic imaging application 116 enables the user device 108 to capture imaging data for the firearm cartridge cases 109 using the forensic imaging apparatus 102.

In some embodiments, forensic imaging application 116 can guide an operator of user device 108 and forensic imaging apparatus 102 through a process of one or more of collecting, imaging, and analyzing a forensic sample, e.g., a firearm cartridge casing 109. Forensic imaging application 116 can include a graphical user interface including a visualization of the firearm cartridge casing 109 as captured by internal camera 118 while the firearm cartridge casing 109 is inserted into the forensic imaging apparatus 102, e.g., to assist in insertion/retention of the casing into holder assembly 114. Forensic imaging application 116 can guide an operator through the process of capturing a set of images under various imaging conditions.

The forensic imaging application 116 can have access to location tracking services (e.g., a GPS) available on the user device 108 such that the forensic imaging application 116 can enable and disable the location tracking services on the user device 108. GPS coordinates of a location associated with the forensic sample, e.g., a location where the firearm cartridge casing 109 is found, can be captured. Forensic imaging application 116 can include, for example, camera capture software, which enables a user to capture imaging data of the firearm cartridge casing 109 in an automatic, semi-automatic, and/or manual manner.

In some embodiments, user device 108 can send/receive data via a network 115. The network 115 can be configured to enable exchange of electronic communication between devices connected to the network. The network 115 can include, for example, one or more of the Internet, Wide Area Networks (WANs), Local Area Networks (LANs), analog or digital wired and wireless telephone networks (e.g., a public switched telephone network 115 (PSTN), Integrated Services Digital Network 115 (ISDN), a cellular network, and Digital Subscriber Line (DSL), radio, television, cable, satellite, or any other delivery or tunneling mechanism for carrying data. A network 115 may include multiple networks or subnetworks, each of which may include, for example, a wired or wireless data pathway. A network 115 may include a circuit-switched network, a packet-switched data network, or any other network 115 able to carry electronic communications (e.g., data or voice communications). For example, a network 115 may include networks based on the Internet protocol (IP), asynchronous transfer mode (ATM), the PSTN, packet-switched networks based on IP, X.25, or Frame Relay, or other comparable technologies and may support voice using, for example, VOIP, or other comparable protocols used for voice communications. A network 115 may include one or more networks that include wireless data channels and wireless voice channels. A network 115 may be a wireless network, a broadband network, or a combination of networks includes a wireless network 115 and a broadband network.

In some embodiments, user device 108 can be in data communication with a cloud-based server 117 over the network. Cloud-based server 117 can include one or more processors, memory coupled to the processor(s), and database(s), e.g., a forensic evidence database 120, on which raw and/or processed imaging data and metadata associated with firearm cartridge casings 109 can be stored. The server 117 can include a forensic detection analysis module 119 for receiving data, e.g., imaging data, metadata, and the like, from the user device 108, performing analysis on the received data, and generating reports based on the analyzed data. In some embodiments, a portion or all of the storage of raw and/or processed imaging data and metadata, analysis of the received data, and report generation described herein can be performed by the cloud-based server 117. The cloud-based server 117 can be operable to provide generated reports to the user device 108, e.g., via email, text/SMS, within the forensic imaging application 116, or the like.

In some embodiments, the forensic imaging application 116 can generate and send data via the network 115 to the cloud-based server 117 including imaging data, video data, GPS data, and the like. In response, the forensic detection analysis module 119 on server 117 can generate ballistic imaging metadata from the provided data. In one example, the forensic detection analysis module 119 can generate a three-dimensional mathematical model of the firearm cartridge casing 109 from the captured imaging data, detect one or more features, e.g., dimensions of the tool marks, and generate a set of metadata for the firearm cartridge casing 109. The server 117 can generate a hit report of the firearm cartridge casing 109 and provide the hit report to the user device 108 via the network.

In some embodiments, the forensic detection analysis module 119 may detect one or more dimension measurements of one or more tool marks and identify an associated position of each tool mark on the firearm cartridge casing 109. The dimension measurements may include the number of tool marks, the width and depth of each tool mark, the angle and direction of each spiral impression within the specimen, and the like. The forensic detection analysis module 119 may compare the dimension measurement and the position to a second set of stored forensic evidence measurements, e.g., stored on database 120. Further, forensic detection analysis module 119 may detect a best match within a predetermine range of the dimension measurement and position. As a result, the forensic detection analysis module 119 can identify a forensic evidence specimen and a suspect associated with the detected best match and generate a list of each identified casing 109 and an associated suspect to form the hit report having suspect data.

Some or all of the operations described herein with reference to the forensic detection analysis module 119 can be performed on the user device 108. For example, a preliminary analysis can be performed by the forensic imaging application 116 on the captured imaging data at the user device 108, where striation markings are detected within the captured image data using the past ballistic imaging data downloaded from the networked server 117 and sample striation image patterns stored within a database 120. The processor of user device 108 can convert the two-dimensional images captured by camera 118 into a three-dimensional model of the forensic evidence to be stored in database 120.

Database 120 can include multiple databases each storing particular set of data, e.g., including one for network server data, sample tool marking patterns, user data, forensic policies, and ballistic specimen (e.g., firearm cartridge casing) data. Historical forensic data, e.g., forensic reports generated for multiple casings 109, manufacturer data, e.g., “golden” samples for casing/firearm pairs, and human-expert generated reports, e.g., using three-dimensional scanners, can be stored on database 120 and accessed by forensic imaging application 116 and/or forensic detection analysis 119.

FIGS. 2A-2C depict schematic views, of an example forensic imaging apparatus 200 with user device 108 attached. Forensic imaging apparatus 200 includes an adaptor 206 that orients and affixes the forensic imaging apparatus 200 to user device 108. As depicted in FIG. 2A, adaptor 206 includes a case-type adaptor, where user device 108, in this case, a smart phone, fits into the smart phone case such that the housing 204 and components therein are oriented and affixed relative to the user device 108. Housing 204 can include an adjustment point 205 including exterior texture, e.g., surface marks, to assist a user in holding and adjusting a position of housing 204. For example, grip marks can be used to assist a user in holding and turning a portion of the housing 204. In certain examples, the housing features a lens adjustment ring 209 having an exterior texture to allow a user to make adjustments to the lens assembly in the housing, e.g., to select a particular lens of multiple selectable lenses and/or to adjust focus of the lens assembly.

FIGS. 2D-2H depict schematic views of another example forensic imaging apparatus 210. In some implementations, as depicted in FIGS. 2D-2H, an adaptor 212 includes a case to accommodate a mobile phone or smart device, where the adaptor 212 is affixed to the housing 214 by a set of fixtures 216. In the embodiment depicted in in FIGS. 2D-2H, the adaptor 212 is affixed to the housing 214 by a set of fixtures 216, e.g., bollards, located on a surface of the housing 214, where each bollard is slotted and locked into a receiving slots located in the adaptor 212.

In some implementations, as depicted in FIGS. 2E-2F, the set of bollards are arranged in a partial or complete circular pattern, e.g., arranged around a circular perimeter surrounding a location of the lens assembly, e.g., lens assembly 110, of the apparatus 200.

FIGS. 2G and 2H depict an example user device 108 secured in the adaptor 212 (e.g., mobile phone within a case) and attached to the housing 214 via the set of fixtures 216. Adaptor 212 can additionally include slots or other cut-out portions to allow a user to access various functionalities of the user device 108 when the user device 108 is retained within the adaptor 212, e.g., access a volume button, a power button, data communication port, etc.

In some implementations, adaptor 212 includes a slot 218 such that the lens assembly 110 of the apparatus has line of sight to a camera of the mobile device, e.g., camera 118 (not shown) of user device 108.

FIGS. 2I-2J depict schematic views of example aspects of forensic imaging apparatuses. FIG. 2I depicts views of the adaptor 212 (e.g., mobile phone case) with and without a user device 108 secured within the case. As depicted, slot 218 in the adaptor 212 can accommodate one or more internal cameras 118 of the user device 108, when the user device is retained within the adaptor 212.

In some implementations, an adaptor can be an insert 220 (i.e., a mezzanine card), for example, as depicted in FIGS. 2J-2K. As depicted in FIGS. 2J and 2K, insert 220 can be affixed to a client device or a case of a client device via one or more attachment points, e.g., magnetic, adhesive, Velcro™, or another type of attachment. For example, a case of a client device can include magnetic component(s), such that an insert 220 made of a magnetic metal can be affixed and retained to the case by the magnet(s). In another example, an adhesive (e.g., a double-sided tape or adhesive putty) can be utilized to temporarily or permanently bond the insert (e.g., as depicted in FIGS. 2J and 2K) to a mobile device or case retaining the mobile device. The insert 220 can include one or more cut-out portions to accommodate locations of internal cameras of the client device as well as one or more slots 222 to receive the attachment points (e.g., bollards) of the housing 104.

FIGS. 2L-2N depict schematic views of example forensic imaging apparatuses. In some implementations, as depicted in FIG. 2L, an adaptor 212 can be affixed to the housing via a quick connect/disconnect connector, e.g., a Bayonet Neill-Concelman (BNC) style connector, including a positive locking mechanism.

In some implementations, as depicted in FIGS. 2M and 2N, an adaptor can be configured to accommodate various user device designs including varying locations of camera sensors with respect to the user device layout. In other words, an orientation of a cut-out portion of an adaptor can depend in part on a location of one or more internal cameras 118 of user device 108. For example, as depicted in FIG. 2M, adaptor 224 can include a cut-out portion 226 oriented on the adaptor 224 to accommodate one or more internal cameras 118 that are located along a central axis of a user device. In another example, as depicted in FIG. 2N, adaptor 228 can include a cut-out portion 230 oriented on the adaptor 228 to accommodate one or more internal cameras located along an edge of a user device. The adaptor can include slots to affix the housing with the multiple bollards such that the internal camera of the client device is aligned along an axis 111 when the client device is retained by the adaptor.

Cut-out portion of an adaptor, e.g., as depicted in FIGS. 2F, 2I, 2M, 2N, can have a round shape (e.g., as depicted in FIG. 2N), a rectangular shape, or another shape to accommodate an orientation and configuration of one or more cameras of the user device. For example, a cut-out portion 218 as depicted in FIG. 2F can accommodate a three-camera configuration of a user device when the user device is secured within the adaptor.

In some implementations, as depicted in FIG. 2O, the slots 222 of the adaptor can include ramp-like features 234 within the register wells 236, which may function to add friction between the bollards of the housing and the slots 222 of the adaptor when the apparatus is secured to the adaptor.

FIGS. 3A-3B depict schematic cross-sectional schematic views of an example of forensic imaging apparatus 102 perpendicular to the illumination plane. FIG. 3C shows a schematic cross-sectional view in the illumination plane. FIG. 3D depicts a schematic cross-sectional view of another example forensic imaging apparatus 102 perpendicular to the illumination plane.

In the embodiments depicted in FIGS. 3A-3F, holder assembly 114 including a holder 301, e.g., a mechanical iris, adjustable stabilization points/grips, etc., is configured to retain and stabilize the firearm cartridge casing 109 within the housing 104 so that a portion of the firearm cartridge casing 109, e.g., a head region of the casing, is located at an illumination plane 306. The head of the casing can include a case head of the casing e.g., one or more of a base of the casing, a rim of the casing, extractor groove, and a portion of the body of the firearm cartridge casing 109. For example, the head of the casing can include a base of the casing and heel of the casing. Holder assembly 114 can additionally be configured to accommodate a range of diameters for various firearm shell casings and prevent external light from entering within housing 104 when the casing 109 is secured within the holder assembly.

Lens assembly 110 includes a lens element 311, for example, forming a macro lens, where the lens assembly 110 can define a focal plane at the illumination plane 306. In some embodiments, lens assembly 110 can include multiple selectable lenses 311, e.g., each having a different magnification. The multiple selectable lenses 311 can be retained in an automated, semi-automated, or manual housing, e.g., a lens/filter wheel that allows for a particular lens 311 to be aligned along axis 111. Lens assembly 110 can additionally include one or more adjustment points for altering a position of the lens 311 along the axis 111, e.g., to align the lens 311 such that the focal point of the lens is aligned with the illumination plane 306.

In some embodiments, a conical ring can be utilized to retain lens 311 within the lens assembly 110. Lens 311 can include a custom molded lens to optimize geometry for the apparatus 102 or can incorporate off-the-shelf optics.

In some embodiments, as depicted in FIGS. 3A-3E, illumination assembly includes multiple light sources. For example, LED illumination is used, and illumination assembly 112 can include one or more rows of 4 to 32 (or more) illumination sources (e.g. 16) positioned radially around the casing 109. In another example, structured light sources, e.g., laser diodes, can be used, and illumination assembly 112 can include one or more structured light assemblies positioned radially around the casing 109.

In some embodiments, light from the flash from device 108 is utilized as a light source, and an aperture is used to direct light from the flash to the illumination plane. The casing 109 can be rotated 360 degrees either manually through a series of registration positions or through the use of a small motor to enable the photometric process to run.

Specifically, the illumination assembly embodiment shown in FIGS. 3A to 3D includes multiple point light sources arranged in two different tiers with respect to illumination plane 306, including light sources 307 arranged in a first tier 310 to provide illumination at the illumination plane with an angle of incidence θ₁ and light sources 308 arranged in a second tier 312 to illuminate the illumination plane at a second angle of incidence θ₂, smaller than θ₁. At least one tier of illumination can be utilized. Additional tiers of illumination at higher angles of incidence can be utilized to provide more illumination detail, while maintaining reflections off the metallic surface below a threshold. Note that the angle of incidence is measured from the normal to the illumination plane, which corresponds to axis 111. A point light source is considered to be a light source that is sufficiently small that, for purposes of analyzing images acquired using the light source, all the light rays useful for tracing the path of the light to the camera can be considered to originate from a single point.

For both tiers 310 and 312 shown in the example illustration, e.g., in FIG. 3A, the point light sources illuminate the illumination plane at glancing angles of incidence. In some embodiments, θ₁ is 75° or more (e.g., 75° or more, 80° or more, 82.5° or more, such as 85°). In certain embodiments, θ₂ is 30° or more (e.g., 40° or more, 50° or more 60° or more, 65° or more, 70° or more, such as 75°). In some embodiments, polarizers and/or filters can be implemented in combination with one or more of the tiers, for example, to reduce reflections generated by the light sources.

Light sources 307 and 308 can be affixed to housing 104 by respective light source fixtures 314. The light sources can be recessed within the light source fixtures which reduces stray light and/or reflection from a surface of the light sources from reaching the illumination plane. For example, each light source can be positioned within light source fixture 314 at an offset register that results in a louver effect.

Generally, a variety of different light sources can be used. Typically, the light sources are selected to provide sufficient light intensity at wavelengths suitable for the sensor used in the user device camera 118, usually visible light. In some embodiments, light sources 308 are light emitting diodes (LEDs), e.g., surface mount LED lights (SMD LEDs). The LEDs can be broadband emission, e.g., white light-emitting LEDs. In some cases, colored light sources can be used. For example, red, green, and/or blue LEDs can be used. In some embodiments, structured light sources, e.g., collimated light sources can be used. In one example, structured light sources can include laser diodes.

In addition to point light sources 307 and 308, the illumination assembly can include one or more spatially-extended light sources 316. A spatially-extended light source is a light source that is too large to be considered a point light source. Spatially-extended light sources can be considered, for purposes of ray tracing, as a combination of multiple point light sources. The spatially-extended light sources are positioned with respect to the illumination plane 306 to provide uniform surface illumination on the head of the firearm cartridge casing 109 within a field of view of the lens assembly 110 when the firearm cartridge casing 109 is held at the illumination plane 306 by the holder assembly 114. For example, one or more light sources 316, e.g., three light sources 316, can include a light emitting element (e.g., a LED) with a diffusing light guide arranged to emit light across an extended area and positioned perpendicular to axis 111 and between the illumination plane 306 and the lens assembly 110.

In some embodiments, light sources 307 and 308 can be arranged in the first tier 310 and second tier 312, respectively, around a perimeter of housing 104 and evenly distributed around the perimeter of housing 104. A number of light sources 307, 308 in each of the first tier 310 and second tier 312 can range between, for example, 16-64 light sources, e.g., 32 light sources. A first number of light sources 307 in first tier 310 can be a same number or different number than a second number of light sources 308 in second tier 312.

Generally, illumination from point light sources 307 and 308 is incident across the illumination plane 306 typically at a fixed angle of incidence and at multiple azimuthal positions about axis 111. This is illustrated in FIG. 3B, which shows divergent light from one of the point light sources 308 in tier 312. Generally, each point light source is considered to have a nominal incident angle at the illumination plane as determined at axis 111. This is denoted θ₂ for the example illustrated in FIG. 3B. At the closest edge of the illumination plane to the light source, the illumination has an incident angle θ₂′. At the furthest edge, the illumination has an incident angle θ₂″. In one example, an nominal incident angle at the illumination plane θ₂ is 75 degrees and a range of incident angles between a closest edge of the illumination plane θ₂′ and a furthest edge θ₂″ can be range between 1 to 15 degrees from the nominal incident angle, e.g., 74 to 76 degrees, 60 to 90 degrees, 65-85 degrees, etc.

Generally, the divergence of a point light source, and hence the range of incident angles at the illumination plane, is determined by the emission pattern from the light source and the degree of collimation of the emitted light by the light source fixtures and/or any optical elements in the path of the light.

In some embodiments, light sources 308 are distributed radially along the perimeter of housing 104. Referring now to FIG. 3C, light sources 308 in respective light source fixtures 314 are arranged in a radial manner along a perimeter of housing 104, such that the light sources 308 are arranged at different azimuthal angles with respect to axis 111. A distribution of the light source/light source fixtures can be evenly distributed around the perimeter of the housing 104. In one example, as depicted in FIG. 3C, a tier of light sources, e.g., first tier 310 and/or second tier 312, can include 16 light sources. Light sources 308 in respective light source fixtures 314 can be arranged in the radial manner such that a portion of the light emitted by each light source 308 when turned “ON” is incident on the illumination plane 306. The intensity of light incident on the illumination plane 306 by each light source 308 can be substantially constant across an area of the illumination plane 306 including the firearm cartridge casing 109.

In some embodiments, a first set of light sources, e.g., light sources 308 in first tier 310, and a second set of light sources, e.g., light sources 308 in second tier 312, are each arranged at different azimuthal angles with respect to axis 111.

In some embodiments, as embodied in FIG. 3D, the illumination assembly can include one or more structured light sources, e.g., structured light assembly 328 including one or more laser diodes or otherwise collimated sources of light coupled to a diffraction grating(s). The structured light assembly 328 can include, for example, a laser diode 330 or otherwise collimated light source (e.g., a divergent light source with collimating optics), a diffraction grating 332, and lens assembly 334. Structured light assembly 328 can include a mirror 336 to direct light from the structured light assembly 328 to the illumination plane 306. In certain examples, the structured light assembly 328 can be oriented with respect to a surface normal of the illumination plane 306, for example, between 60-80 degrees, e.g., 70 degrees utilizing a mirror or mirrors if necessary to redirect the light. The structured light assembly 328 can be utilized to generate a structured light pattern at illumination plane 306, e.g., a line or array of light features projected on the illumination plane 306, for example, to enable depth calibration of the surface features.

As noted above, and referring to FIG. 3E, lens 311, e.g., a macro lens, is positioned within a lens assembly 110 such that illumination plane 306 is located at a focal length 321 of the lens 311. Lens assembly 110 is designed to form an imaging system with an internal lens assembly 324 of the internal camera 118 of the user device to image objects (e.g., casing head) at the illumination plane 306 to a camera sensor 322 of the internal camera. In some embodiments, an axial position of lens 311 can be adjustable to change the precise axial location of the focal plane of the imaging system. e.g., using an automated or manual actuator. A carousel mechanism can be utilized, in which the lens switch is mechanically coupled to the shell holder 301 (and thus illumination plane 306) to move it up or down, as appropriate to keep the cartridge headstamp in proper focus for the respective macro lens magnification.

In some embodiments, interior surfaces of the forensic imaging apparatus 102, e.g., barrel 101, light source fixtures 314, holder 301, can be coated with a black light-absorbing coating and/or paint to reduce reflection effects including stray light.

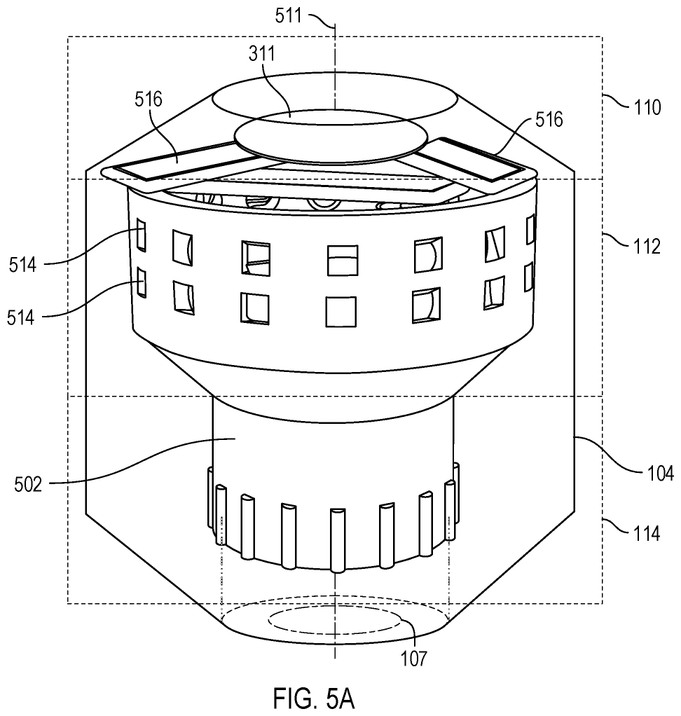

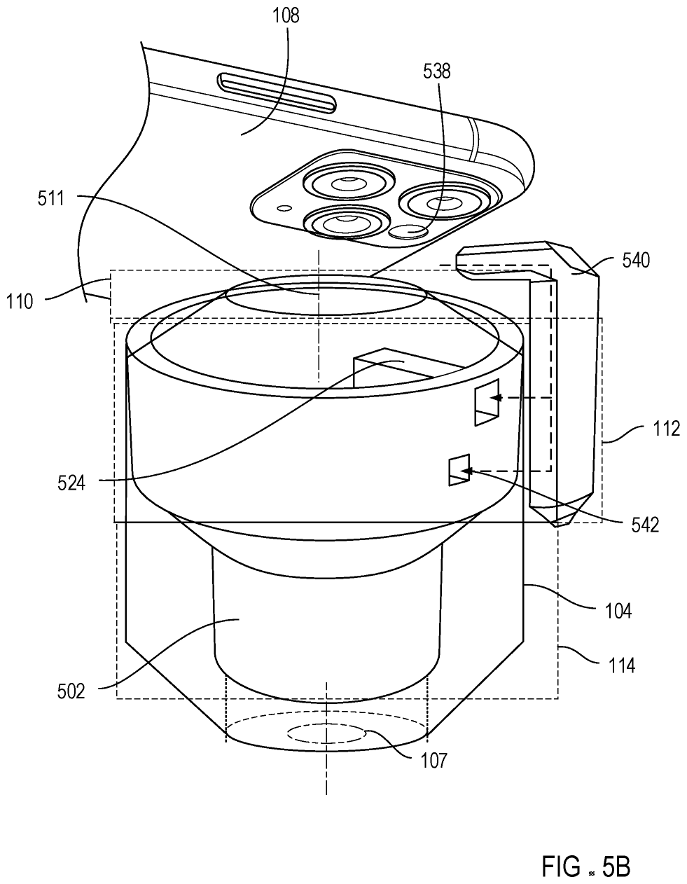

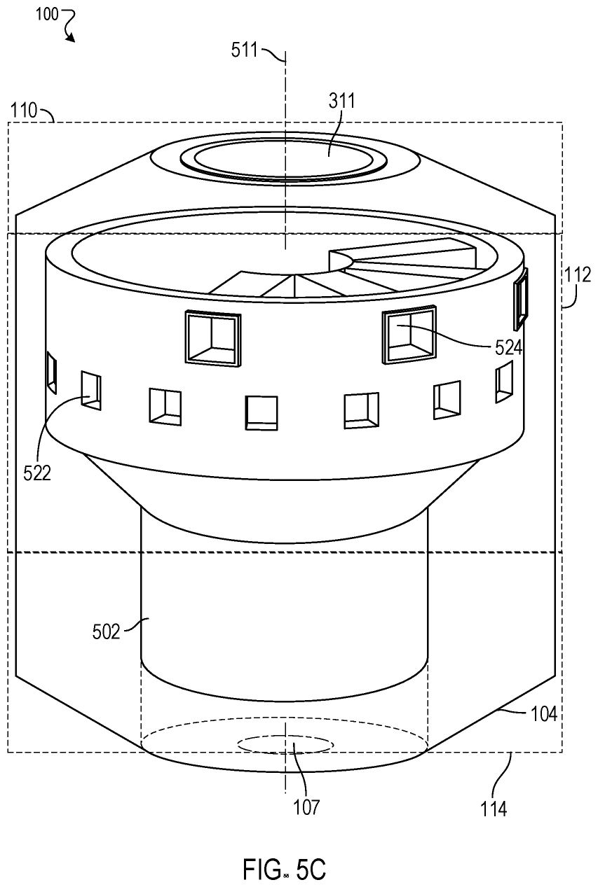

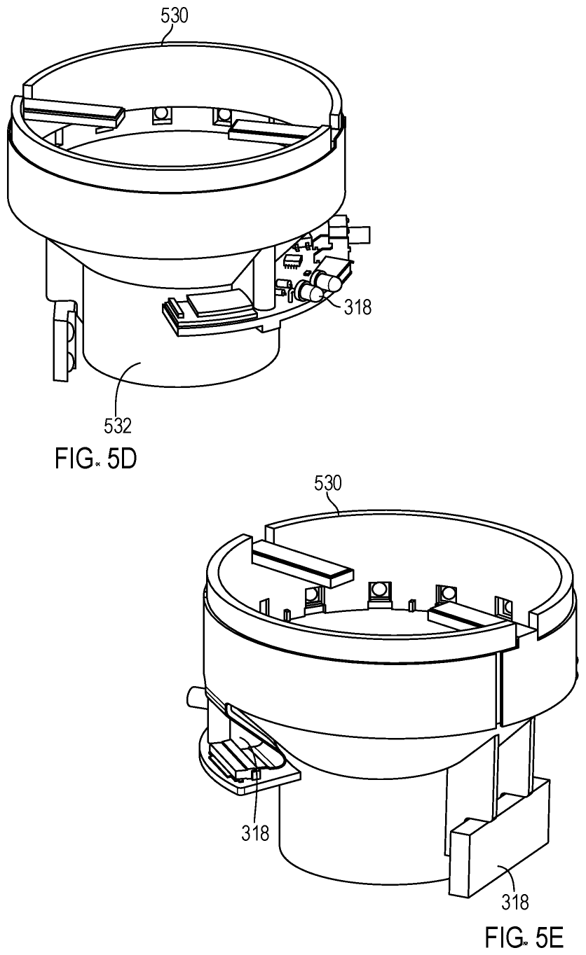

In some embodiments, electronics 318, e.g., data processing apparatus, electrical controller (e.g., microcontrollers), data communication link, power indicators (showing ON/OFF status), or the like, and/or power supply 320 for the forensic imaging apparatus 102 can be located within housing 104 and affixed to housing 104. In some implementations, as depicted in FIGS. 5D-5E, electronics 318 can include one or more flexible components, e.g., flexible printed circuit board (PCB) components, that can conform to a curvature of the housing, illumination assembly, etc.

Power supply 320 can include a battery (e.g., a rechargeable battery), power management, power switch, AC/DC converter, and the like, and can be operable to provide power to the electronics 318 and illumination assembly 112, e.g., light sources 308, light source 316. Power supply 320 can be operable to provide power to particular light sources 308, light source 316, e.g., one light source at a time. In some embodiments, power supply 320 can be operable to provide power to lens assembly 110, e.g., an automated/semi-automated lens selection wheel, and/or to the holder assembly 114, e.g., an automated/semi-automated holder. In some embodiments, a power supply 320 can be integrated into the forensic imaging apparatus, e.g., a standalone portable (handheld) apparatus. In some embodiments, one or more components of a forensic imaging apparatus can be powered by the user device via a wired connection to the user device, e.g., via a USB, micro USB, mini USB, or another power connection.

Electronics 318 can include an electronic processing module, e.g., an electrical controller, that is programmed to control the operation of the illumination assembly 112, e.g., turning ON/OFF light sources 308, 316.

Electronics 318 can include one or more data communication links. A data communication link can be wired, e.g., micro-USB, or wireless, e.g., Bluetooth, Wi-Fi, or the like. Data communication link can be utilized by the forensic imaging apparatus 102 to send/receive data via the data communication link to user device 108 and/or to a cloud-based server 117 via a network. In one example, electronics 318 can include a micro-USB cable to allow transfer of data between the forensic imaging apparatus 102 and user device 108. Data communication link can be used to connect the forensic imaging apparatus 102 and an electronic processing module that is programmed to control the illumination assembly 112 and internal camera 118 included in user device 108, such that the electronic processing module included in the user device 108 can control the operation of the illumination assembly 112, e.g., turning ON/OFF light sources 307, 308, 316 and acquire images with the camera.

In some embodiments, the electronic processing module is programmed to sequentially illuminate the head of the firearm cartridge casing 109 with light from light sources of the illumination assembly 112 at a varying range of angles of incidence and azimuth at the illumination plane 306, and acquire, with the internal camera 118, a sequence of images of the head of the firearm cartridge casing 109 while the head of the firearm cartridge casing 109 is illuminated by a corresponding light source of the multiple light sources.

While the foregoing example features an optical system composed of the internal camera 118 and lens assembly 110 arranged along a single optical axis coaxial with axis 111, other arrangements are possible. For example, folded optical systems can be used. FIG. 3F depicts a schematic cross-sectional view of an example forensic imaging apparatus including a fold mirror 326 within housing 104, to fold the optical path between illumination plane and internal camera 118 of user device 108 when the forensic imaging apparatus 102 is affixed to the user device 108. As illustrated, mirror 326 alter a direction of an optical path such that the lens 311 is oriented along an axis 331 and perpendicular to detecting area of the internal camera sensor 322.

In this arrangement, the firearm cartridge casing 109 can be dropped into the opening 107 while a user views the display on the user device 108 in an upright orientation. Though depicted in FIG. 3F as a single mirror 326, other configurations utilizing additional mirrors (or prisms) to fold the optical path between illumination plane and internal camera 118 to yield a more compact and/or differently oriented forensic imaging apparatus 102 can be contemplated.

FIGS. 3G-3K depict schematic views of an example forensic imaging apparatus 337. In some implementations, as depicted in FIGS. 3G-3K, forensic imaging apparatus includes an adjustable portion 338 that can be rotatable to adjust a length between a second end 105 of the housing 104 and an illumination plane 306, such that the length can be adjusted to accommodate different lengths of bullet shell casings and/or different caliber bullet shell casings 109 and position a surface of the bullet shell casing, e.g., a headstamp of the casing, at the illumination plane (not shown).

In some implementations, the adjustable portion 338 can include registration marks calibrated to particular caliber bullet shell casings and/or particular length bullet shell casings, e.g., such that each metered rotation of the adjustable portion approximately corresponds to a width of a caliber of bullet shell casing or a particular length of a bullet shell casing.

In some implementations, forensic imaging apparatus 337 can include one or more visual indicators 340 viewable by a user of the apparatus. The visual indicators can provide visual feedback to a user of the status of operation of the apparatus, e.g., ON/OFF states, mode of operation (“collecting data”, “processing,” “complete”), alignment feedback, or the like. As depicted in FIGS. 3G-3I and 3K, the visual indicator can be light emitting diodes (LEDs), where each of the LED(s) can provide different visual feedback to the user. For example, a first LED can provide ON/OFF states of the apparatus (i.e., where the LED is ON or OFF) and a second LED can provide mode of operation (i.e., red/yellow/green lights for respective states).

In some implementations, forensic imaging apparatus 337 can include one or more data communication ports 342, e.g., mini-USB, USB, micro-USB, or the like, which can be utilized by the user to interface between the electronics of the forensic evidence apparatus and a user device. For example, the data communication port can be utilized to provide instructions to the illumination assembly (e.g., to control operation of the multiple light sources).

In some implementations, e.g., as depicted in FIG. 3H, apparatus includes a lens and multiple fixtures 216 (e.g., bollards) to affix the housing 104 to an adaptor, e.g., adaptor 212 as depicted in FIGS. 2D-2H.

As depicted in FIG. 3I, the apparatus 337 can include one or more set screws or another set of one or more locking mechanisms 344 to lock position(s) of one or more components of the apparatus. For example, one or more set screws can be located on the housing and configured to selectively lock a position of a first portion of the housing (e.g., adjustable portion 338) with respect to a second portion 346 of the housing (e.g., a position of the adjustable portion relative to the illumination assembly).

FIGS. 3K-3L depict schematic views of example components of forensic imaging apparatuses. FIG. 3K depicts protective caps 348 that can be used to protect the lens and sample insertion opening, e.g., from dust, contaminants, physical damage, etc. The protective caps may be shaped to snap over the respective features, e.g., as depicted in FIG. 3L, intended to be protected or include a compressive component to secure the cap.

FIGS. 3M-3O depict schematic views of example aspects of forensic imaging apparatuses. In some implementations, a locking mechanism 350, e.g., as depicted in FIG. 3O, can be utilized to lock a position of a first portion 352 of the forensic imaging apparatus 354 with respect to a second portion 356. As depicted in FIGS. 3M and 3N, the locking mechanism 350 can slide along a track to secure a first portion 352 including registration marks 358 with respect to a second portion 356. The second portion 356 includes threads 360 allowing rotation of the first portion 352 and to set a particular length 362 of the apparatus 354 based on a position of the first portion 352 relative to the second portion 356. The particular length 362 of the apparatus 354 can be set to accommodate different camera optics on different user devices (e.g., on different mobile phones) and/or accommodate different thickness device cases (e.g., different thickness mobile phone cases) to add flexibility of use between the apparatus and various configurations of user device. Additionally, or alternatively, the apparatus 354 can include one or more set screws 364 to lock positions of the different portions of the apparatus 354 with respect to one another.

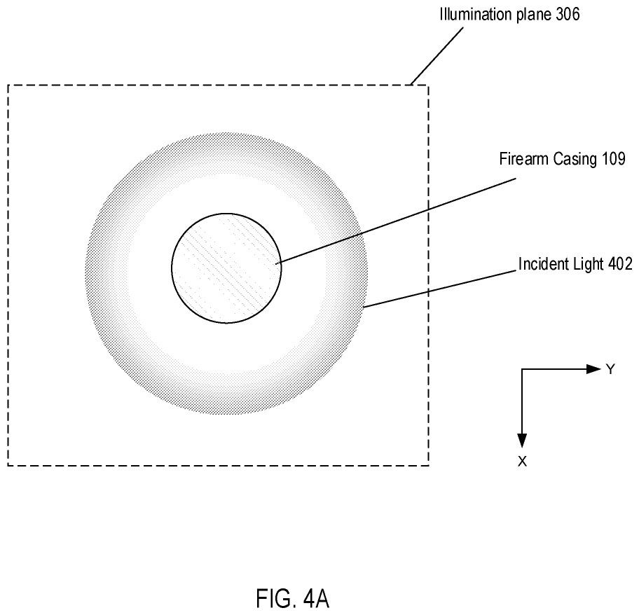

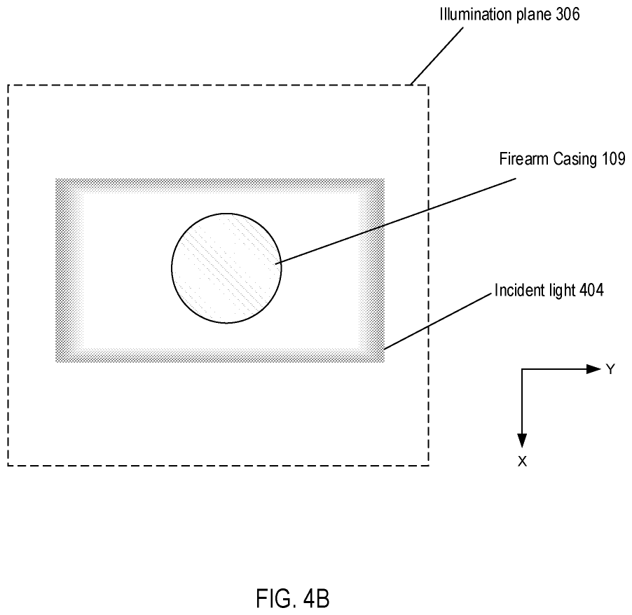

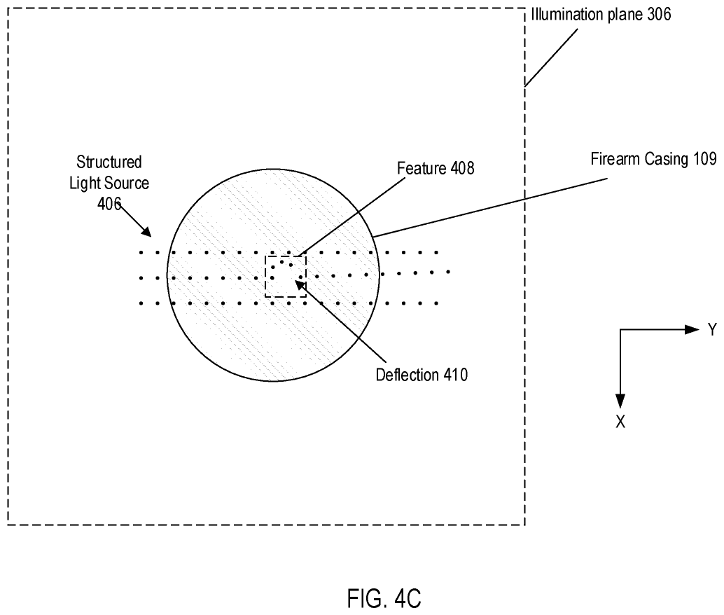

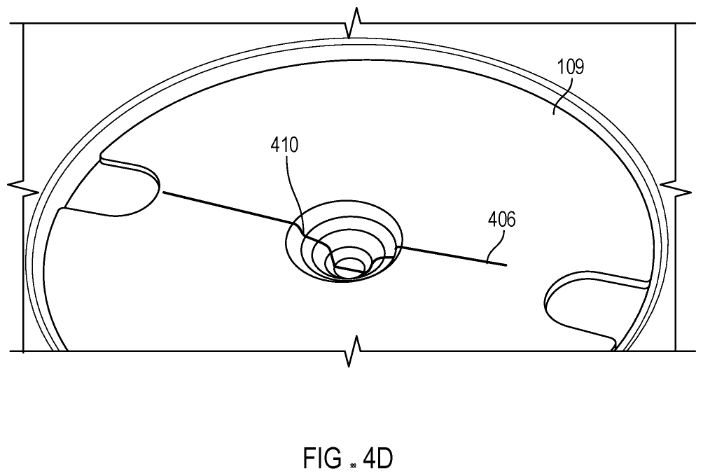

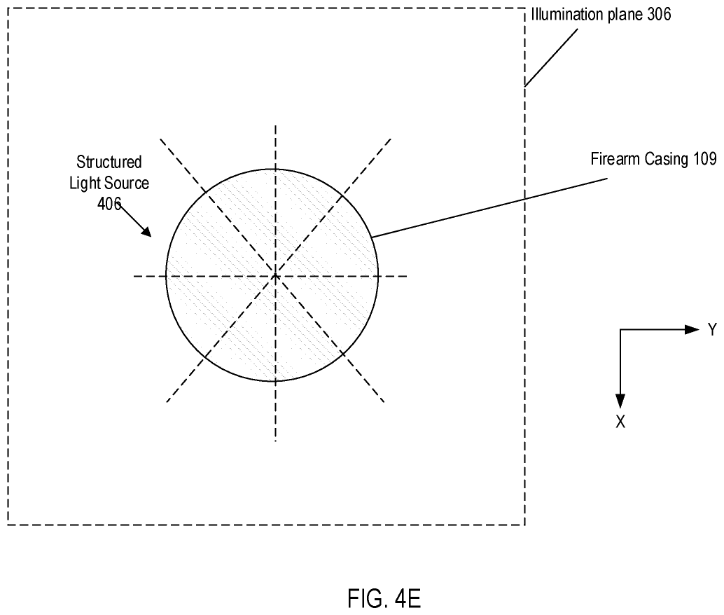

FIGS. 4A-4C depict illumination profiles of different light sources at the illumination plane of a forensic imaging apparatus. As depicted in FIG. 4A, a light source 308 can include a point light source, e.g., an LED, oriented with respect to an illumination plane 306 such that when light from the light source 308 is incident on the illumination plane 306, the incident light 402 is substantially uniform across an area of the firearm cartridge casing 109.

Referring now to FIG. 4B, a light source 316 can be an extended light source 316, e.g., an LED edge-coupled diffuser light guide, oriented with respect to an illumination plane 306 such that when light from the light source 316 is incident on the illumination plane 306, the incident light 404 is substantially uniform across an area of the firearm cartridge casing 109.

In some embodiments, as described with reference to FIG. 3D, a structured light source can be utilized in addition to or in lieu of light sources 308 and/or light sources 316. FIGS. 4C, 4D, and 4E depicts example illumination profiles of a structured light source. Structured light source, e.g., structured light assembly 328, can be a light source that projects a pattern onto the illumination plane 306, e.g., using one or more laser diodes or otherwise collimated light sources coupled to a diffraction grating(s). The structure light assembly 328 can be oriented with respect to a surface normal of the illumination plane 306, for example, between 60-80 degrees, e.g., 70 degrees utilizing a mirror or mirrors if necessary to redirect the light to the illumination plane 306. The structured light assembly 328 can be utilized to generate structured light source, e.g., a line or array of light features projected on the illumination plane 306. Depth information and/or surface feature information for feature 408 located on the firearm cartridge casing 109 can be extracted by capturing deflections 410 of the structured light source 406. In one example, as depicted in FIGS. 4C and 4D, feature 408 causes a deflection 410 of a portion of a line of light dots or in an array of dots. The structured light arrays can be composed of a grid of dots or lines or a series of “pie-shaped” wedges, e.g., as depicted in FIG. 4E, from which multiple slices of surface profile calibration data can be gleaned and intermingled with surface detail recovered using the glancing angle photometry, combined together to provide edge and depth detail recovery.

In some embodiments, for example the set of pie-shaped wedges depicted in FIG. 4E can be utilized to estimate surface depth in the area between each of the structured lines of the structured light source 406 projected onto the surface of the casing 109.

FIGS. 5A-5C depict schematics of perspective views of components of example forensic imaging apparatuses. As depicted, the housing 104 includes lens assembly 110 and illumination assembly 112 arranged along an axis 511. Lens assembly 110 includes a lens element 311, e.g., forming a macro lens. Illumination assembly 112 includes multiple light source fixtures 514, where each light source fixture 514 is configured to retain a light source 308, e.g., a LED or other point source. Light source fixtures 514 are arranged in two different rows that are at different axial positions. Each row provides illumination of the illumination plane at a common incident angle, and each light source provide illumination from a different radial direction.

In some embodiments, as depicted in FIG. 5A, illumination assembly 112 includes three extended light sources 516 located between lens assembly 110 and an illumination plane within barrel 502. Axially, the extended light sources 516 are further from the illumination plane than the point sources of fixtures 514. Accordingly, the angles of incidence of the light from the extended sources is lower (i.e., closer to perpendicular incidence) than the illumination from the point sources. As shown in FIG. 5A, the three extended light sources 516 are arranged along a top perimeter of the illumination assembly 112. Barrel portion 502 of the housing 104 includes opening 107 which permits the insertion of the firearm cartridge casing 109 and a holder assembly 114 within the barrel is configured to retain and secure the firearm cartridge casing 109 within the forensic imaging apparatus.

While the illumination assembly in each of the foregoing embodiments includes light sources that are independent from the user device, other implementations are possible. For instance, embodiments can use light sources that are part of the user device, e.g., the camera's flash, as a light source for the illumination assembly. For example, in some embodiments, the illumination assembly includes optics to direct light from the camera flash to the illumination plane, and may not include any light producing capacity otherwise.

Referring to FIG. 5B, an apparatus includes a light pipe 540 to direct light from an internal light of the user device, e.g., a camera flash 538, to the illumination plane 306. Light pipe 540, e.g., an optical fiber, planar light guide, free space optics, or the like, guides light from a point of origin (e.g., camera flash 538) to a location within the illumination assembly through apertures 542 in the barrel.

In some embodiments, light pipe 540 can direct light from the camera flash 538 to a first location, e.g., a structure light source assembly 524. Light from the camera flash 538 can be collimated, e.g., using a collimating lens or set of collimating lenses as a part of structured light source assembly 524. Light pipe 540 can additionally or alternatively direct light from camera flash 538 to a light aperture, e.g., aperture 542, to be utilized as a point light source for glancing incident angle illumination. In some embodiments, light pipe 540 can be coupled to light aperture 542 via a set of focusing optics.

In some embodiments, light pipe 540 can include a reflective coating at the walls of the light pipe 540 to increase reflectivity and promote wave propagation of light from camera flash 538 to the illumination assembly. In some embodiments, the light pipe 540 can include a light guide that uses total internal reflection of light within the light pipe 540 to direct light from the flash to the illumination assembly. In some embodiments, an intensity of the light source (camera flash 538) can be modulated to affect a light intensity at illumination plane 306, e.g., by use of a polarizer/filter, an aperture, or by adjusting an intensity of the flash on the user device 108 (e.g., via camera software).

In some embodiments, light pipe 540 can be semi-flexible, e.g., a flexible optical fiber, such that light from the light pipe can be utilized to illuminate illumination plane 306 through a range of azimuthal angles with respect to axis 511 while the illumination assembly 112 is rotated about axis 511. In some examples, illumination assembly can be rotated about axis 511 while casing 109 may be held fixed by the holder assembly.

In some embodiments, the illumination assembly can include a first aperture 542 to receive light from light pipe 540 and a structured light source, e.g., structured light assembly 524 to receive light from the light pipe 540. As depicted in FIG. 5B, the aperture 542 and structure light assembly 524 can be offset azimuthally from each other with respect to axis 511, such that a light pipe 540 can direct light into one or the other in turn.

In some embodiments, the illumination assembly includes two light sources, each at a respective incident glancing angle. The two light sources can be a same type of light source, e.g., both LEDs, or can be different types of light sources, e.g., one LED, one structured light source. Holder assembly 114 can be adjustable to change a position of the casing 109, e.g., rotate the casing 109 relative to axis 511, in order to capture different azimuthal positions of the casing 109 at the illumination plane 306 using the two light sources.

In some embodiments, holder assembly 114 can be adjustable to change a position of the casing 109, e.g., rotate the casing 109 relative to axis 511, in order to capture different azimuthal positions of the casing 109 at the illumination plane 306 using the two light sources, and additionally, the light pipe 540 may be adjustable to change a position of the light pipe 540 with respect to the illumination assembly 112, e.g., to direct light from flash 538 into a particular aperture 542 or structured light assembly 524.

In some embodiments, as depicted in FIG. 5C, illumination assembly includes a tier of point light source fixtures 522 and a tier of structured light assemblies 524, e.g., four structure light assemblies 328. The structured light assemblies 524 are arranged radially with respect to axis 511 to generate structured light patterns, e.g., by structured light sources 406, at the illumination plane 306 of the apparatus.

As depicted in FIG. 5C, the structured light assemblies 524 and light source fixtures 522 are offset azimuthally with respect to each other. In some embodiments, a light pipe (not shown) can be utilized to direct light from an external light source (e.g., camera flash) to each of the structured light assemblies 524 and light source fixtures 522 in turn, e.g., sequentially, as the light pipe is rotated about axis 511 with respect to illumination assembly 112. Alternatively, or additionally, illumination assembly 112 may be rotated while a light pipe is held fixed. Each incremental sub-rotation of the light pipe and/or illumination assembly can result in either a structure light assembly 524 or a light source fixture 522 receiving light from the light pipe 540.

FIGS. 5D-5E depict schematics of partial views of forensic imaging apparatuses. In some implementations, one or more of the electronics components of electronics 318 of the forensic imaging apparatus may be affixed to the lens assembly, illumination assembly, barrel, or a combination thereof. The electronic components can include one or more flexible PCB components that conform to a surface of the lens assembly (not shown), illumination assembly 530 and/or barrel 532.

In embodiments where a rotation of a portion or all of the illumination assembly 112 (e.g., optionally including rotation of light pipe 540) and/or holder assembly 114 is described, a fiducial tracking system, e.g., registration marks, can be implemented to track relative orientations of the casing 109 and the illumination assembly 112, e.g., with respect to the camera of the user device. The fiducial tracking system can be utilized to track the orientation of the casing between images captured by the camera of the user device 108. Rotation of the illumination assembly 112 and/or holder assembly 114 can be optionally manual (e.g., rotate by hand), semi-automatic (e.g., a wind-up motor), or automatic (e.g., a servo-motor).

### Example Process of Forensic Evidence Collection

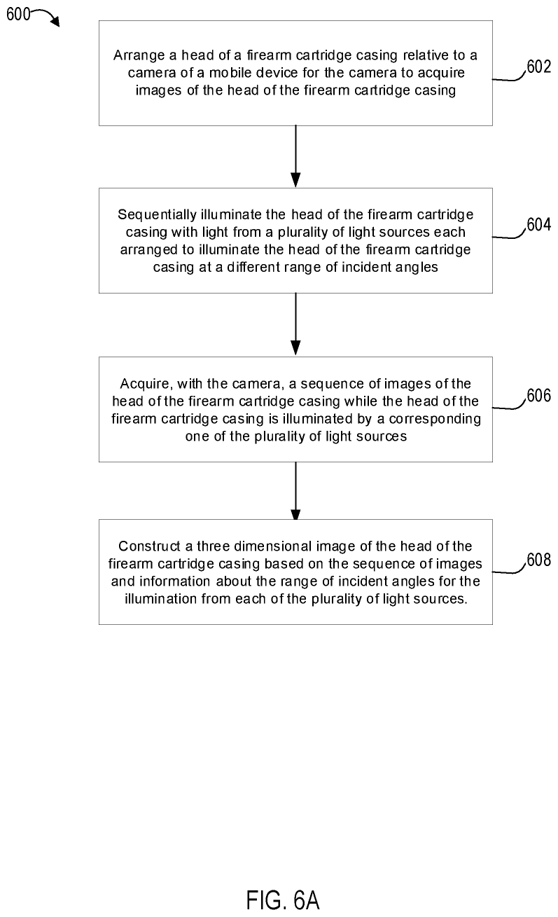

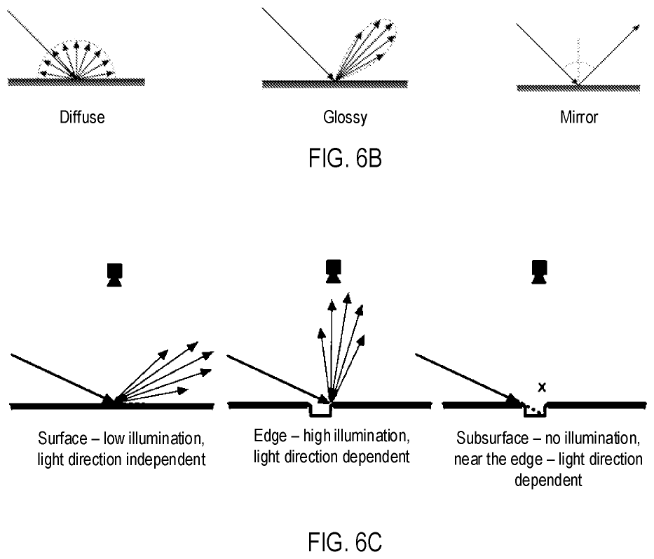

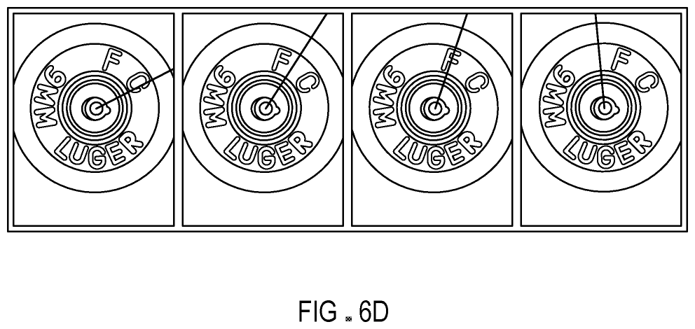

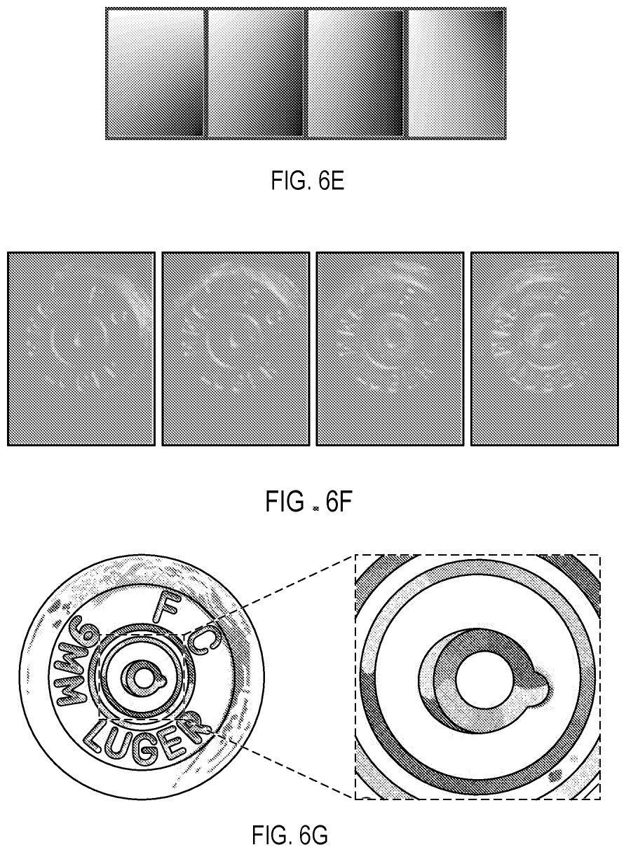

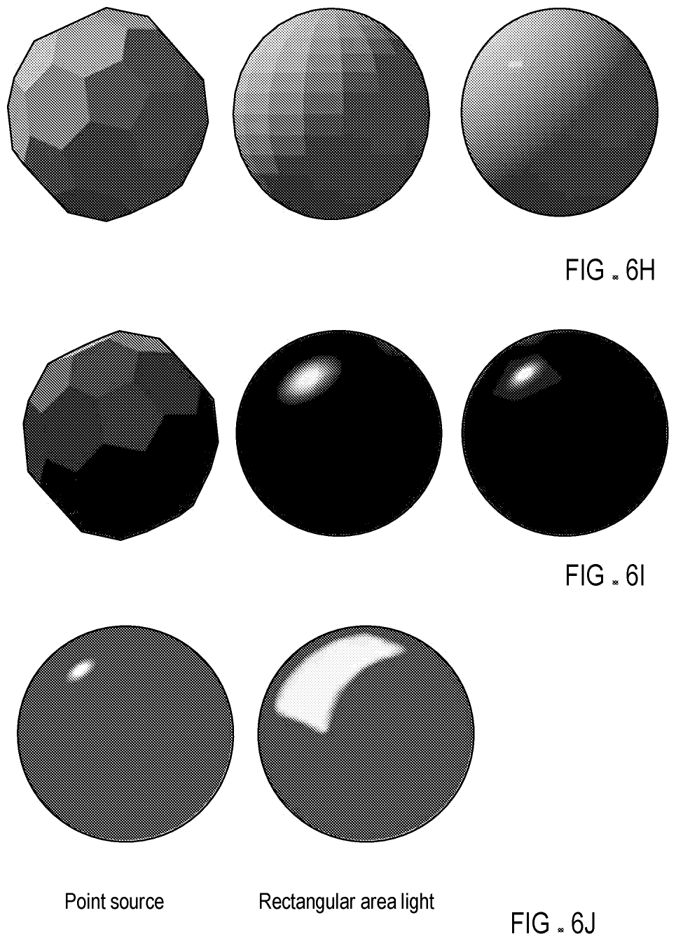

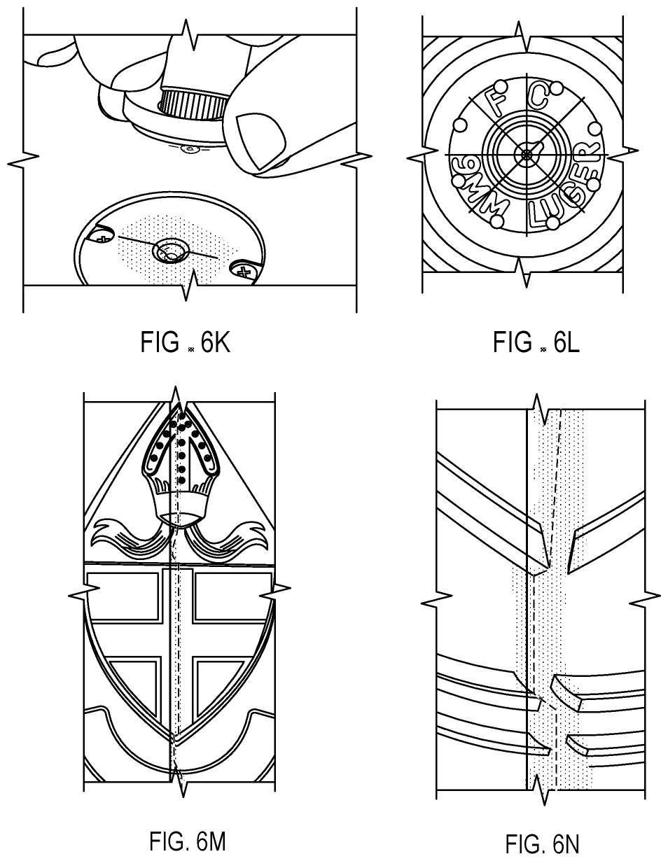

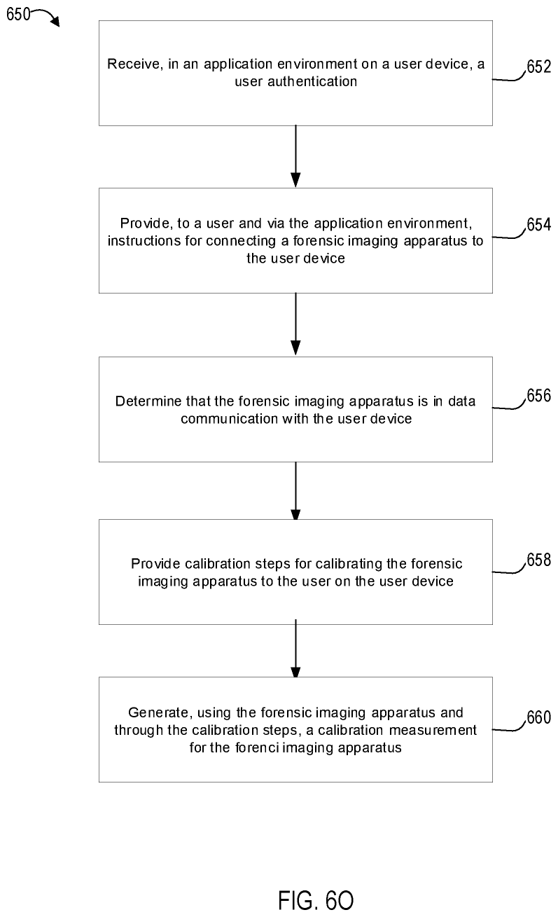

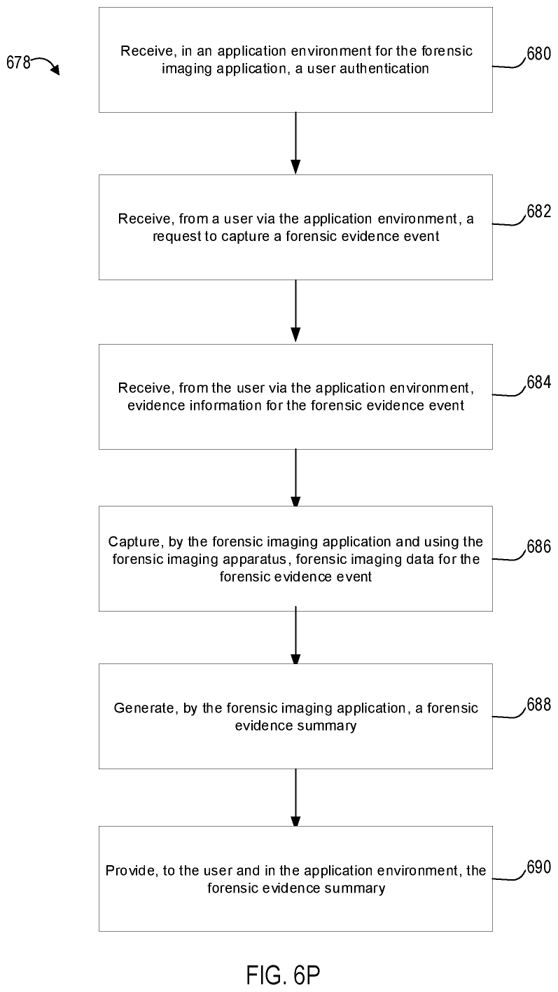

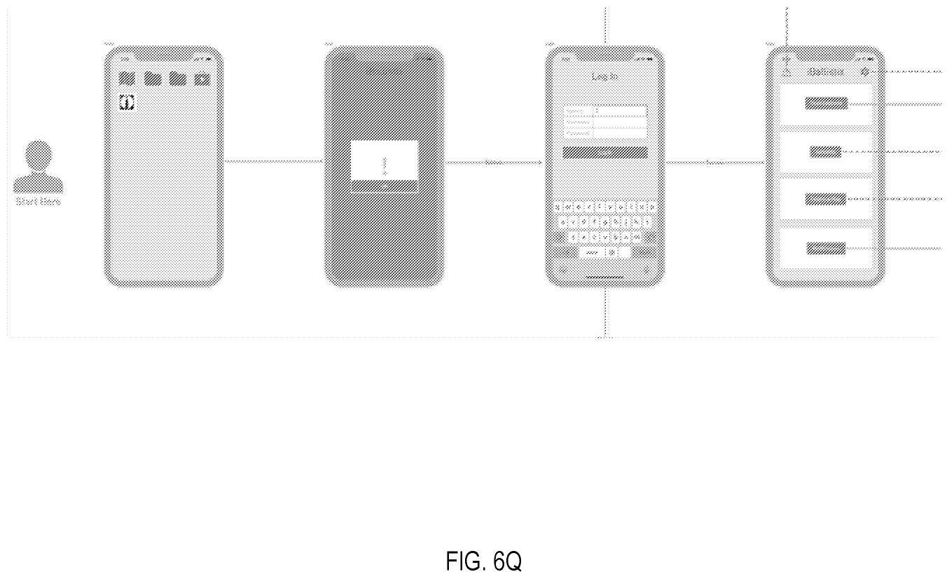

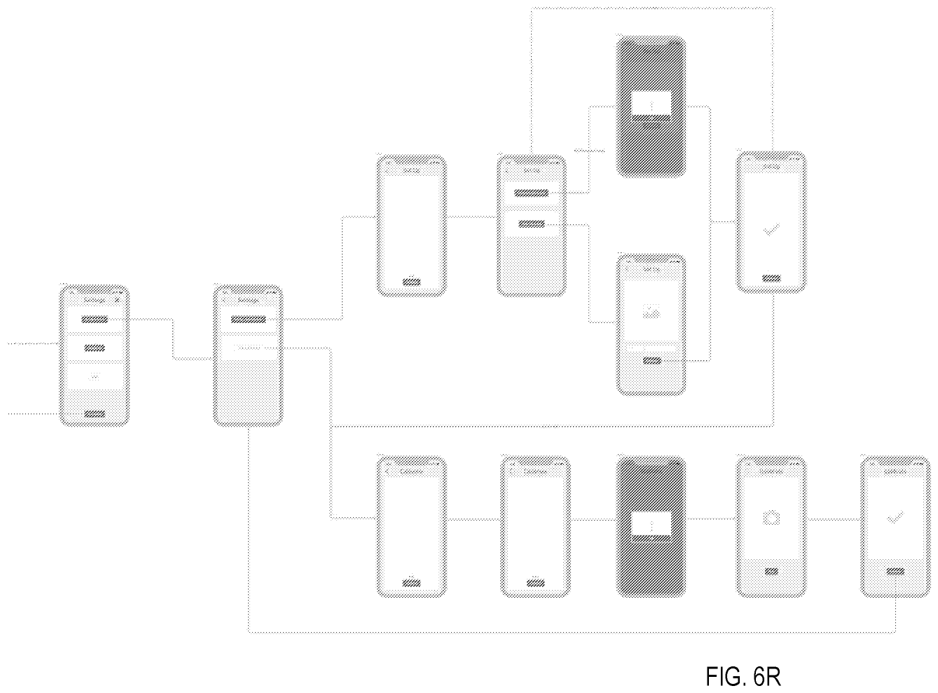

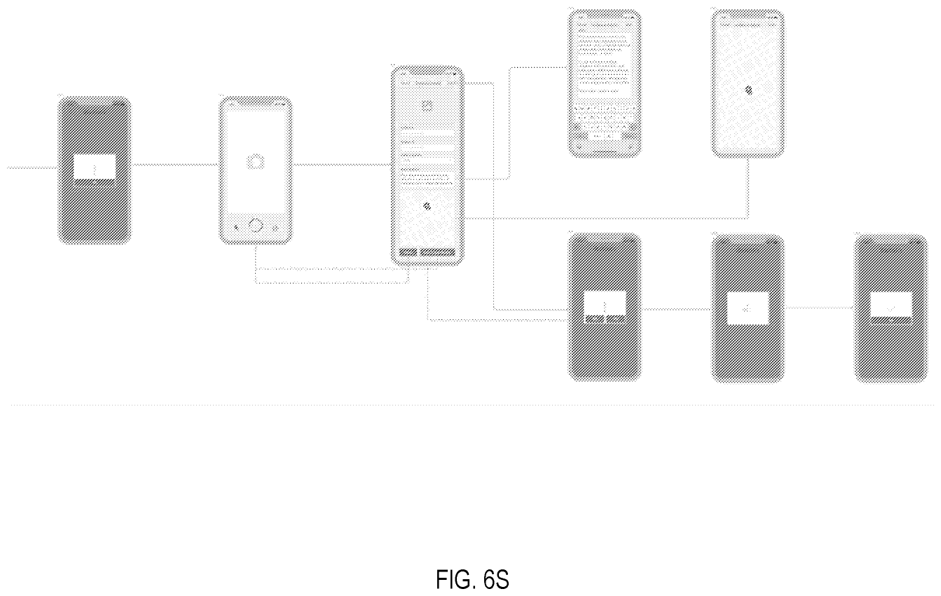

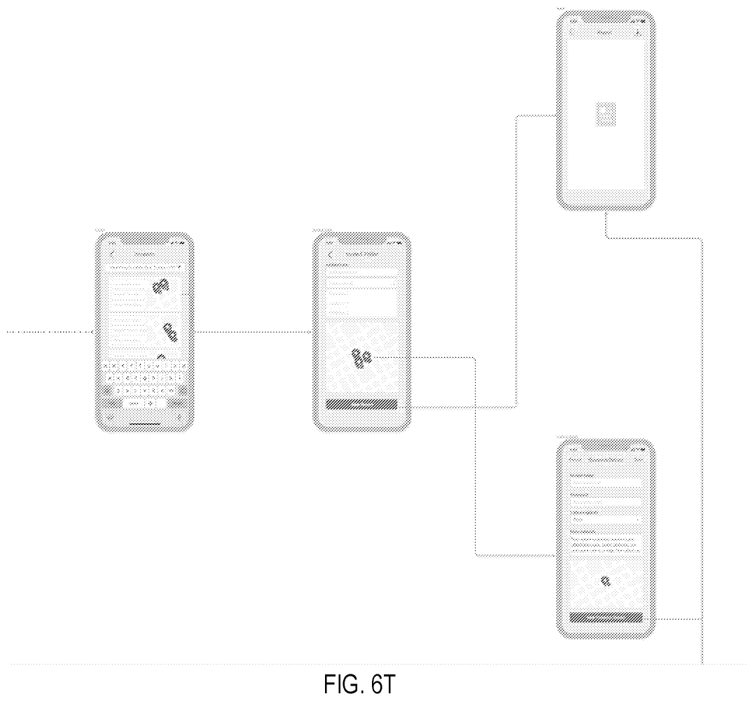

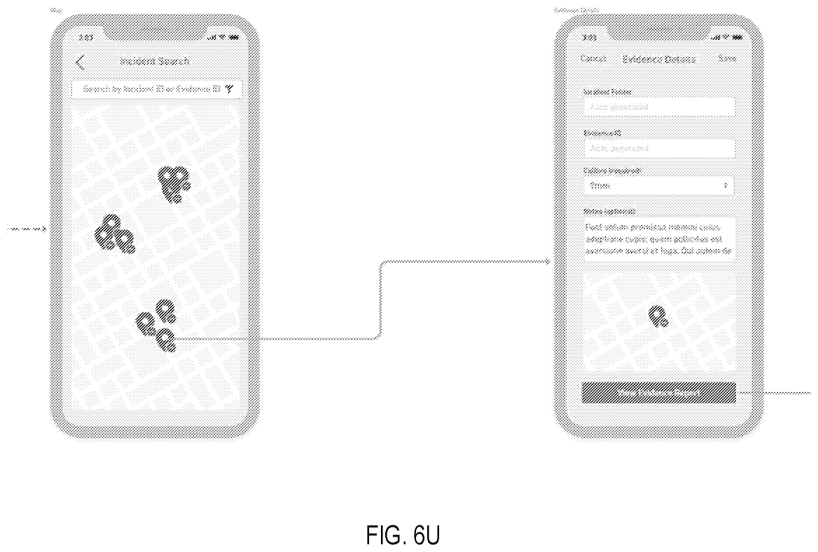

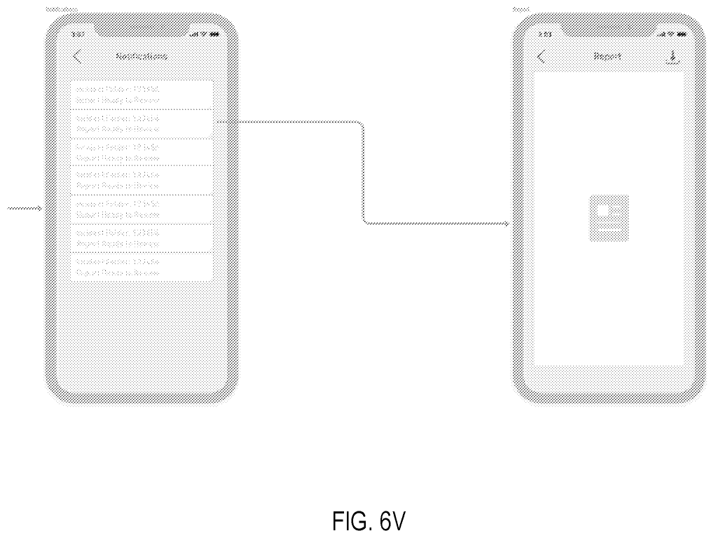

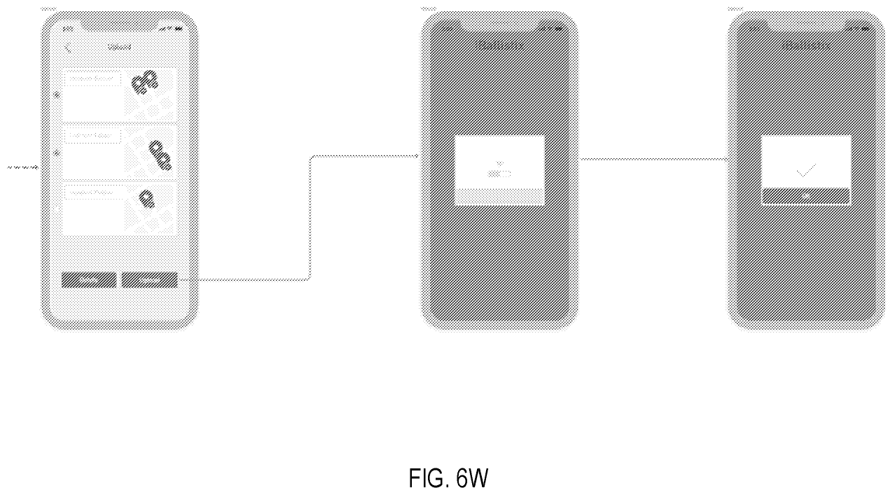

In some embodiments, the apparatus performs sequential illumination of the head of the firearm cartridge casing with light from multiple light source configurations each arranged to illuminate the head of the firearm cartridge casing at a different range of incident angles surrounding the cartridge can be performed. FIG. 6A is a flow diagram of an example process 600 for acquiring images of a cartridge casing using forensic imaging apparatus 102. After retrieval of the casing, the head of casing is arranged in the forensic imaging apparatus with the apparatus mounted to the user device. This positions the sample relative to the camera of the user device for the camera to acquire images of the head of the casing (602). For example, as depicted in FIG. 3A, the firearm cartridge casing 109 can be retained within barrel 101 by holder 301. Holder 301 can include, for example, a mechanical iris defining an aperture with an adjustable diameter that can be opened wider than the casing during installation and then closed onto the casing to retain and secure the casing 109. The firearm cartridge casing 109 can be positioned within the barrel 101 of the housing 104 and aligned with axis 111 such that the head of the casing 109 is positioned at illumination plane 306. At this position, the head of the firearm cartridge casing 109 can be in focus by internal camera 118 of the user device so that the user device can acquire high resolution images of the head.

Once the casing is properly positioned in the apparatus, the user initiates an image capture sequence. As part of this sequence, the illumination assembly sequentially illuminates the head of the firearm cartridge casing with light from multiple of the light sources in the assembly (step 604). Each time, the assembly illuminates the head of the firearm cartridge casing at a different ranges of incident angles (604). For example, the sequence can include illuminating the head of the casing from each of multiple point light sources each at a common polar illumination angle (e.g., an angle of 80 degrees or more from the axis) but from different radial directions with respect to an axis of the forensic imaging apparatus. The sequence can further include illuminating the head of the casing from each of multiple point light sources each at a second common polar illumination angle (e.g., an angle in a range from 50 degrees to 80 degrees from the axis) but from different radial directions with respect to an axis of the forensic imaging apparatus. The sequence can also include illuminating the head of the casing with one or more extended light sources.

In some embodiments, two or more light sources are illuminated at a time.

Instructions to perform a sequence of illumination can be provided by a user device 108, e.g., by a forensic imaging application 116, and coordinated with the capture of images of the head of the firearm cartridge casing 109. For example, one or more light sources of the multiple light sources may be illuminated in sequence and a respective set of one or more images may be captured by the camera of the casing 109 utilizing the illumination provided by the light source(s) in the sequence.

The camera acquires a sequence of images of the head of the firearm cartridge casing while the head of the firearm cartridge casing is illuminated by a corresponding one (or more) of the multiple light sources (606). Forensic imaging application 116 can have access to an internal camera 118 of user device and provide acquisition instructions to the internal camera 118 as well as illumination instructions to the forensic imaging apparatus 102 to illuminate a particular light source. The forensic imaging application 116 can acquire and label an acquired image with metadata related to a particular light source utilized for capturing the acquired image, e.g., range of angles of incidence, type of light source, known reflections, and the like.

In some embodiments, images are acquired of the head of the firearm cartridge casing 109 that include shadows that occur due to features (e.g., protrusions or depressions) on the surface of the head of the casing generated by the illumination of the light source.

The system constructs a three-dimensional image of the head of the firearm cartridge casing based on the captured images and information about the range of incident and azimuthal angles for the illumination from each of the multiple light sources (608). Acquired images can be provided to a forensic detection analysis module 119 on a cloud-based server 117 via network 115. Forensic detection analysis module 119 can process the set of acquired images including images captured under different illumination conditions, e.g., illumination by different light sources, and construct a three-dimensional image of the head of the firearm cartridge casing.

### Example Image Processing and Analysis for a Forensic Imaging Apparatus

Traditional photometric approaches to computational image analysis often rely on Lambertian surfaces. These can be defined as where lighting intensity is linearly related to the surface angle. In the real world, modeling as Lambertian surfaces can be difficult as result of light bouncing/reflecting from surfaces and/or illuminating into shadows. These effects can be compensated by developing a modified photometric approach.

Various techniques can be utilized to deal with glossy materials (non-linear but still highly correlated with lighting intensity to surface angle). For example, using digital or polarizing filters to compensate and remove the specular lobe these materials can be turned back into ‘Lambertian’, e.g., remove the higher albedo from glossy materials and additional spill/bounce light due to the reflection.

Rough (faceted) metal materials with changing material properties over the surface can be the difficult to model as there can be no relationship between the surface angle and the illumination intensity, and/or such that the relationship between surface angle and illumination intensity changes as the material changes. Non-metallic examples include anisotropic materials like velvet. Examples of rough metal materials include surfaces of firearm shell cases, e.g., the head of a shell casing.

With known point-like distant light sources and a surface with uniform albedo (surface reflectance), the surface normal can be calculated as the illumination intensity/light direction. These surface normal values can then be combined from multiple light sources to create a map of the overall estimated surface normal.

Glossy surfaces can be managed in special cases, but complex faceted surfaces defined by a BDRF (bidirectional reflectance distribution function) can be difficult to model. Multiple formulations can be utilized to model glossy surfaces, for example, including a spatially-varying bidirectional reflectance distribution function (SVBDRF) and bidirectional texture function (BTF) which encode spatial variance over the surface. The BTF also encodes internal shadowing and inter reflection. In another example, bidirectional scattering-surface distribution function (BSSRDF) 8-dimensional encodings, including scattering and reflectance can be utilized to model light entering and exiting at different locations.

FIG. 6B, illustrates reflections of light incident at an angle of approximately 45 degrees from a diffuse, glossy, and mirror (specular) surface, respectively. A challenge with these more complex materials is that the illumination can be difficult to normalize without knowing the parameters of the model over the whole surface. The nature of flat glossy surfaces-even those with varying non-linear reflectance is that the reflectance response is not diffuse but highly concentrated around a primary lobe. In other words, modeling glossy metallic surfaces can be approached similarly to modeling a mirror surface rather than a diffuse surface.

In some embodiments, it is possible to utilize a sharp illumination angle (e.g., a high incidence angle by a point source that is collimated or has a very low divergence) to a surface and a camera pointed at the primarily flat surface, such that the surface of the material will only be slightly illuminated. The surface can also be illuminated by every compass angle which is illuminated. By contrast, edges defined in a faceted surface can be clearly illuminated from only a few directions and subsurface areas will not be illuminated at all. FIG. 6C shows reflection of light incidence at a high angle of incidence measured relative to the surface normal (referred to as low-illumination light direction) on a flat surface and a faceted surface. A camera is positioned along the normal to the plane of the flat surface. Significant light is reflected from a facet edge to the camera. Relatively little light is reflected from the flat surface or from the subsurface feature to the camera.

Utilizing the noted properties of a tight reflective lobe of a metallic/shiny surface (e.g., at angles of incidence of 45 degrees or more with respect to surface normal) it can be possible to use point light sources (e.g., light emitting diode (LED) point light sources) around a circumference of a largely flat bullet casing surface at a low angle (e.g., 7.5 to 20 degrees glancing angle, i.e., an angle of incidence of 70 degrees to 83.5 degrees). A reflectance from the surface of the bullet casing back to a camera can be separately detectable from a tight lobe generated by reflectance from the flat surface. In some embodiments, there may be some stray illumination, e.g., where the surface of the bullet casing is rough or has very small edges, however this can be treated as a small textural detail. The illumination strategy described can result in the surface of the bullet casing having a low illumination across any illumination angle.

FIG. 6D shows images photographed under various illumination directions by respective incoming light vectors specified by varying azimuthal (or compass angles). As depicted in FIG. 6D, an incoming light vector from a light source is indicated for each illumination direction and a corresponding image is photographed with a camera positioned as depicted in FIG. 6C (i.e., perpendicular to a surface of the bullet shell casing), and which highlights edges facing the light source. In each of the images shown in FIG. 6D, a respective illumination direction which is specified by an azimuthal (or compass) angle is different.

Referring now to FIG. 6E shows corresponding direction maps for the respective images depicted in FIG. 6D. In order to determine corresponding directions of the edges of the surface, a direction map can be computed which traces each illumination direction back to a point light source at every pixel in the image. The direction map can additionally include a falloff compensation value added. The compensation value can be calibrated by using a flat white surface in place of a bullet shell casing such that the illumination falloff across the surface can be compensated for. The compensation value normalizes the illumination intensity to be constant over the surface.

FIG. 6F shows corresponding normal maps for respective images depicted in FIG. 6D. In FIG. 6F, an illumination direction of the light source is modulated by an intensity of the edge and encoded where redness is the x angle and greenness is the y angle to generate a normal map of the image.

FIG. 6G depicts a synthetic normal map constructed from the composite images depicted in FIGS. 6D-6F. Referring to FIG. 6G, the multiple images of FIGS. 6D-6F are combined to sculpt a synthetic normal map which encodes the directional light response of the metallic surface. The synthetic normal map can be highly accurate laterally but the slopes are all saturated in their angular color. This may occur due to this approach allowing for detection whether edges are present or not, but may not provide information about how steep these slopes are, as result of how the glossy lobe reflection from the material surface is treated.

Utilizing a glancing illumination angle-based photometric approach, unlike some normal photometric approaches, has an advantage of finding edges extremely accurately, but does not measure their slope. Glancing illumination angle-based photometric approaches can be useful in cases where a surface material has a non-homogeneous faceted nature.

In some embodiments, the normal map can be enhanced by finding a more accurate slope for the edges of the faceted surface without using point or directional light (i.e., because the surface in question may not be a diffuse Lambertian surface). With a Lambertian surface, all areas hit by light will respond by reflecting some diffuse rays in the direction of the camera. This is illustrated in FIG. 6H, which illustrates reflection from three faceted spheres. In each case, the intensity of the reflected light at the camera can be correlated to the orientation of the surface with respect to the light source and the camera.

FIGS. 6H-6J illustrate reflections from various faceted spheres having different surface qualities and under various lighting conditions. Glossy surfaces, which reflect light with a tighter specular lobe, return very little light from a point source to a camera except for facets with a specific relative orientation between the light source and the camera. This is illustrated in FIG. 6I, which shows reflection from the faceted spheres but now having a glossy surface. As illustrated, it can be seen that very little illumination is returned by a point light source over the whole surface, making even correcting the non-linearity difficult, if not impossible, if there is no information.

### Generating a Heightmap

In some embodiments, the unique specular lobe with the edge lighting can be utilized to extract a binary mask and provide a baseline of where there are edges in the faceted surface. To calculate the magnitude of the slopes which make up these edges, the basic photometric approach may be modified. That is, as mentioned (surface normal=illumination intensity/light direction) will not work if there is no light intensity to measure.

A modified photometric approach can be based on the intuition that the current formula relies on a distant point light source (highly directional) and a diffuse response. We cannot change the fact that the surface we are dealing with is non-linear and glossy. We can, however, change the light source. The modified photometric approach can instead use an area light (also referred to as a spatially extended light source) for illumination. In other words, a diffuse light source made of infinite point lights.

The area light can be located to one side of the object to be imaged (e.g., the bullet shell casing) while there will be diffuse light, it will be diffuse light which originates to one side of the object. As result, light which captured by the camera image will be proportional to the slope of the subject relative to the camera and because it is an area light all of the surface will see a response.

A response of the camera due to the area light is illustrated in FIG. 6J, which compares reflection of a point source and a rectangular area light from a spherical object.

The depicted response can be treated as analogous to illumination from a diffuse soft-box used in photography except that the surface illuminated by the area light from the respect of the camera aperture can be measured. Because the camera is oriented perpendicular to the illuminated surface, the illumination provides only partial coverage of the surface corresponding to a side of the surface where the light source (e.g., the area light) is directed. However, by rotating the area light with respect to the surface (e.g., at various azimuthal angles) and capturing multiple images, full coverage of the illuminated surface can be possible.

Accordingly, there are at least two approaches to extracting a slope of an edge for a faceted surface utilizing an area light. A first approach is to use a calibrated lookup table made by measuring an illumination level of different slopes for edges milled into surface templates. By measuring a range of slopes over the area of a surface and using a range of materials can be possible to interpolate a likely accurate slope value.

Alternatively, or additionally, an accurate lateral edge mask acquired using the point light sources located at high incident angles with respect to the faceted surface can be utilized in the analysis of the slopes in the surface. Based on the lateral edge mask, it can be determined for each pixel whether the pixel captures a slope. The slope's gradient is unknown, however. Accordingly, the analysis can be performed using the area light only for edge pixels measuring a change in illumination seen over those edge pixels. The slope gradient can then be determined based on this change in illumination.

In some embodiments, the modified photometric stereo approach described herein can include inter-reflected due to highly mirrored faceted surfaces of a bullet. In other words, where light reflecting off one part of the bullet surface illuminates another part of the surface creating apparent false slope information. For example, inter-reflection effects can appear in concave recesses which may inter-reflect many times.

To reduce this effect, the area light source can be polarized. An analyzer, such as a switchable polarizer (e.g., an LCD) can be placed in front of the camera. In this way two images can be taken with and without the analyzer. The photo taken with the analyzer enabled on the camera will result in blocking some of the primary reflection while letting most of the subsequent reflections through. The image captured with the analyzer can then be subtracted from the image captured without the analyzer enabled on the camera to preserve most of the primary reflection and dampen the subsequent reflections.

A potential challenge with this approach is where the surface is very mirror-like rather than rough. This can result in less depolarization due to multiple reflections and the light that experiences subsequent reflections remaining highly polarized.

FIGS. 6K-6L depict an example for utilizing a structured light source for illuminating a surface. Another approach to return more information about the absolute surface height and the surface curvature is to use structured light. An example of structured light involves a sparse sampling approach. For instance, using a light source, a diffraction grating or holographic element a line is projected on the surface. The structured light source illumination line can be projected off axis from the camera to create perspective. For example, as illustrated in FIGS. 6K-6L, four lines can be used to create 8 ‘pie slices’ where the z height of the surface along each line (allowing for perspective offset) can be known.

FIGS. 6M-6N depict another example for utilizing a structured light source for illuminating a surface. A projected line is tilted in one axis, in the case of FIGS. 6M-6N the horizontal axis to provide a perspective tilt. The image can then be processed to detect a brightest part of the line for each row. The column the brightest part of the line falls on—is horizontally offset in direct proportion to the height of the surface. The solid line in FIG. 6N represents a flat surface, the further each bright dot of the dotted lines is to the right of the line, the taller the actual surface. Determining the distance between the flat surface and the illuminated light of the structured light creates a set of known z heights along the line (allowing for the perspective offset). As embodied in the example presented in FIG. 6n, each line of the structured light source is photographed and analyzed separately.

Height information determined using the methods described above can be used in a variety of ways. For example, height information can be used to calibrate a height of the surface in known height units. As another example, height information can be used to propagate known height information in the edges along connected edges of the same estimate height (are they sharp, shallow, rounded etc.). In another example, height information can be used to provide data on surfaces not illuminated, such as subsurface areas.

In some embodiments, in order to apply height information, a first step can include estimating a height of the original surface from the normal map, e.g., a normal map as depicted in FIG. 6G. A pyramidal integration approach, for example, can be utilized to efficiently generate a suitable heightmap (also known as a heightfield). Laser data, i.e., structured light data, for each line (and perspective offsets) can be mapped onto this heightmap. The result is a sparse set of known heights allocated against the relative heights in the full heightmap.

A modified Basri Jacobs formulation can be utilized for iterative integration to create a heightmap from a normal map.

As described, edge data is captured in two dimensions through a selected lighting sequence and image stacking process, where the edge data is converted into a 2D normal map. A Basri Jacobs formulation can be utilized to generate, from the 2D normal map and inflating over multiple (iterative) passes, a heightmap. The generated 3D shape can be solution to describe an object from which to generate the 2D normal map. A Basri Jacobs formulation can be utilized to account for scenarios that do not include perfectly Lambertian surfaces and/or for features extruded from surfaces that may not be coplanar flat surfaces to an illumination plane by appropriate modification. In such cases, multiple 3D models may be possible, which can in turn generate any given normal map sampled from a non Lambertian surface.

What is described herein are heightmaps which provide flat surfaces and which can be generated relatively quickly. Additionally, processes for calibrating the heightmaps such that a relative height of the flat surfaces can be measured in real world dimensional units.

A first calibration pre-process includes adjusting the normal map such that edges are contiguous edges. This involves a number of machine vision tasks to find the edges of all flat areas and make sure the length of the edges is comparable. Edge data may be added if it has been cropped outside the frame—or to mask edge data out if it is only partial. For example, edge data for a primer area of a shell casing can be added by enhancing a magnification of the primer area of a shell casing such that an outside of the shell casing will not be continuous in the image. This can result in an inflation where areas where an edge is present are raised, and where an edge is not present, the areas will be flat. As such, an appearance of the shell casing can be curved on the surface and non-planar. Finding a primer and masking out the outer shell casing in contrast results in a clean planar circular primer being inflated.

A second calibration pre-process can include applying a multi-scale approach. The second calibration pre-process is to perform heightmap generation using a scaled down inflation process to quickly propagate and create a heightmap of a threshold resolution. The inflation process is then scaled up incrementally. The normal map is scaled to match and the second calibration pre-process is re-run with the existing scaled up heightmap as a starting point, such that only the incremental surface detail needs to be added and the process may proceed more quickly. In some embodiments, the multiscale process is performed in powers of two, which can provide an order of magnitude in performance improvement.

After a threshold heightmap has been extracted from the clean normal data and either a standard or multiscale Basri Jacobs inflation a further calibration process can include calibrating the heightmap against real world dimensional units.

### Calibration of the Heightmap

Various point-sampling approaches can be utilized for determining distance from a camera to a sample surface (e.g., a surface of the bullet shell casing). These include, for example, measuring an offset of a laser line and checking for focus contrast against a pre-calibrated template. As used herein, checking the focus contrast again the pre-calibrated template includes utilizing a tight focal plane to find areas which are in focus using the contrast of the surface of a calibrated template. The focus is moved up slowly, such that when patterns on different height steps in the template come into focus each pattern at a respective height step will have high contrast. Because the different height steps of the template are at known position and height, the focus settings can be recorded against the known height on the template, which provides a focus depth-to-micron scale for this given camera and optical setup. When a new forensic sample, e.g., a bullet casing, is scanned it becomes possible to use this result to quantify the heights of parts of the surface. Accordingly, as the camera focus is again moved up slowly, then areas on the forensic sample, e.g., bullet shell casings, which come into focus can be calculated as being at the same height as a calibrated template. However, such approaches may capture distance from the camera for a small part of the subject. Thus, once a set of pixels on the subject are determined to be at a specific distance from the camera, a next step can be to propagate the distance information over the heightmap.

The calibration process includes 1) correcting for errors in the calculated surface topology (when known), 2) correcting the heightmap where the same-height area from these measurements is not the same in the heightmap, 3) propagate the known heights (e.g., in microns) across surface regions with the same height in the heightmap and 3) to flow the height between areas of different height as measured by approaches such as structured laser line or contrast focus.

Similarly to Basri Jacobs inflation in that it is an iterative process, but the calibration process differs where the known dimensions from the point sampling process is flowed to neighboring pixels. With a threshold of interactions, discontinuities in the height across the image can be corrected and the vertical pixel heights can be linearized. To reduce memory and increase performance, a data structure, e.g., a lookup table, which maps the heightmap value to a distance in microns can be applied. This can make the iterative restitution more performant. For example, the heightmap value is not linearly correlated to microns, but via a lookup value from heightmap value to micron value can be a sparse map.

A calibration process for a heightmap can involve a statistical approach. A heightmap estimated from a normal map may include localized errors in height. In other words, a known height provided by the structured light on a given heightmap pixel may not match another heightmap pixel even with the same structured light height. Additionally, only the sparse set of heights sampled along the line or lines are able to be considered, e.g., there is likely only a partial set of heights included in a given sample set.

A maximum error can be associated with an outer edge of the sample surface between two lines of the structured light source projected onto the sample surface. These heightmap pixels are furthest from the lines.

The approach is to build a histogram where the known height from the structured light and the delta to the heightmap is recorded. Then using a kernel filter of suitable radius (the radius recommended was that at the outer radius of the surface, two such circles on separate lines would touch) the histogram for known heightmap pixels is applied. For heightmap pixels not represented, their values can be interpolated where possible. For heightmap pixels in the extrema (e.g., above or below the range) a global histogram can be used.

### Propagation of the Heightmap

To propagate the heightmap, edges (marked in the normal map) which are contiguous and of the same height in the heightmap will have their respective heights adjusted, e.g., similar to a flood fill operation. Using propagation can be used to perform more subtle operations to add back in curvature information into edges than the bulk calibration carried out previously.

### Infill of the Heightmap

Where no heights have been generated due to pixels being sub-surface, heights can be filled in using the structured light pixels. Radial symmetries in the object, e.g., radial symmetry of a bullet and firing pin, can make using infill techniques a useful approach. In addition, the center of the bullet can provide the densest structured light information. Infill approaches can be based largely on pattern matching and can rely on assumptions on the construction of the surface. In other words, if unique features are present subsurface, but not sampled, they may not be captured or reproduced.

Examples of hardware that can be used to perform the image acquisition and analysis under the described conditions, including point source illumination, spatially extended source illumination, and structured illumination, are described above.

In some embodiments, techniques described above can be implemented as part of a forensic imaging application environment on a mobile device that uses the mobile device's camera to acquire images. The application environment can be used in coordination with a server-side application that administers the system and associated database (e.g., a secure server), providing a platform for collecting and analyzing images.

### Example Processes of a Forensic Imaging Application Environment

In some embodiments, an application environment for a forensic imaging application, e.g., forensic imaging application 116, can be presented to a user via a user device, e.g., mobile device, to set-up, calibrate, and capture forensic imaging data using the forensic imaging apparatus. The application environment can be configured to perform various functions, examples of which are described below with reference to FIGS. 6O-6V.

The application environment for the forensic imaging application 116 can include a graphical user interface (GUI) including multiple screens, e.g., as depicted in FIGS. 6R-6V, to guide a user through a registration process to establish a new user account. Each individual user (e.g., law enforcement officer) can download the forensic imaging application (e.g., from a secure site or an app store) onto a user device, e.g., a mobile phone, tablet, computer, laptop computer, or the like, then open it and choose a registration option such as “register for an account.” In some implementations, a data management service can pre-fill out certain registration fields on the back end, so all an individual officer needs to do during registration is enter full name, badge number, and then choose his department, e.g., from a drop-down menu. Data fields can also be filled ahead of time for the actual assignment and rank of the officer/detective. In some cases, all that the officer should have to do is choose from pre-filled areas for everything but their name and badge (e.g., John Q. Smith, Badge 1234, NYPD, Patrol Bureau, Borough Command, Precinct, Rank, Patrolman).

In some cases, when a new user registers, their account may be set to an “account pending” status with their person of contact (POC) listed (e.g. from above, NYPD 20th Precinct account POC is Neil Jones). In some embodiments, biometric identifiers can be obtained as part of the registration process, e.g., one can include fingerprint registration and/or facial recognition, at least cached on the individual phone, for every account holder.

Once a new user successfully registers their account, the user can use the forensic imaging application in combination with a forensic imaging apparatus connected to a user device to enter evidence. In some embodiments, use of a forensic imaging platform can include a set-up process to calibrate the forensic imaging apparatus. The application environment of the forensic imaging application can assist the user in a calibration process to pair a forensic imaging apparatus with a mobile device and configure one or more features of the forensic imaging apparatus. In some embodiments, a process to set-up an account and calibrate the forensic imaging apparatus is described with reference to FIG. 6O depicted in example graphical user interface (GUI) windows in FIGS. 6Q-6R.

Receive, in an application environment on a user device, a user authentication. (652). A user may open the forensic imaging application on the user device and log into the application using a previously established credential, e.g., using facial recognition, a password, and/or another secure method. In some embodiments, a two-factor authentication including a secondary verification method (e.g., text/SMS or phone call including a login code) can be utilized.

Provide, to a user and via the application environment, instructions for connecting a forensic imaging apparatus to the user device (654). A home screen of the application environment can provide an option to navigate to a settings menu through which the user may select from various options including, for example, to set up a new device, calibrate an existing device, contact support, access help resources, and logout of the application.

In some embodiments, instructions for connecting (pairing) the forensic imaging apparatus with the user device can include visual/audio instructions via the application environment guiding the user to attached the forensic imaging apparatus to the adaptor, e.g., via one or more fixtures 216. The instructions may additionally include guidance for connecting the user device to the forensic imaging apparatus via a data communication link, e.g., via Bluetooth, Bluetooth Low Energy (BLE), or the like, using a unique authentication code.

Determine that a forensic imaging apparatus is in data communication with the user device (656). The forensic imaging application can determine that the apparatus is in data communication with the user device, e.g., validating an authentication code, via packet analysis, etc. An audio/visual confirmation of data communication can be provided to the user, e.g., an LED on an external portion of the apparatus can indicate confirmed data communication, a pop-up window in the application environment can confirm the link, etc.

In some embodiments, the forensic imaging apparatus will guide the user through a set of steps to calibrate the forensic imaging apparatus prior to the collection of data. The calibration sequence may be performed each time the forensic imaging apparatus is attached to the user device, may be performed at an initial pairing of an apparatus with a user device, and/or may be performed periodically to maintain a threshold calibration. Calibration steps for calibrating the forensic imaging apparatus are provided to the user on the user device (658). In some embodiments, a set of calibration steps can be provided to the user via the application environment including instructions on how to use a SRM2461 shell or another test shell that is provided to calibrate the forensic imaging apparatus. The calibration steps can include capturing calibration data, e.g., a sequence of images of the SRM2461 or another test shell.

Generating, using the forensic imaging apparatus and through the plurality of calibration steps, a calibration measurement for the forensic imaging apparatus (660). The forensic imaging application can generate, from the captured calibration data, a calibration measurement or value that can be used to calibrate the forensic imaging apparatus and/or user device setup.

After a calibration set-up is completed, the application environment can return to a home screen. In some embodiments, a user may proceed to capture forensic event data for one or more forensic events using the forensic imaging application.

The forensic imaging application, via the application environment, can assist the user in processes to capture, analyze, and/or validate forensic evidence. In some embodiments, an example workflow process 678 to capture, analyze, and validate forensic evidence is described with reference to FIG. 6P and depicted in example GUI windows in FIGS. 6Q, 6R-6W.

Receive, in an application environment for the forensic imaging application, a user authentication (680). User authentication can include, for example, facial recognition, passcode, or another secure authentication measure. User authentication can include a two-factor authentication process.

After authenticating the user in the forensic imaging application, a home screen of the application environment can provide navigation options to the user for capturing and/or accessing forensic event data. In some embodiments, a home screen of the application environment can include a live preview of forensic evidence retained within the forensic imaging apparatus and include options to adjust focus and/or capture imaging data of the forensic evidence.

Receive, from a user via the application environment, a request to capture a forensic evidence event (682). The user may select to enter an “evidence details” window where the user may view and select from menu items including, for example, “new incident report”, “cancel incident creation”, “submit incident”, “image preview”, “incident ID”, “evidence ID”, “caliber information”, “notes entry”, “map location”, “delete scan”, “add to an existing forensic event”, etc.

The forensic imaging application can receive a request from the user to generate a new forensic evidence event or add to an existing forensic evidence event and can provide, via multiple windows of the application environment, data entry points for the user to enter evidence information for the forensic evidence event. A portion or all of the evidence information may be entered in an automatic or semi-automatic (e.g., auto-fill, pre-populated, or suggested auto-fill) manner. A user may be prompted to provide one or more of, e.g., an incident ID, evidence ID, caliber information for the bullet shell casing, map location, date/time, notes related to evidence collection, or another custom metadata input. The application environment may additionally allow a user to cancel event creation, submit a new event, delete an image scan, and/or add an additional scan for a different piece of forensic evidence corresponding to a same forensic evidence event (e.g., a second bullet shell casing at a same crime scene).

Receive, from the user via the application environment, evidence information for the forensic evidence event (684). A user may select from two available choices: e.g., ENTER NEW EVIDENCE FOR EXISTING SCENE and ADD MORE TO A SCENE YOU'VE ALREADY WORKED. In the case of NEW ENTRIES, basic questions can be included before actually taking the photos. A tip/help guide can be included for each respective question.

In some embodiments, location information can be added automatically because the app may require location access. The user can be prompted to confirm where they are standing and/or drag a pin if location refinement is needed for accuracy.

In some embodiments, a case number can be added, either populated from a database (e.g., if entering new evidence for an existing scene), can be requested from a server/administrator, and/or entered manually.

In some embodiments, crime information can be added. For example, the user can choose from what they think is the actual crime, e.g., from a drop down menu (e.g., in alphabetic order such as Assault, Homicide, Robbery, etc.).

In some embodiments, date/time of recovered evidence can be populated automatically or manually.

In some embodiments, date/time that the crime was committed can be populated automatically (e.g., from a database server) or manually. An approximate time may be okay here from witnesses or other sources.

Capturing, by the forensic imaging application and using the forensic imaging apparatus, forensic imaging data for the forensic evidence event (686). The forensic imaging application can provide, via the application environment, a step-by-step process to the user for aligning a piece of forensic evidence (e.g., a bullet shell casing) within the forensic evidence apparatus. In one example, the application environment can include a live preview from the camera of the user device of the forensic evidence and provide guidance (e.g., via visual and/or audio cues) to the user to align the forensic evidence within the forensic imaging apparatus, e.g., at an imaging plane of the forensic imaging apparatus.

Once aligned, the forensic imaging application can proceed with capturing a sequence of images of the forensic evidence, e.g., under varying illumination schemes, to document one or more surfaces of the forensic evidence, e.g., the bullet shell casing, as detailed above in further detail.

Generating, by the forensic imaging application, a forensic evidence summary (688). The forensic imaging application can analyze the captured imaging data and generate a composite image of the forensic evidence, e.g., of one or more surfaces of a bullet shell casing. The forensic evidence summary can include metadata for the forensic event, e.g., time/date, location, notes, etc., provided by the user and/or automatically entered.

Providing, to the user and in the application environment, the forensic evidence summary (690). In some embodiments, the entered information can be presented for review before (or after) the user acquires images of the shell case. Images for more than one case can be acquired for the same crime scene. For instance, upon processing the images for one case, the application environment can prompt the user with a message such as “Is that all or would you like to add another casing to this current scene?” Finally, the user is prompted to SAVE AND FINISH evidence collection.

In some implementations, each user is able to modify only their entries. For example, the forensic imaging application can include Upload Center views in the application environment which allow a user to review and/or edit existing forensic evidence events, e.g., review/edit incident reports, forensic imaging data, evidence information, etc., for forensic evidence events that have not been uploaded to a cloud-based database, e.g., as depicted in FIG. 6W. The application environment can offer an option to MODIFY along with the SAVE AND FINISH prompt so that the user can add to or amend the information collected before finishing. If the user chooses to MODIFY after opening the app, the app can present a list by date, time, location and crime for the user to choose . . . and then be asked what they want to do. E.g., add photos, edit info?

Additional fields for user input can be included. For example, the user can be prompted to enter “How were you notified of the shooting”. For this, and other prompts, the app can present a drop down menu with a list of answers. E.g., for this question, the drop down can include “police dispatch” or the like.

On the back end, the platform can group multiple entries based on certain data fields. E.g., with the geo information and photo tags, such that, if multiple users collect evidence from a same scene and/or if a user enters multiple entries, the forensic imaging platform will associate these entries together.

In some embodiments, a user may be able to review the generated forensic evidence event and associated incident report(s) and elect to upload the data at a current time/date or set a future time/date to sync the upload (e.g., if there is poor connectivity with the network).

In some cases, the application environment can be used at an evidence locker and then associated with the actual recovery site manually or through an identifier (e.g., case number and/or dragging the location pin to the actual recovery site).

In some embodiments, a user may access an existing forensic evidence event via the application environment of the forensic imaging application, e.g., as depicted in FIGS. 6S-6U. The forensic imaging application can include search functions which allow the user to search for an existing forensic evidence event, e.g., in the forensic evidence database 120. The search functions can be configured to allow searching, for example, by incident ID, evidence ID, RMS/CAD numbers, location (i.e., point of interest) and/or address, date/time, or another custom metadata field. The application environment can present the information to the user and allow the user to view forensic evidence events including associated evidence (e.g., captured imaging data, evidence information, etc.) as well as access incident/evidence-specific reports.

In some embodiments, a user may interact with new and/or existing forensic evidence events via an evidence map functionality in the application environment of the forensic imaging application, e.g., as depicted in FIGS. 6T-6U. An evidence map can allow a user to search for evidence in a map-based window and view and/or generate relationships between multiple pieces of forensic evidence. The evidence map can include a search functionality configured to receive search criteria including, for example, an incident ID, evidence ID, RMS/CAD numbers, location (i.e., point of interest) and/or address, date/time, or another custom metadata field.

In some embodiments, the forensic imaging application includes a notification center in the application environment where a user may view and access, for example, recently submitted incident reports for forensic evidence events, e.g., as depicted in FIG. 6V. An incident report can include, for example, an actionable summary report including analysis and expert opinion responsive to the forensic evidence event including collected evidence information and forensic imaging data.

Though described herein with reference to a mobile user device, e.g., mobile phone, laptop, tablet, or another portable smart device, the processes described herein can be performed by a non-mobile user device, e.g., a desktop computer, bench-top test apparatus including a display, or the like.

In some embodiments, some or all of the processing of forensic event data can be performed on a cloud-based server.

### Example Forensic Manipulation Tool

In some embodiments, a forensic manipulation tool is utilized to retrieve a forensic sample, e.g., a firearm cartridge casing, from a crime scene or other location and mount the sample in apparatus 102 for forensic analysis. The forensic manipulation tool can allow sample collection and analysis with low-contact in order to avoid sample contamination, for example, to prevent contamination of DNA evidence or the like on the firearm cartridge casing.

The forensic manipulation tool can include retention features to secure the firearm cartridge casing on the forensic manipulation tool and can include alignment features that are compatible with the forensic imaging apparatus.

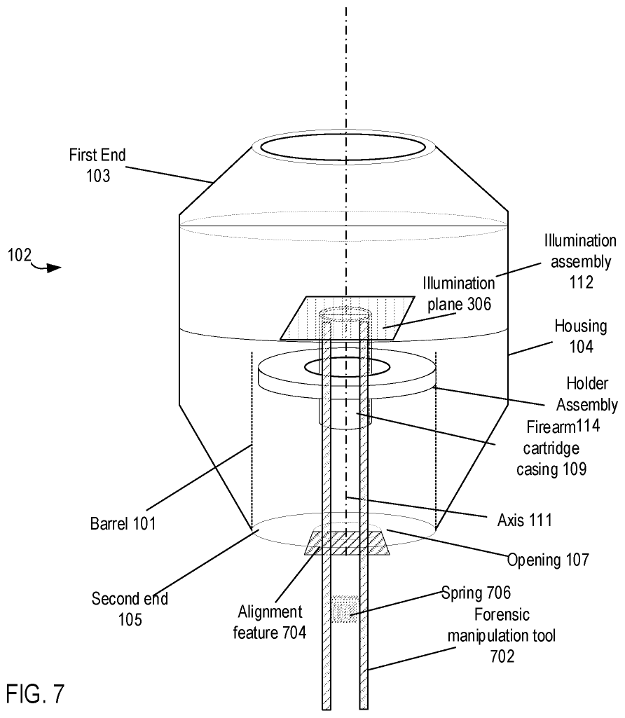

Forensic imaging apparatus 102 is depicted in FIG. 7 with a forensic manipulation tool 702 inserting firearm cartridge casing 109 into the barrel 101 of the forensic imaging apparatus 102. The forensic manipulation tool 702 includes an alignment feature 704, in this case a stop to position casing 109 at the appropriate axial location in barrel 101.

In some implementations, an alignment feature 704 can be adjustable with respect to the forensic manipulation tool such that the position of the casing 109 secured by the forensic manipulation tool 702 within the forensic imaging apparatus 102 is adjustable, e.g., to accommodate different length and/or caliber casings 109.

In some embodiments, alignment feature 704 can include a locking mechanism that can be utilized to secure a portion of the forensic manipulation tool 702 within the forensic imaging apparatus 102, e.g., when a casing 109 is being imaged inside the barrel 101. For example, a locking mechanism can include clips, snaps, threads, or the like. In another example, a locking mechanism can include magnetic components located on the forensic manipulation tool 702 and/or on the forensic imaging apparatus 102 such that when the forensic manipulation tool 702 is located within the forensic imaging apparatus 102, there the one or more magnetic components secure a portion of the forensic manipulation tool 702 in place within the forensic imaging apparatus 102.

In some implementations, the forensic manipulation tool 702 is configured to retain the bullet shell casing 109 and secure the casing 109 and position the casing 109 within the forensic imaging apparatus 102 such that an outer surface of the bullet shell casing 109 maintains isolation from the environment (e.g., the outer surface does not touch the forensic manipulation tool 702, the outer surface does not touch an inner portion of the forensic imaging apparatus 102 when retained within the apparatus 102). In other words, the forensic manipulation tool 702 may secure and position the casing 109 such that forensic evidence (e.g., DNA) located on an outer surface of the casing 109 is protected from becoming physically contaminated by surrounding environment.

Forensic manipulation tool 702 includes a pair of prongs and a spring 706 positioned between the prongs. When inserted into a casing, the spring is compressed and causes the prongs to press against the interior surface of the casing 109. In one example process, spring 706 is compressed by a user, e.g., a user can squeeze a base portion of the manipulation tool including a spring of the tweezers to move the prong tips together, and then insert the prong tips into the interior cylindrical cavity of the firearm cartridge casing, e.g., the distal ends of the tips of the tweezers can be inserted into the shell. The user can subsequently release the spring 706, allowing the spring to push the prongs the interior walls of the casing 109 with sufficient friction to allow the user to further manipulate the firearm cartridge casing 109 using the forensic manipulation tool 702, e.g., carry it to a different location, insert it into the forensic imaging apparatus 102, etc.

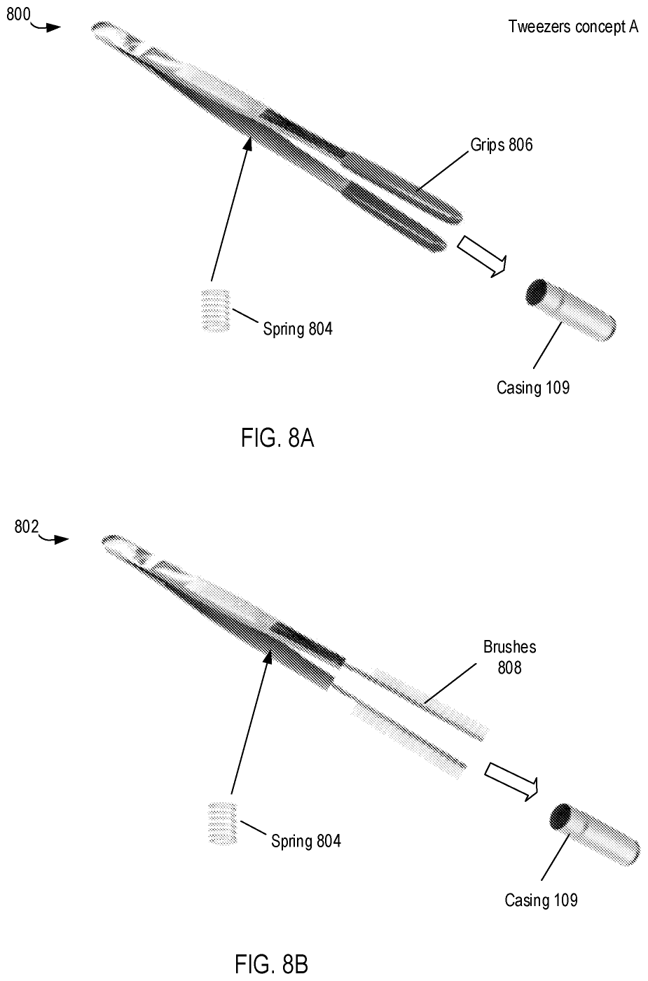

FIGS. 8A-8B depict two example forensic manipulation tools. Both are composed of tweezers that include a spring between to tweezer prongs. As shown in FIG. 8A, forensic manipulation tool 800 includes positioned approximately midway along the length of the tool between the tweezer prongs. Tool 800 also includes grips 806 on the tip of each prong, e.g., rubberized and/or textured surface, to provide additional friction when securing the casing 109.

As shown in FIG. 8B, tool 802 includes spring 804 and brushes 808 at the tip of each prong, e.g., pipe-cleaner style brushes, which can provide flexible but secure friction between an interior surface of the casing 109 and the tool 802.

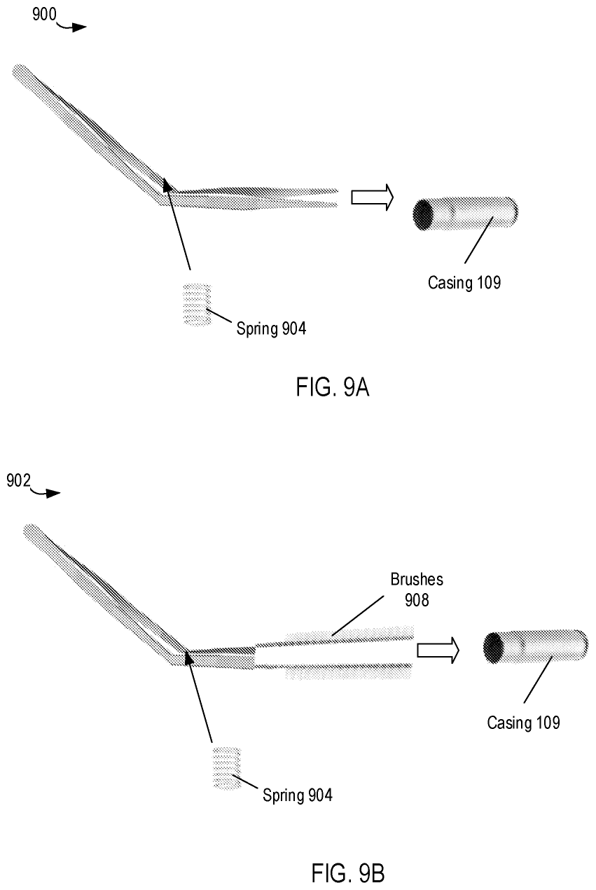

Other tweezer-type tools are also contemplated. For example, as depicted in FIGS. 9A-9B, forensic manipulation tools 900, 902 include a first portion that is arranged at a different angle with respect to a second portion. In one example, the tools 900, 902 can be a “dog-leg” tweezer, where a portion of the tool 900, 902 that is utilized to pick up the casing 109 is formed/bent at a different angle than a portion that is held by a user. This configuration can facilitate retrieval of spent shells sitting on the ground and provide ergonomic enhancement above and beyond straight-handled tweezers. Tools 900, 902 further includes a spring 904 to provide outward force on an interior of a firearm cartridge casing 109 when a portion of tool 900, 902 is inserted within a cavity of the casing 109. Tool 902 includes brushes 908 on the prong tips.

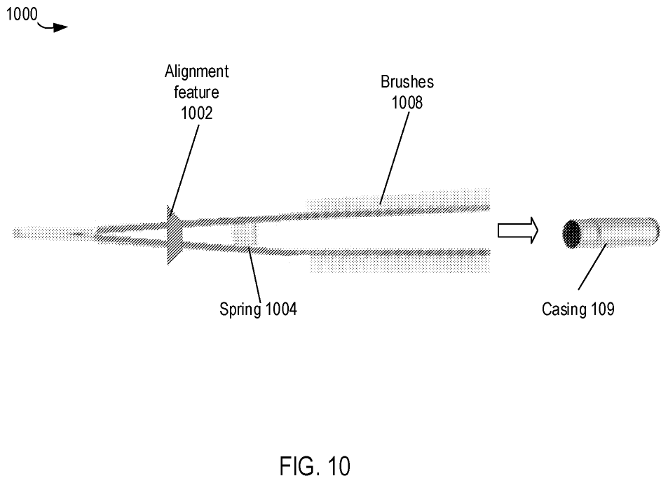

FIG. 10 shows an example of a tweezer-type forensic manipulation tool 1000 that includes an alignment feature 1002. The alignment feature can be sized and shaped to be compatible with dimensions of opening 107, e.g., can function as a stopper to align and register the firearm cartridge casing 109 within barrel 101 at the illumination plane 306 when the casing 109 is retained by the forensic manipulation tool 1000. Tool 1000 further includes a spring 1004 to provide outward force on an interior of a firearm cartridge casing 109 when a portion of tool 1000 is inserted within a cavity of the casing 109. Tool 1000 includes brushes 1008 on a tip portion which can provide flexible but secure friction between an interior surface of the casing 109 and the tool 1000.

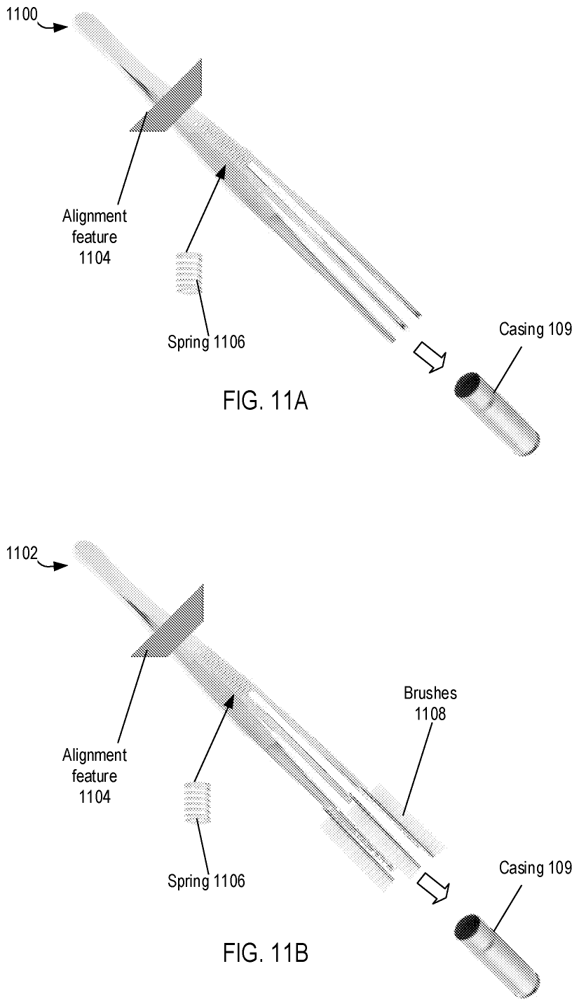

In some embodiments, as depicted in FIGS. 11A-11B, forensic manipulation tools 1100, 1102 includes a prong that features a pair of tines. Forensic manipulation tools 1100, 1102 also include an alignment feature 1104 that can be formed to be compatible with dimensions of opening 107, e.g., can function as a stopper to align the firearm cartridge casing 109 within barrel 101 at the illumination plane 306 when the casing 109 is retained by the forensic manipulation tools 1100, 1102. Tools 1100, 1102 further can include a spring 1106 to provide outward force on an interior of a firearm cartridge casing 109 when a portion of tool 1100, 1102 is inserted within a cavity of the casing 109. Tool 1102 include brushes 1108 on the prong tips. While tools 1100 and 1102 feature straight prongs, in some embodiments, these tools can include a “dog-leg” configuration, e.g., as described with reference to FIG. 9A, 9B.

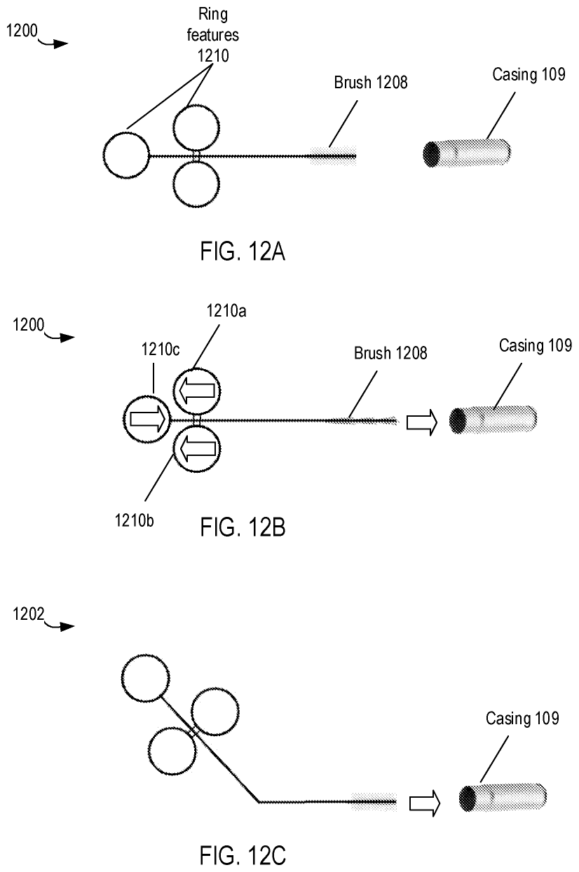

The foregoing examples all feature tweezer-type tools. Other grasping tools are also possible. In some embodiments, as depicted in FIGS. 12A-12B, a forensic manipulation tool 1200 includes include a mechanism that includes finger grips (e.g., ring features) 1210 to accommodate a user's thumb and fingers. The ring features 1210 can allow the user to compress or expand bristles on a brush 1208 on an end of the tool 1200 when a portion of the tool 1200 is being inserted into a cavity of the firearm cartridge casing 109. For example, ring features 1210a,b can be manipulated in a first direct and ring feature 1210c can be manipulated in a second, different direction. Tool 1200 is spring loaded so that when the finger grips are released the bristles of the brush in an outwardly extended manner, which can provide friction with an interior of the casing 109 when the brush 1208 is inserted into the casing 109. A compressed state of brush 1208, as depicted in FIG. 12B, can include the bristles of the brush in a lowered profile, e.g., flush with the tool's shaft, to allow the brush to be inserted into a cavity of the casing 109.

Other configurations are possible, e.g., as depicted in FIG. 12C in which the forensic manipulation tool described with respect to FIGS. 12A, 12B further includes an off-set portion, e.g., dog-leg, to allow for ergonomic manipulation of the tool 1202.

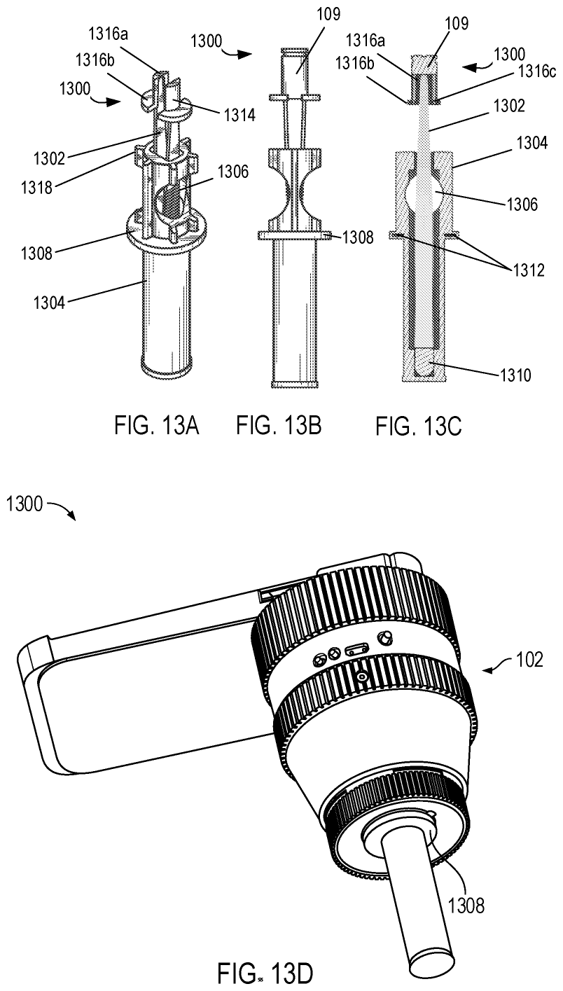

FIGS. 13A-13D depict views of another example forensic manipulation tool 1300. As depicted in FIGS. 13A-13C, the forensic manipulation tool 1300 includes a two-prong tweezer 1302 partially retained within a grip portion 1304. The tweezer 1302 can be made of metal, plastic, ceramic, or the like and include a textured portion to assist a user in manipulating the tweezer. The grip portion 1304 can be made of a rubber or plastic, e.g., silicone, and can include texture to assist a user in holding the tool. The user may access the tweezer component via cut-outs 1306 of the grip portion 1304, and can actuate the tweezer 1302 by compressing the tweezer 1302 via the cut-outs 1306 in the grip 1304.

Forensic manipulation tool 1300 can further include an alignment feature 1308, which can be integrated into the grip portion 1304. As depicted, the alignment feature 1308 includes a lip portion (or collar) of the grip portion that stops the insertion of the tool into the apparatus 102, e.g., as depicted in FIG. 13D.

In some implementations, the alignment feature 1308, as described with reference to FIG. 7, can be positioned on the forensic manipulation tool 1300 such that, when the forensic manipulation tool 1300 is inserted into the apparatus 102, a portion of the casing 109 (e.g., a headstamp of the casing) is located at the illumination plane (e.g., illumination plane 306) of the apparatus 102.

In some implementations, a position of alignment feature 1308 can be adjustable to accommodate different length casings 109 (e.g., different caliber casings). The position of alignment feature 1308 can be adjusted, for example, by adjusting a position of the grip portion 1304 with respect to the tweezer 1302 of the forensic manipulation tool 1300. For example, the position of the alignment feature 1308 can be adjusted by sliding the grip portion 1304 with respect to the tweezers 1302. In another example, the position of alignment feature 1308 can be adjusted by turning the grip portion 1304 with respect to the tweezers 1302, where the tweezers 1302 includes a threaded portion 1310.

In some implementations, the forensic manipulation tool 1300 includes one or more locking mechanisms 1312 for securing the tool to the apparatus while the tool is inserted into the apparatus. FIG. 13C depicts a cross-sectional schematic of the forensic manipulation tool including the one or more locking mechanisms 1312 embedded in the grip portion 1304. For example, the forensic manipulation tool 1300 and/or the apparatus 102 may include magnets and/or magnetic components such that magnetic attraction between the magnets and/or magnetic components of the tool and/or apparatus secure the tool while it is inserted into the apparatus.

In some implementations, the forensic manipulation tool 1300 can further include retention features 1314 located at the tips of the tweezer component. The retention features 1314 can include a curved portion 1316a that can be aligned with an inner curvature of a casing, e.g., as depicted in FIG. 13C. Retention features 1314 can be composed of a metal, rubber, and/or plastic material and can be textured to increase friction between the inner surface of the casing 109 and the retention features 1314. Retention features can additionally include a lip portion 1316b to rest a bottom of the casing 109 on the lip portion 1316b with respect to the retention features 1314 and while minimizing contacting an outer surface of the casing 109. In some implementations, as depicted in FIG. 13C, the lip portion 1316b includes a recessed feature 1316c to secure an outer rim of the casing 109 when the casing 109 is retained by the forensic manipulation tool 1300.

Forensic manipulation tool 1300 can be utilized to retain a casing 109. The casing 109 can be secured by the tool 1300 by compressing the tweezers 1302 and sliding the retention features 1314 into an inner volume of the casing 109. The tweezers 1302 can then be partially or fully decompressed such that the retention features 1314 apply outward pressure on the inner surface of the casing 109 to hold the casing 109 fixed on the forensic manipulation tool 1300. Tweezers 1302 can be decompressed such that the retention features 1314 define a radius that is a sufficiently small for a first portion of the retention features to be inserted into a range of casing calibers. In other words, the tweezers can be adaptably decompressed such that at least a portion of the retention features have an external radius that is smaller than an inner radius of a range of casing calibers and can be inserted into an inner portion of a casing for the range of casing calibers.

In some implementations, the tweezers 1302 of forensic manipulation tool 1300 can be decompressed adaptably to accommodate casings of a range of dimensions. In some implementations, tweezers 1302 can be adaptable to accommodate a range of casing calibers, e.g., a range including 50 caliber casing (having a 12.7 mm diameter) to a 0.32 Automatic Colt Pistol (ACP) shell casing (having a 7.8 mm diameter). In some implementations, the tweezers 1302 can be adaptably decompressed to accommodate bullet shell casings including (but not limited to) one or more of a 9 mm casing (e.g., 9.85 mm diameter, 18.85 mm length), a 40 caliber casing (e.g., 10.2 mm diameter, 21.6 mm length), and a 50 caliber casing (e.g., 12.7 mm diameter, 32.6 mm length).

In some implementations, an outer diameter of a first portion 1318 of the grip portion 1304 is configured to securely contact an inner diameter of the housing 104 (e.g., holder assembly 114 and/or an inner diameter of barrel 101) when the forensic manipulation tool 1300 is inserted within the apparatus 102. In other words, the outer diameter of the first portion 1318 of the grip portion 1304 is approximately equal to the inner diameter of the housing 104 to reduce vibration or movement of the casing retained by the forensic manipulation tool 1300 when the tool is inserted into the apparatus 102. In some implementations, the first portion 1318 includes one or more fins, where outer edges of each of the fins defines the outer diameter of the first portion 1318. The one or more fins can be composed of a rigid (e.g., plastic) or semi-flexible material (e.g., silicone or another rubber) to reduce weight/bulkiness of the tool while allowing an aperture of the apparatus to be sufficiently wide to minimize potential contact between an exterior of the shell casing 109 and assist in a secure fit between the forensic manipulation tool 1300 and the apparatus 102 when the tool is inserted into the apparatus 102, e.g., as depicted in FIG. 13D.

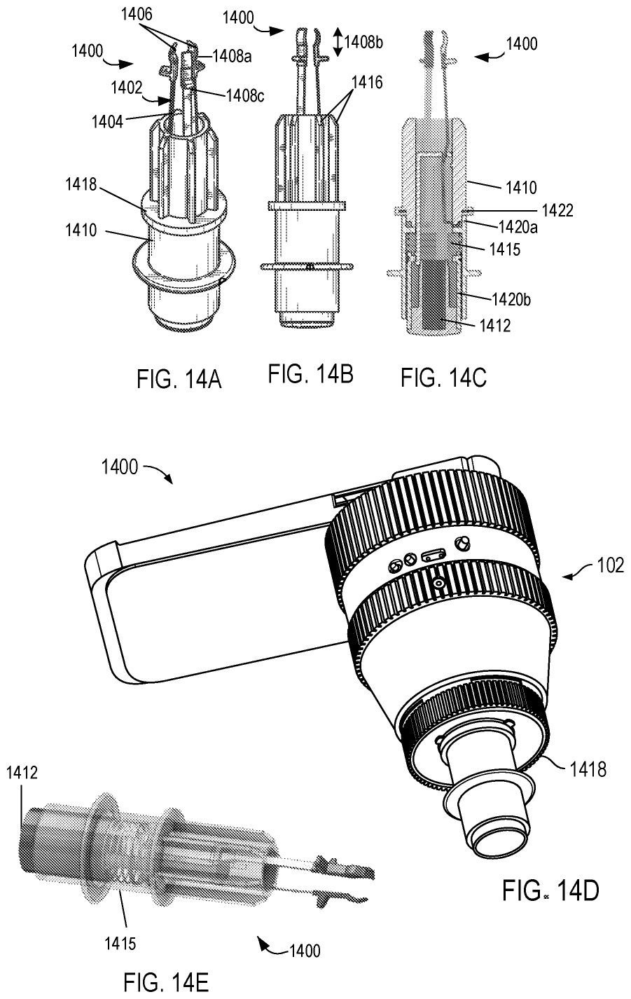

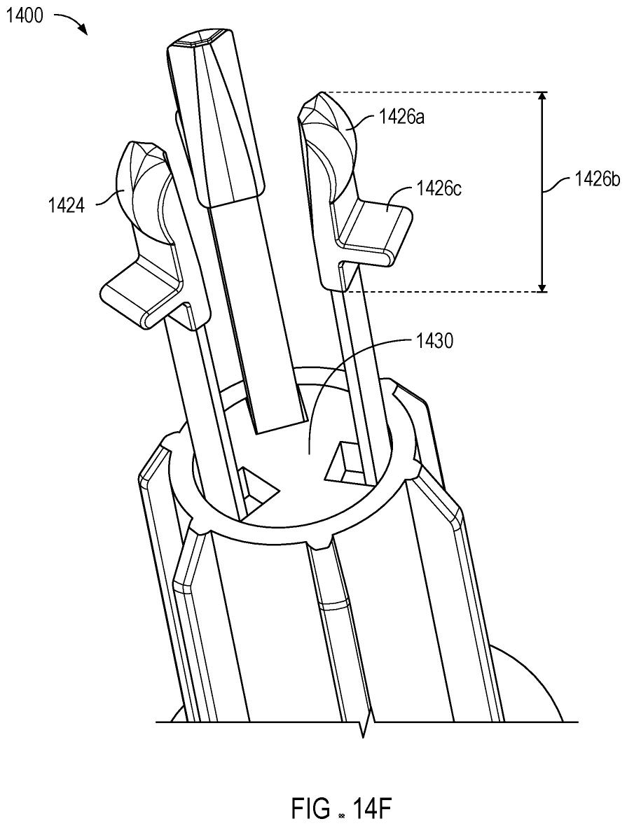

FIGS. 14A-14F depict views of another example forensic manipulation tool 1400. As depicted in FIGS. 14A-14F, the forensic manipulation tool 1400 includes a three-pronged tweezer 1402, each prong 1404 of the tweezer 1402 including a retention feature 1406 on a tip of the prong 1404.

In some implementations, e.g., as depicted in FIGS. 14A-14C and 14D, retention features 1406 include a first portion 1408a to be inserted into an inner volume of a casing 109 when the tweezers 1402 are in a first state (i.e., a first, more-compressed state) and to contact an inner surface of the casing 109 when the tweezers 1402 are in a second state (i.e., a second, less-compressed state). The first portion 1408a of the retention feature 1406 can include a curvature to provide a point of contact to the inner surface of the casing 109 and include a length 1408b that is inserted into the casing and that is sufficient to secure the casing 109 and minimize wobble or vibration.

In some implementations, the retention features 1406 include a second portion 1408c to support an outer rim of the casing 109 when the first portion 1408a of the retention features 1406 are inserted into the inner volume of the casing 109. In some implementations, second portion 1408c can function as an alignment feature to prevent further insertion of the forensic manipulation tool 1400 into the inner volume of the casing 109.

In some implementations, e.g., as depicted in FIG. 14F, retention features 1424 include a first portion 1426a including a rounded feature to be inserted into an inner volume of a casing 109 when the tweezers 1402 are in a first state (i.e., a first, more-compressed state) and to provide a point of contact to an inner surface of the casing 109 when the tweezers 1402 are in a second state (i.e., a second, less-compressed state). The retention features 1424 additionally includes a length 1426b that is inserted into the casing and that is sufficient to secure the casing 109 and minimize wobble or vibration. The length extends from the top of the first portion 1426a to a shelf 1426c which acts as a stop for the shell casing.

In some implementations, forensic manipulation tool includes a stabilizer piece 1430 at a throat portion of the tweezer to guide and/or constrict a motion of the respective prongs of the tweezers 1402 between the first state and the second state.

Forensic manipulation tool 1400 further includes a grip portion 1410 retaining a portion of the tweezers 1402. The grip portion 1410 can include an actuation mechanism 1412, that can be utilized to actuate the tweezers 1402 (e.g., compress/decompress the prongs of the tweezers 1402). A portion of the tweezers 1402 are retained within the grip portion 1410, e.g., as depicted by FIG. 14C in the cross-sectional schematic of forensic manipulation tool 1400. The actuation mechanism 1412 can include a spring-loaded component 1415 affixed to one or more of the prongs 1404 of the tweezers 1402 such that compression of the actuation mechanism 1412 actuates the tweezers 1402, for example, compressing the actuation mechanism compresses the tweezers together and decompressing the actuation mechanism relaxes the tweezers apart.

Grip portion 1410 can included a molded outer surface including multiple fins 1416, where an outer diameter defined by the edges of the fins 1416 is approximately equal to an inner diameter of an inner portion of the apparatus to reduce vibration or movement of the casing retained by the forensic manipulation tool 1400 when the tool is inserted into the apparatus 102, e.g., as depicted in FIG. 14D. Additionally, the multiple fins 1416 can be utilized to reduce weight/bulkiness of the tool while allowing an aperture of the apparatus to be sufficiently wide to minimize potential contact between an exterior of the shell casing 109 and assist in a secure fit between the forensic manipulation tool 1300 and the apparatus 102 when the tool is inserted into the apparatus 102, e.g., as depicted in FIG. 14D.

Grip portion 1410 can include an alignment feature 1418 that can be positioned on the forensic manipulation tool 1400 such that, when the forensic manipulation tool 1400 is inserted into the apparatus 102, a portion of the casing 109 (e.g., a headstamp of the casing) is located at the illumination plane, e.g., illumination plane 306, of the apparatus 102.

In some implementations, a position of alignment feature 1418 can be adjustable to accommodate different length casings and/or different caliber casings). A position of alignment feature 1418 can be adjusted, for example, by adjusting a position of the grip portion 1410 with respect to the tweezers 1402 of the forensic manipulation tool 1400. For example, the position of the alignment feature can be adjusted by sliding the grip portion with respect to the tweezers. In another example, the position of alignment feature can be adjusted by turning a first feature 1420a of the grip portion 1410 with respect to a second feature 1420b of the grip portion 1410 to thread/unthread the first feature 1420a with respect to the second feature 1420b.

Forensic manipulation tool 1400 can be utilized to retain a casing 109. The casing 109 can be secured by the tool 1400 by compressing the tweezers 1402 and sliding the retention features 1406 into an inner volume of the casing 109. The tweezers 1402 can then be partially or fully decompressed such that the retention features 1406 apply outward pressure on the inner surface of the casing 109 to hold the casing 109 fixed on the forensic manipulation tool 1400. Tweezers 1402 can be decompressed such that the retention features 1406 define a radius that is a sufficiently small for a first portion of the retention features to be inserted into a range of casing calibers. In other words, the tweezers can be adaptably decompressed such that at least a portion of the retention features have an external radius that is smaller than an inner radius of a range of casing calibers and can be inserted into an inner portion of a casing for the range of casing calibers.

In some implementations, the tweezers 1402 of forensic manipulation tool 1400 can be decompressed adaptably to accommodate casings of a range of dimensions. In some implementations, tweezers 1302 can be adaptable to accommodate a range of casing calibers, e.g., a range including 50 caliber casing (having a 12.7 mm diameter) to a 0.32 Automatic Colt Pistol (ACP) shell casing (having a 7.8 mm diameter). In some implementations, the tweezers 1302 can be adaptably decompressed to accommodate bullet shell casings including (but not limited to) one or more of a 9 mm casing (e.g., 9.85 mm diameter, 18.85 mm length), a 40 caliber casing (e.g., 10.2 mm diameter, 21.6 mm length), and a 50 caliber casing (e.g., 12.7 mm diameter, 32.6 mm length).

In some implementations, the forensic manipulation tool 1400 includes one or more components 1422 for securing the forensic manipulation tool 1400 to the apparatus 102 while the tool is inserted into the apparatus, e.g., as depicted in FIG. 14D. For example, the forensic manipulation tool 1400 and/or the apparatus 102 may include magnets and/or magnetic components such that magnetic attraction between the magnets and/or magnetic components of the tool and/or apparatus secure the forensic manipulation tool 1400 while it is inserted into the apparatus 102.

In some implementations, the forensic manipulation tool 1400 includes a release mechanism to release the locking mechanism securing the tool to the apparatus while the tool is inserted into the apparatus. For example, a release mechanism to release the magnetic coupling between the forensic manipulation tool and the apparatus.

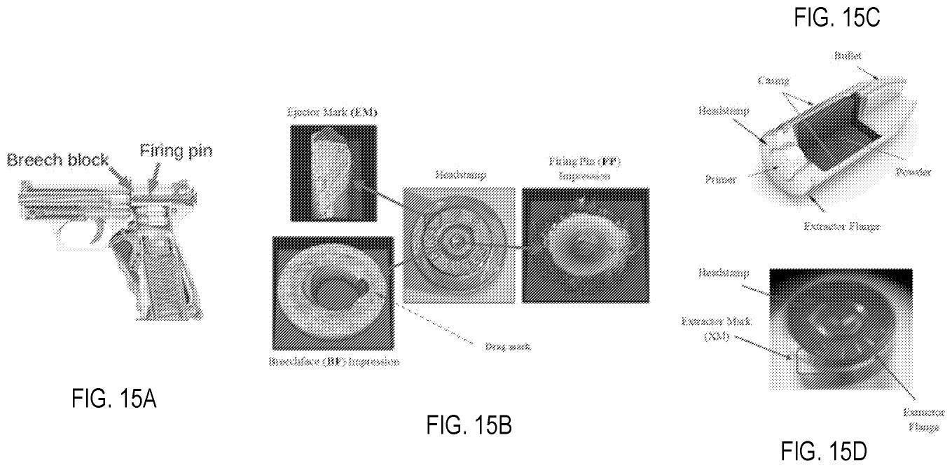

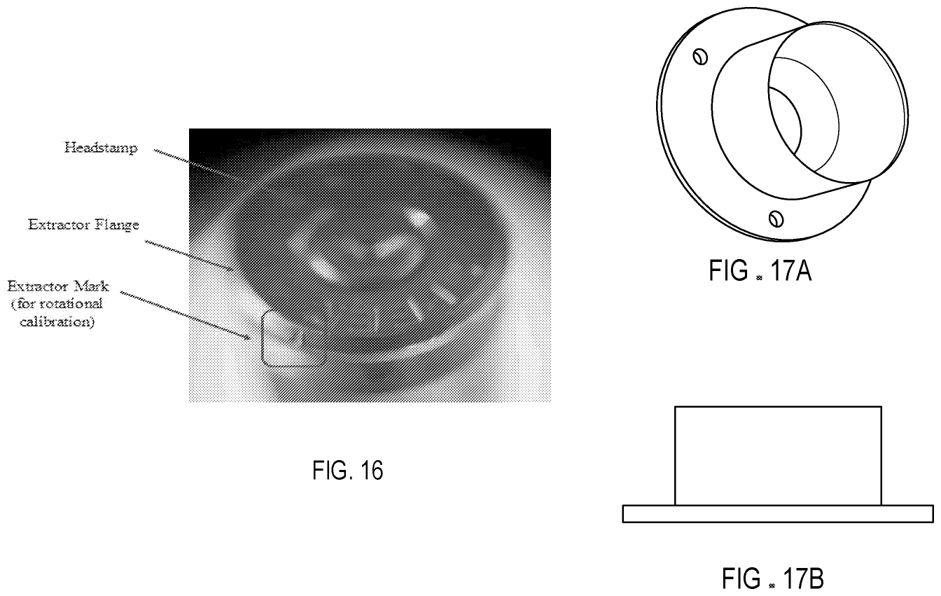

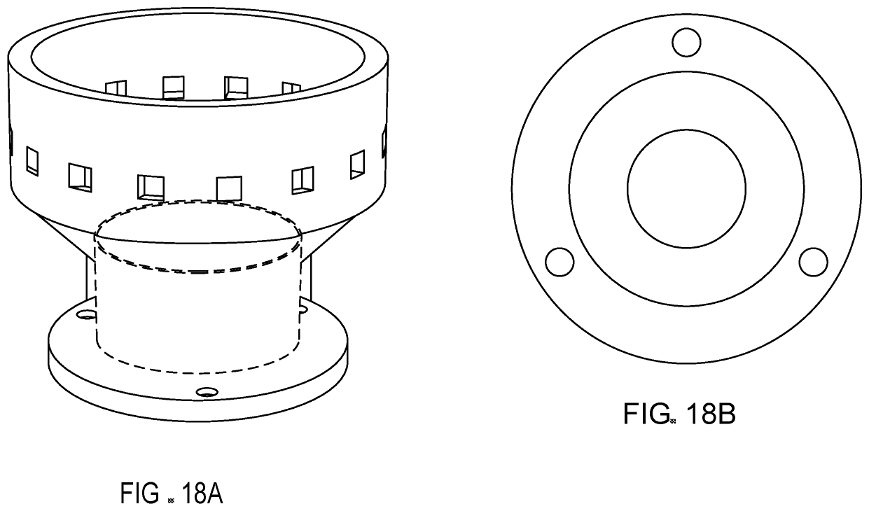

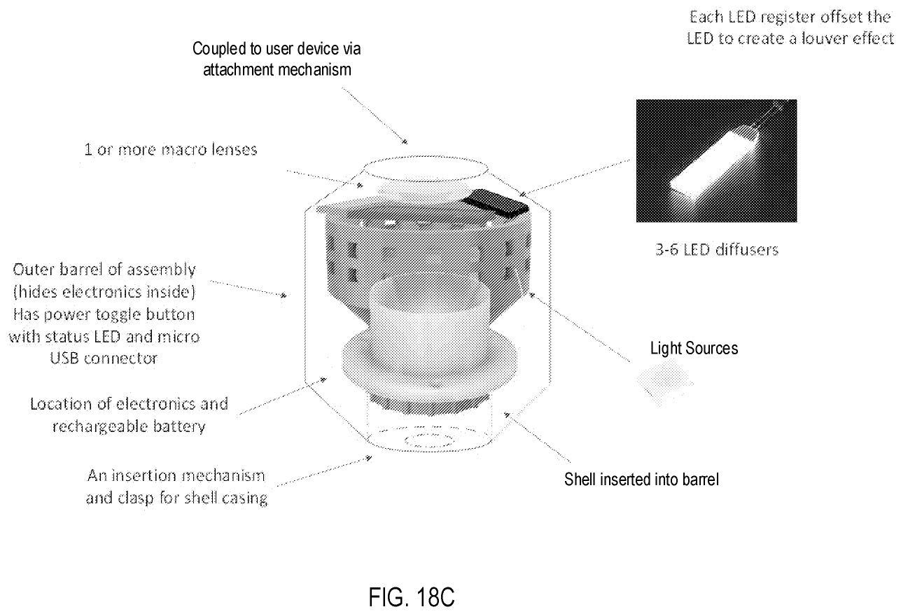

FIG. 15A shows a view of a handgun identifying the breech block and firing pin. FIGS. 15B-15D and FIG. 16 show different views of a bullet and example marks that may be formed on the head upon discharge with a firearm.

Referring to FIGS. 16, 17A-B and 18A-C, in some embodiments, a mirror can be used to image an extractor mark on the extractor flange of a shell casing. For example, as illustrated, a component featuring a cone mirror can be included to allow imaging of the extractor flange with the camera. Image processing can be used to determine the angular position of the extractor mark in the image of the extractor flange facilitated by the cone mirror. The extractor flange can also be used as a rotational reference in images, allowing image rotation in software to align the head in the image with any necessary angular reference.

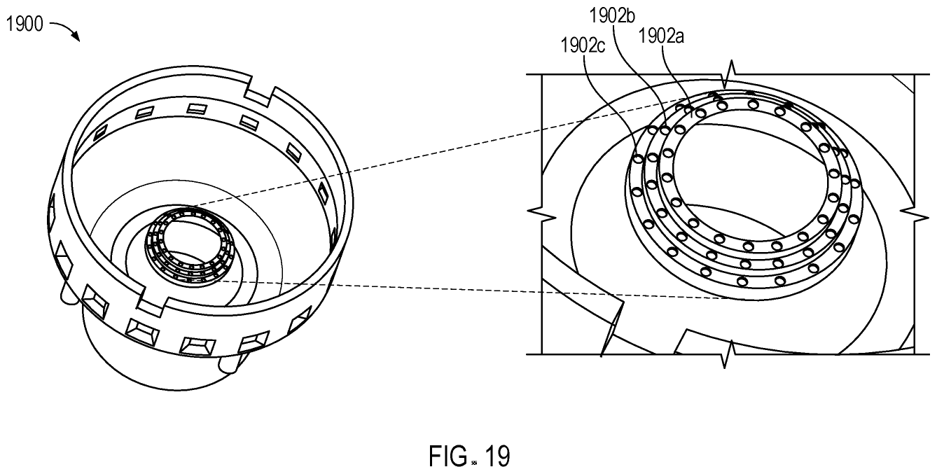

FIG. 19 depict an example focusing reticle 1900 for the forensic imaging apparatus 102. As depicted, the focusing reticle 1900 includes multiple registration levels 1902a, b, c corresponding to multiple focal lengths. In some implementations, the focusing reticle 1900 can be utilized in combination with the camera's focus feature and under software control, where contrasting colors on the surfaces of the reticle 1900 can be utilized by a contrast-detection algorithm to determine when each reticle plane is in optimal focus, (e.g., the higher the contrast, the sharper the focus.) The camera settings at which these maximum contrast points occur can be stored in the user device memory (or that of another user device memory) to correlate a particular settings to known distances. This correlation can be utilized to help ensure that the casing 109 is inserted at an appropriate depth. In other words, when the casing is at maximum contrast at the optical settings corresponding to proper focus of the top registration level 1902a of the focusing reticle 1900, it can be said to be inserted properly. The software can be written to then alert a user to stop inserting the casing 109 into the apparatus. The lower tiers of the reticle can provide means for additional user feedback, i.e. to guide the user during the insert of the shell casing 109 into the apparatus.

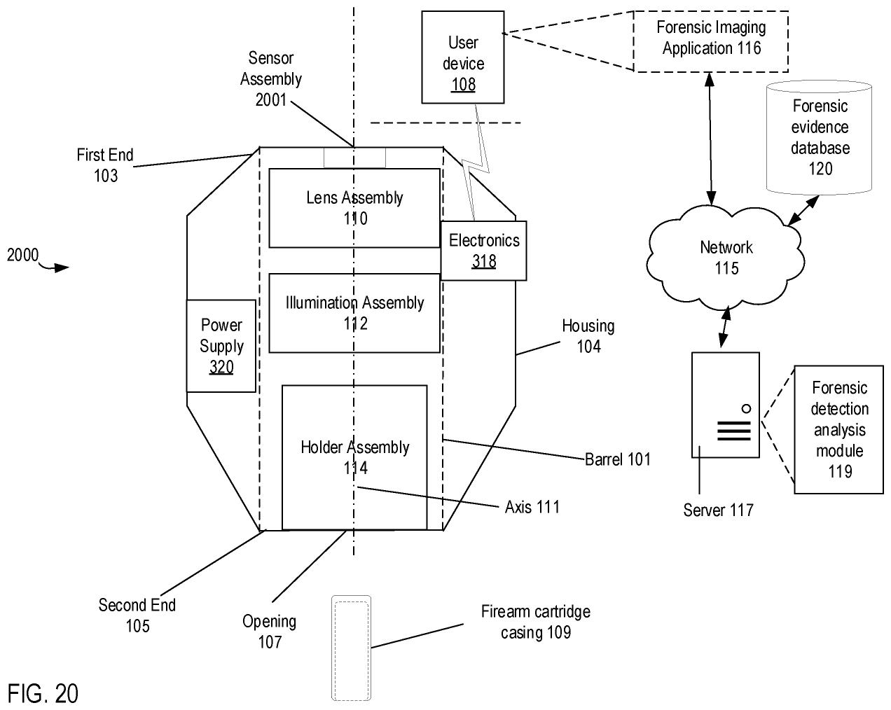

FIG. 20 depicts another example operating environment for a forensic imaging apparatus according to some embodiments. Here, a forensic imaging apparatus 2000 includes an internal sensor assembly, e.g., one or more imaging sensors, integrated into the housing 104 and in data communication with electronics 318 such that one or more operations of the sensor assembly 2001 can be controlled by electronics 318. Sensor assembly 2001 can receive power from power supply 320, e.g., to provide power to one or more imaging sensors of the imaging assembly 2001. Sensor assembly is optically aligned along axis 111 with lens assembly 110, illumination assembly 112, and holder assembly 114, such that imaging data of a casing 109 that is aligned within the forensic imaging apparatus 2000 at an illumination plane can be captured by sensor assembly 2001. In general, sensor assembly 2001 includes one or more imaging sensors, for example, one or more of CCD sensors, CMOS sensors, infrared sensors, or the like. In some embodiments, sensor assembly 2001 includes multiple sensors. Sensor assembly 2001 can include other components, such as optical elements including a filter or filters, e.g., for filtering particular ranges of reflected wavelengths of light from a surface of the casing 109, e.g., red/blue/green, IR filters, UV filters, etc. Forensic imaging apparatus 2000 can be in data communication with a user device 108, for example, via Bluetooth, USB, Wi-Fi, or another form of wireless or wired communication, such that operation of the forensic imaging apparatus 2000 can be controlled by a forensic imaging application 116 operating on user device 108, e.g., operation of one or more of the sensor assembly, illumination assembly, etc. For example, electronics 318 can include a modem and/or other communication interface for transmitting and receiving data to and from the apparatus. Imaging data captured by sensor assembly 2001 can be uploaded to user device 108 via a data communication link (e.g., via Bluetooth) such that processing and analysis of the captured imaging data can be performed by the forensic imaging application 116 and/or on a cloud-based server 117. The forensic imaging apparatus 2000 can be a stand-alone portable device, e.g., a handheld portable device, may communicate with a user device, e.g., via wireless communication, to upload captured images to the user device.

In some embodiments, sensor assembly 2001 and lens assembly 110 can be components of a camera including one or more sensors and one or more lenses that are integrated into the housing of the forensic imaging apparatus 2000, where one or more operations of the camera, e.g., capturing imaging data, can be controlled by electronics 318 and/or one or more operations of the camera can be controlled by a user device 108 in data communication with the camera via a data communication link (e.g., via Bluetooth).

In some embodiments, some or all of the functionality performed by the user device 108 can be integrated into the housing. For example, a forensic imaging apparatus can be a standalone device in which all the components for performing image capture and analysis are integrated into the housing. This can include one or more data processors, memory, and a user interface. The standalone portable device including illumination and imaging capabilities may communicate with a user device, e.g., via wireless communication, to upload captured images to the user device. The standalone portable device can be a handheld device including dimensions and weight that can be held by a user operating or carrying the portable handheld device. The standalone portable device can include an integrated battery-based power source.

In situations in which the systems discussed here collect personal information about users, or may make use of personal information, the users may be provided with an opportunity to control whether applications or features collect user information (e.g., information about a user's social network, social actions or activities, profession, a user's preferences, or a user's current location), or to control whether and/or how to receive content that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by a content server.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus.

Non-transitory computer-readable storage media can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., a FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices: magnetic disks, e.g., internal hard disks or removable disks: magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well: for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user: for example, by sending web pages to a web browser on a user's user device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a user computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network 115 (“LAN”) and a wide area network 115 (“WAN”), an inter-network 115 (e.g., the Internet), and peer-to-peer networks (e.g., ad hoc peer-to-peer networks).

The computing system can include users and servers. A user and server 117 are generally remote from each other and typically interact through a communication network. The relationship of user and server 117 arises by virtue of computer programs running on the respective computers and having a user-server 117 relationship to each other. In some embodiments, a server 117 transmits data (e.g., an HTML page) to a user device (e.g., for purposes of displaying data to and receiving user input from a user interacting with the user device). Data generated at the user device (e.g., a result of the user interaction) can be received from the user device at the server.

While this specification contains many specific implementation details, these should not be construed as limitations on the scope of any features or of what may be claimed, but rather as descriptions of features specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

1. An assembly, comprising:
an adaptor for receiving a camera;
a housing defining a barrel extending along an axis, the housing being attached to the adaptor at a first end of the barrel and having an opening at a second end of the barrel opposite the first end, the opening being sufficiently large to receive a firearm cartridge casing;
a holder for holding the firearm cartridge casing within the barrel to position a head of the firearm cartridge casing at an illumination plane within the barrel;
a plurality of light sources arranged within the housing and arranged to direct light to illuminate the illumination plane within the barrel, the plurality of light sources being arranged between the between the first end and the illumination plane,
wherein the plurality of light sources comprises a first light source arranged to illuminate the illumination plane at a first range of glancing incident angles.

2. The assembly of claim 1, wherein the adaptor is configured to attach the assembly to a user device comprising the camera.

3. The assembly of claim 1, wherein the plurality of light sources comprises a second light source arranged to illuminate the illumination plane at a second range of incident angles different from the first range of glancing incident angles.

4. The assembly of claim 1, wherein the plurality of light sources comprise at least one structured light source.

5. The assembly of claim 3, wherein the first light source is at a first position along the axis and the second light source is at a second position along the axis different from the first light source.

6. The assembly of claim 5, wherein the plurality of light sources comprises a first plurality of light sources including the first light source, each of the first plurality of light sources being arranged at the first position along the axis, each arranged to illuminate the illumination plane at the first range of glancing incident angles.

7. The assembly of claim 6, wherein the plurality of light sources are arranged at different azimuthal angles with respect to the axis.

8. The assembly of claim 7, wherein the plurality of light sources comprises a second plurality of light sources including the second light source, each of the second plurality of light sources being arranged at the second position along the axis, each arranged to illuminate the illumination plane at a second range of incident angles.

9. The assembly of claim 8, wherein the second plurality of light sources are arranged at different azimuthal angles with respect to the axis.

10. The assembly of claim 9, wherein the plurality of light sources comprises a third light source at a third position along the axis arranged to illuminate the illumination plane at a third range of incident angles, different from the first and second ranges of incident angles.

11. The assembly of claim 1, wherein the plurality of light sources comprises at least one spatially extended light source.

12. The assembly of claim 11, wherein the at least one spatially extended light source comprises a diffusing light guide arranged to emit light across an extended area.

13. The assembly of claim 11, wherein the at least one spatially extended light source is arranged at a location along the axis to illuminate the illumination plane across a range of incident angles sufficient to generate photometric stereo conditions.

14. The assembly of claim 1, wherein the first light source is a point light source.

15. The assembly of claim 12, wherein the range of incident angles is sufficient to generate photometric stereo conditions.

16. The assembly of claim 3, wherein the second light source is a point light source.

17. The assembly of claim 8, wherein the second range of incidence angles is sufficient to generate photometric stereo conditions.

18. The assembly of claim 3, wherein the second light source is a spatially extended light source.

19. The assembly of claim 1, further comprising a lens assembly mounted within the barrel, the lens assembly defining a focal plane at the illumination plane.

20. The assembly of claim 19, wherein the lens assembly is a magnifying lens assembly.

21. The assembly of claim 1, further comprising a source of electrical power for the plurality of light sources.

22. The assembly of claim 1, further comprising an electrical controller in communication with the light sources and programmed to control a sequence of illumination of the illumination plane by the plurality of light sources.

23. The assembly of claim 1, wherein the assembly is a portable assembly.

24. The assembly of claim 23, wherein the portable assembly is a handheld portable assembly.

25.-67. (canceled)
